(19) United States
(12) Patent Application Publication
(10) Pub. No.: US 2009/0162106 A1
(43) Pub. Date: Jun. 25, 2009

(54) Image Forming Device

(75) Inventors: Tomoaki HATTORI, Nagoya-shi (JP); Kenjiro NISHIWAKI, Nagoya-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/391,354

(22) Filed: Feb. 24, 2009

Related U.S. Application Data
(63) Continuation of application No. PCT/JP2007/066965, filed on Aug. 24, 2007.

(30) Foreign Application Priority Data
Aug. 28, 2006 (JP) 2006-230474
Aug. 28, 2006 (JP) 2006-230481
Sep. 14, 2006 (JP) 2006-249018
Sep. 14, 2006 (JP) 2006-249060

(51) Int. Cl. G03G 15/08

(52) U.S. Cl. 399/261

(57) ABSTRACT

An image forming apparatus includes a developer containing casing, a developer transport body, transport electrodes, and a developer vibrating section. The developer containing casing is a box-like member in which a developer is contained. The developer transport body has a developer transport surface, and is disposed within the developer containing casing. The plurality of transport electrodes are provided along the developer transport surface. These transport electrodes are configured such that they can transport the developer in a predetermined developer transport direction on the developer transport surface upon application of traveling-wave voltages. The developer vibrating section is configured to be able to vibrate the developer which is to be transported on the developer transport surface.

### TECHNICAL FIELD

The present invention relates to an image forming apparatus.

### BACKGROUND ART

[1] Many mechanisms for transporting toner (developer) by means of traveling-wave electric fields are conventionally known for use in image forming apparatus.

A mechanism (hereinafter, referred to as a “developer electric-field transport apparatus”) capable of transporting charged developer by means of traveling-wave electric fields as mentioned above includes a casing (container) and a developer transport member.

The toner is stored in the casing. Further, the developer transport member is accommodated within the casing. A large number of strip-shaped electrodes are provided in a row on the developer transport member.

By virtue of the developer electric-field transport apparatus having such a configuration, the developer is supplied from the casing to the developer transport member in a small amount at a time. Meanwhile, polyphase AC voltages are sequentially applied to the plurality of strip-shaped electrodes, whereby traveling-wave electric fields are generated on the developer transport member. By the action of the traveling-wave electric fields, the toner supplied to the developer transport member is transported in a predetermined direction.

[2] Many so-called “electric-field curtain” mechanisms for transporting developer by use of an electric field are conventionally known for use in image forming apparatus.

Such an electric-field curtain mechanism includes a container for storing the developer. A large number of electrodes are disposed within the container. These electrodes are provided on a plate-like member accommodated within the container. These electrodes are connected to a polyphase (e.g., three-phase) AC power supply.

The electric-field curtain mechanism is configured such that it can transport the developer in a charged state when polyphase AC voltages are applied to the electrodes.

In the electric-field curtain mechanism having such a configuration, polyphase AC voltages are output from the AC power supply, and applied to the plurality of electrodes. Thus, electrical fields which can move the developer in a predetermined direction are generated.

By means of the electric fields, the developer within the container is transported on the plate-like member in the predetermined direction. As a result of the developer being supplied to an object to which the developer to be supplied, an image is formed at a predetermined developing section. After that, the developer falls down from the plate-like member.

### DISCLOSURE OF THE INVENTION

[1] In the above-mentioned conventional developer electric-field transport apparatus, the developer transport member may fail to uniformly transport the developer. This becomes remarkable when the developer aggregates within the casing of the developer electric-field transport apparatus.

When the developer aggregates within the casing as described above, non-uniformity arises in the amount of the developer supplied to the developer transport member. As a result, non-uniformity arises in the amount of the developer transported on the developer transport member, whereby a formed image becomes non-uniform in terms of density.

The present invention has been conceived for solving the above problems. An object of the invention is to provide a developer supply apparatus in which transport and supply of developer by means of traveling-wave electric fields can be performed more uniformly, and an image forming apparatus which includes the developer supply apparatus, whereby generation of density non-uniformity is suppressed effectively, and satisfactory images can be formed.

[1-1]

(1) An image forming apparatus of the present invention comprises an electrostatic-latent-image carrying body and a developer supply apparatus.

The electrostatic-latent-image carrying body has a latent-image forming surface. The latent-image forming surface is configured to be able to form an electrostatic latent image thereon by means of electric-potential distribution. The latent-image forming surface is formed in parallel with a predetermined main scanning direction. The electrostatic-latent-image carrying body is configured such that the latent-image forming surface can move along a sub-scanning direction orthogonal to the main scanning direction.

The developer supply apparatus is disposed in such a manner as to face the electrostatic-latent-image carrying body. The developer supply apparatus is configured to be able to supply the latent-image forming surface with a developer in a charged state.

Specifically, the developer supply apparatus comprises a developer containing casing, a developer transport body, a plurality of transport electrodes, and a developer vibrating section.

The developer containing casing is a box-like member. The developer containing casing is configured to be able to contain the developer therein. The developer containing casing has an opening portion formed at a position where the casing faces the electrostatic-latent-image carrying body.

The developer transport body has a developer transport surface parallel with the main scanning direction. This developer transport body is disposed within the developer containing casing such that the developer transport surface faces the electrostatic-latent-image carrying body via the opening portion.

The plurality of transport electrodes are provided along the developer transport surface such that they face the latent-image forming surface. These transport electrodes are arrayed along the sub-scanning direction. The transport electrodes are configured in such a manner as to be able to transport the developer in a predetermined developer transport direction on the developer transport surface upon application of traveling-wave voltages.

That is, the developer transport body is configured to be able to transport the developer on the developer transport surface in the predetermined developer transport direction (toward the latent-image forming surface or a position (developing position) where the latent-image forming surface and the developer transfer face each other) when predetermined voltages are applied to the plurality of transport electrodes.

The developer vibrating section is configured to be able to vibrate the developer stored in the developer containing casing. Specifically, the developer vibrating section is configured to be able to vibrate the developer which is to be transported on the developer transport surface. This developer vibrating section may be disposed such that it can vibrate the developer which is to be transported on the developer transport surface, for example, at a position near the furthest upstream portion of the developer transport surface with respect to the developer transport direction.

The above-described “position near the furthest upstream portion of the developer transport surface with respect to the developer transport direction” may be any position so long as the developer which faces the furthest upstream portion of the developer transport surface is satisfactorily fluidized by the developer vibrating section disposed at the position.

That is, the developer vibrating section is provided at such a position that the developer satisfactorily fluidized by means of vibration applied by the developer vibrating section can come into contact with the furthest upstream portion of the developer transport surface.

Specifically, the developer vibrating section may be provided at, for example, a position corresponding to the furthest upstream portion of the developer transport surface with respect to the developer transport direction. That is, the developer vibrating section may be provided at a position at which the developer vibrating section overlaps the furthest upstream portion of the developer transport surface with respect to the horizontal direction or the vertical direction. Alternatively, the developer vibrating section may be provided at a position at which the developer vibrating section faces the furthest upstream portion of the developer transport surface.

The image forming apparatus of the present invention having the above configuration operates as described below in formation of an image.

An electrostatic latent image in the form of an electric-potential distribution is formed on the latent-image forming surface of the electrostatic-latent-image carrying body. The latent-image forming surface on which the electrostatic latent image is formed moves along the sub-scanning direction.

Meanwhile, the developer which is stored in the developer containing casing and is to be transported on the developer transport surface is vibrated by the developer vibrating section. As a result, the developer is fluidized. That is, a satisfactory fluidity is imparted to the developer.

Further, predetermined traveling-wave voltages are applied to the plurality of transport electrodes arrayed along the sub-scanning direction. As a result, a predetermined electric field is formed in the vicinity of the developer transport surface of the developer transport body. This electric field is a traveling-wave electric field which travels in a direction along the sub-scanning direction.

A portion of the developer within the developer containing casing having been satisfactorily fluidized as described above, the portion being located near the developer transfer surface, is transported on the developer transport surface in the predetermined developer transport direction by means of the traveling-wave electric field. That portion of the developer is supplied to a position (the above-described developing position) where the latent-image forming surface and the developer transport surface (which are parallel with each other) face each other.

In this manner, the developer supply apparatus supplies the developer in a charged state to the latent-image forming surface on which the electrostatic latent image is formed. Thus, the electrostatic latent image is developed (rendered visible) with the developer.

According to the image forming apparatus of the present invention having such a configuration, the developer which is to be transported on the developer transport surface is effectively fluidized. Thus, on the developer transport surface, the developer can be transported as uniformly as possible. At that time, application of large stresses, such as compressive force and shearing force, on the developer can be suppressed to the greatest possible extent.

Thus, according to the present invention, the transport and supply of the developer by means of the traveling-wave electric field can be performed more uniformly. Therefore, according to the present invention, there can be provided an image forming apparatus which can effectively suppress generation of density non-uniformity and which can form a satisfactory image.
The developer vibrating section may be provided in a bottom plate of the developer containing casing.

By virtue of this configuration, the developer within the developer containing casing can be satisfactorily fluidized through employment of a very simple apparatus structure.
The developer vibrating section may be provided within the developer containing casing such that the developer vibrating section is separated from an inner wall surface of a bottom portion of the developer containing casing and the developer transport body.

By virtue of this configuration, the developer vibrating section, which vibrates, is separated from the developer containing casing and the developer transport body. Therefore, vibration generated by the developer vibrating section is not transmitted directly to the developer containing casing and the developer transport body.

Accordingly, by virtue of such a configuration, there is prevented, to the greatest possible extent, a change in a predetermined positional relation between the latent-image forming surface of the electrostatic-image carrying body and the developer transport surface of the developer transport body, which change would otherwise result from vibration of the developer vibrating section.

Thus, it is possible to satisfactorily fluidize the developer to thereby render uniform the state of transport of the developer on the developer transport surface, while suppressing adverse influence on development of the electrostatic latent image to the greatest possible extent.
The developer vibrating section may be provided at least at a position corresponding to a lowest portion of the developer containing casing.

By virtue of the image forming apparatus having such a configuration, even when the storage amount of the developer within the developer containing casing decreases, the developer at the bottom portion of the developer containing casing can be satisfactorily fluidized. Thus, even in such a case, transport of the developer to the position which faces the latent-image forming surface can be performed properly.

Therefore, such a configuration enables satisfactory image formation by the developer even in the above-described case.

(2) A developer supply apparatus of the present invention is configured to be able to supply a developer in a charged state to a developer carrying surface of a developer carrying body along a predetermined developer transport direction. The developer carrying surface is a surface which is parallel to a predetermined main scanning direction and which can carry the developer thereon.

The developer carrying body has the developer carrying surface and is configured such that the developer carrying surface can move along a sub-scanning direction orthogonal to the main scanning direction.

The developer carrying body may be an electrostatic-latent-image carrying body having a latent-image forming surface configured to be able to form an electrostatic latent image thereon by means of electric-potential distribution.

Alternatively, the developer carrying body may be a recording medium (paper) which is transported along the sub-scanning direction.

Alternatively, the developer carrying body may be a roller, a sleeve, or a belt member (a developing roller, a developing sleeve, an intermediate transfer belt, etc.) which is configured and disposed so as to be able to transfer the developer onto the recording medium or the electrostatic-latent-image carrying body by means of facing the recording medium or the electrostatic-latent-image carrying body.

The developer supply apparatus of the present invention comprises a developer containing casing, a developer transport body, and a plurality of transport electrodes.

The developer containing casing is a box-like member. The developer containing casing is configured to be able to contain the developer therein. The developer containing casing has an opening portion formed at a position where the casing faces the developer carrying body.

The developer transport body has a developer transport surface parallel with the main scanning direction. This developer transport body is disposed within the developer containing casing such that the developer transport surface faces the developer carrying body via the opening portion.

The plurality of transport electrodes are provided along the developer transport surface such that they face the developer carrying surface. These transport electrodes are arrayed along the sub-scanning direction. The transport electrodes are configured in such a manner as to be able to transport the developer in the developer transport direction on the developer transport surface upon application of traveling-wave voltages.

That is, the developer transport body is configured to be able to transport the developer on the developer transport surface in the predetermined developer transport direction (toward the opening portion, the developer carrying surface, or a position (developing position) where the developer carrying surface and the developer transfer face each other) when predetermined voltages are applied to the plurality of transport electrodes.

The developer vibrating section is configured to be able to vibrate the developer which is stored in the developer containing casing and which is to be transported on the developer transport surface. This developer vibrating section may be disposed such that it can vibrate the developer which is to be transported on the developer transport surface, at a position near the furthest upstream portion of the developer transport surface with respect to the developer transport direction.

In the developer supply apparatus of the present invention having such a configuration, the developer within the developer containing casing is vibrated by the developer vibrating section. As a result, the developer can be fluidized.

Further, predetermined traveling-wave voltages are applied to the plurality of transport electrodes arrayed along the sub-scanning direction. As a result, a predetermined electric field is formed in the vicinity of the developer transport surface of the developer transport body. This electric field is a traveling-wave electric field which travels in a direction along the sub-scanning direction.

A portion of the developer within the developer containing casing having been fluidized as described above, the portion being located near the developer transfer surface, is transported on the developer transport surface in the predetermined developer transport direction by means of the traveling-wave electric field. That portion of the developer is supplied to a position (the above-described developing position) where the developer carrying surface and the developer transport surface (which are parallel with each other) face each other.

In this manner, the developer supply apparatus supplies the developer in a charged state to the developer carrying surface, which moves along the sub-scanning direction. Thus, the developer is carried on the developer carrying surface.

According to the developer supply apparatus of the present invention such a configuration, the developer which is to be transported on the developer transport surface is effectively fluidized. At that time, application of large stresses, such as compressive force and shearing force, on the developer can be suppressed to the greatest possible extent.

Thus, according to the developer supply apparatus of the present invention, the transport and supply of the developer by means of the traveling-wave electric field can be performed more uniformly.
The developer vibrating section may be provided in a bottom plate of the developer containing casing.

By virtue of this configuration, the developer within the developer containing casing can be satisfactorily fluidized through employment of a very simple apparatus structure.
The developer vibrating section may be provided within the developer containing casing such that the developer vibrating section is separated from an inner wall surface of a bottom portion of the developer containing casing and the developer transport body.

By virtue of such a configuration, there is prevented, to the greatest possible extent, a change in a predetermined positional relation between the developer carrying surface of the developer carrying body and the developer transport surface of the developer transport body, which change would otherwise result from vibration of the developer vibrating section.

Thus, adverse influence of a change in the positional relation on transfer of the developer onto the developer carrying surface (development or image formation by the developer) can be suppressed to the greatest possible extent.
The developer vibrating section may be provided at least at a position corresponding to a lowest portion of the developer containing casing.

By virtue of the developer supply apparatus having such a configuration, even when the storage amount of the developer within the developer containing casing decreases, the developer at the bottom portion of the developer containing casing can be satisfactorily fluidized. Thus, even in such a case, transport of the developer to the position which faces the latent-image forming surface can be performed properly.

(3) An image forming apparatus of the present invention comprises an electrostatic-latent-image carrying body and a developer supply apparatus. The electrostatic-latent-image carrying body is configured and disposed in the same manner as described in section (1) above.

The developer supply apparatus is configured to be able to supply the latent-image forming surface with a developer in a charged state. This developer supply apparatus comprises a developer containing casing, a developer transport body, a plurality of transport electrodes, and a developer vibrating section, and is disposed in such a manner as to face the electrostatic-latent-image carrying body.

The developer containing casing is a box-like member, and is configured to be able to contain the developer therein. The developer containing casing has an opening portion formed at a position where the casing faces the electrostatic-latent-image carrying body.

The developer transport body has a developer transport surface parallel with the main scanning direction.

The developer transport body may be disposed within the developer containing casing such that the developer transport surface faces the electrostatic-latent-image carrying body via the opening portion. Alternatively, the developer transport body may be disposed on the inner wall surface of the developer containing casing at a position at which the developer transport body is located adjacent to the opening portion and/or faces the opening portion.

The plurality of transport electrodes are provided along the developer transport surface. These transport electrodes are arrayed along the sub-scanning direction. The transport electrodes are configured in such a manner as to be able to transport the developer in a predetermined developer transport direction on the developer transport surface upon application of traveling-wave voltages.

That is, the developer transport body is configured to be able to transport the developer on the developer transport surface in the developer transport direction (toward the opening portion, the latent-image forming surface, or a position (developing position) where the latent-image forming surface and the developer transfer face each other) when predetermined voltages are applied to the plurality of transport electrodes.

The developer vibrating section is configured to be able to vibrate the developer stored in the developer containing casing. Specifically, the developer vibrating section is configured to be able to vibrate the developer which is to be transported on the developer transport surface.

The developer vibrating section may be disposed at a position near the furthest upstream portion of the developer transport surface with respect to the developer transport direction. The above-described “position near the furthest upstream portion of the developer transport surface with respect to the developer transport direction” may be any position so long as the developer which faces the furthest upstream portion of the developer transport surface can be satisfactorily fluidized by the developer vibrating section disposed at the position.

Specifically, the developer vibrating section may be provided at, for example, at a position corresponding to the furthest upstream portion of the developer transport surface with respect to the developer transport direction. That is, the developer vibrating section may be provided at a position at which the developer vibrating section overlaps the furthest upstream portion of the developer transport surface with respect to the horizontal direction or the vertical direction. Alternatively, the developer vibrating section may be provided at a position at which the developer vibrating section faces the furthest upstream portion of the developer transport surface.

In the image forming apparatus of the present invention having such a configuration, the developer which is stored in the developer containing casing and is to be transported on the developer transport surface is vibrated by the developer vibrating section. As a result, the developer is fluidized.

Further, predetermined traveling-wave voltages are applied to the plurality of transport electrodes. As a result, a traveling-wave electric field which travels in the developer transport direction along the sub-scanning direction is formed in the vicinity of the developer transport surface of the developer transport body.

By means of the traveling-wave electric field, a portion of the developer within the developer containing casing having been satisfactorily fluidized as described above, the portion being located near the developer transfer surface, is transported on the developer transport surface in the developer transport direction (toward the opening portion, the latent-image forming surface, or the position (the developing position) where the latent-image forming surface and the developer transport surface face each other).

According to the image forming apparatus of the present invention, the developer which is to be transported on the developer transport surface is effectively fluidized. Thus, on the developer transport surface, the developer can be transported as uniformly as possible. At that time, application of large stresses, such as compressive force and shearing force, on the developer can be suppressed to the greatest possible extent.

Thus, according to the present invention, the transport and supply of the developer by means of the traveling-wave electric field can be performed more uniformly. Therefore, according to the present invention, there can be provided an image forming apparatus which can effectively suppress generation of density non-uniformity and which can form a satisfactory image can be provided.
The developer vibrating section may be provided in a bottom plate of the developer containing casing.

By virtue of this configuration, the developer within the developer containing casing can be satisfactorily fluidized through employment of a very simple apparatus structure.
The developer vibrating section may be provided within the developer containing casing such that the developer vibrating section is separated from an inner wall surface of a bottom portion of the developer containing casing and the developer transport body.

By virtue of this configuration, the developer vibrating section, which vibrates, is separated from the developer containing casing and the developer transport body. Therefore, vibration generated by the developer vibrating section is not transmitted directly to the developer containing casing and the developer transport body.
The developer vibrating section may be provided at least at a position corresponding to a lowest portion of the developer containing casing.

By virtue of the image forming apparatus having such a configuration, even when the storage amount of the developer within the developer containing casing decreases, the developer at the bottom portion of the developer containing casing can be vibrated satisfactorily. Thus, even in such a case, transport of the developer to the position which faces the latent-image forming surface can be performed properly.

Therefore, such a configuration enables satisfactory image formation by the developer even in the above-described case.

(4) A developer supply apparatus of the present invention is configured to be able to supply a developer in a charged state to a developer carrying surface of a developer carrying body along a predetermined developer transport direction.

The developer carrying body is configured and disposed in the same manner as described in section (2) above. Further, the developer carrying surface is a surface which is parallel to a predetermined main scanning direction and which can carry the developer thereon.

The developer supply apparatus of the present invention comprises a developer containing casing, a developer transport body, and a plurality of transport electrodes.

The developer containing casing is a box-like member, and is configured to be able to contain the developer therein. The developer containing casing has an opening portion formed at a position where the casing faces the developer carrying body.

The developer transport body has a developer transport surface parallel with the main scanning direction.

The developer transport body may be disposed within the developer containing casing such that the developer transport surface faces the developer carrying body via the opening portion. Alternatively, the developer transport body may be disposed on the inner wall surface of the developer containing casing at a position at which the developer transport body is located adjacent to the opening portion and/or faces the opening portion.

The plurality of transport electrodes are provided along the developer transport surface. These transport electrodes are arrayed along the sub-scanning direction. The transport electrodes are configured in such a manner as to be able to transport the developer in the developer transport direction on the developer transport surface upon application of traveling-wave voltages.

That is, the developer transport body is configured to be able to transport the developer on the developer transport surface in the predetermined developer transport direction (toward the opening portion or the developer carrying surface) when predetermined voltages are applied to the plurality of transport electrodes.

The developer vibrating section is configured to be able to vibrate the developer which is stored in the developer containing casing and is to be transported on the developer transport surface.

The developer vibrating section may be disposed at a position near the furthest upstream portion of the developer transport surface with respect to the developer transport direction.

In the developer supply apparatus of the present invention having such a configuration, the developer within the developer containing casing is vibrated by the developer vibrating section. As a result, the developer is fluidized.

Further, predetermined traveling-wave voltages are applied to the plurality of transport electrodes arrayed in the sub-scanning direction. As a result, a traveling-wave electric field which travels along the sub-scanning direction is formed in the vicinity of the developer transport surface of the developer transport body.

By means of the traveling-wave electric field, a portion of the developer within the developer containing casing having been fluidized as described above, the portion being located near the developer transfer surface, is transported on the developer transport surface in the predetermined developer transport direction (toward the opening portion or the developer carrying surface).

According to the developer supply apparatus of the present invention having such a configuration, the developer which is to be transported on the developer transport surface is effectively fluidized. At that time, application of large stresses, such as compressive force and shearing force, on the developer can be suppressed to the greatest possible extent.

Thus, according to the developer supply apparatus of the present invention, the transport and supply of the developer by means of the traveling-wave electric field can be performed more uniformly.
The developer vibrating section may be provided in a bottom plate of the developer containing casing.

By virtue of this configuration, the developer within the developer containing casing can be satisfactorily fluidized through employment of a very simple apparatus structure.
The developer vibrating section may be provided within the developer containing casing such that the developer vibrating section is separated from an inner wall surface of a bottom portion of the developer containing casing and the developer transport body.

By virtue of this configuration, transmission of vibration generated by the developer vibrating section directly to the developer containing casing and the developer transport body can be suppressed effectively.
The developer vibrating section may be provided at least at a position corresponding to a lowest portion of the developer containing casing.

By virtue of the developer supply apparatus having such a configuration, even when the storage amount of the developer within the developer containing casing decreases, the developer at the bottom portion of the developer containing casing can be vibrated satisfactorily.

[1-2]

(1) An image forming apparatus of the present invention comprises an electrostatic-latent-image carrying body and a developer supply apparatus.

The electrostatic-latent-image carrying body has a latent-image forming surface. The latent-image forming surface is configured to be able to form an electrostatic latent image thereon by means of electric-potential distribution. The latent-image forming surface is formed in parallel with a predetermined main scanning direction. The electrostatic-latent-image carrying body is configured such that the latent-image forming surface can move along a sub-scanning direction orthogonal to the main scanning direction.

The developer supply apparatus is disposed in such a manner as to face the electrostatic-latent-image carrying body. The developer supply apparatus is configured to be able to supply the latent-image forming surface with a developer in a charged state. Specifically, the developer supply apparatus comprises a developer containing casing, a developer transport body, a plurality of transport electrodes, and a gas supply section.

The developer containing casing is a box-like member which includes a developing-section counter plate and a gas-permeable bottom plate. The developing-section counter plate has an opening portion formed at a position where the counter plate faces the electrostatic-latent-image carrying body. The gas-permeable bottom plate is configured to prevent passage of the developer therethrough and permit passage of a gas therethrough. The developer containing casing is configured to be able to contain the developer therein.

The developer transport body has a developer transport surface parallel with the main scanning direction. This developer transport body is disposed within the developer containing casing such that the developer transport surface faces the electrostatic-latent-image carrying body via the opening portion of the developing-section counter plate.

The plurality of transport electrodes are provided along the developer transport surface such that they face the latent-image forming surface. These transport electrodes are arrayed along the sub-scanning direction. The transport electrodes are configured in such a manner as to be able to transport the developer in a predetermined developer transport direction on the developer transport surface upon application of traveling-wave voltages.

The gas supply section is configured to blow a gas into the interior of the developer containing casing via the gas-permeable bottom plate, to thereby fluidize the developer within the developer containing casing.

The image forming apparatus of the present invention having such a configuration operates as described below in formation of an image.

An electrostatic latent image in the form of an electric-potential distribution is formed on the latent-image forming surface of the electrostatic-latent-image carrying body. The latent-image forming surface on which the electrostatic latent image is formed moves along the sub-scanning direction.

Meanwhile, the gas supply section blows the gas into the interior of the developer containing casing via the gas-permeable bottom plate. As a result, the developer within the developer containing casing is fluidized.

Further, predetermined traveling-wave voltages are applied to the plurality of transport electrodes arrayed along the sub-scanning direction. As a result, a predetermined electric field is formed in the vicinity of the developer transport surface of the developer transport body. This electric field is a traveling-wave electric field which travels in a direction along the sub-scanning direction.

A portion of the developer within the developer containing casing having been fluidized as described, the portion being located near the developer transfer surface, is transported on the developer transport surface in the predetermined developer transport direction by means of the traveling-wave electric field. That portion of the developer is supplied to a position (the developing position) where the latent-image forming surface and the developer transport surface (which are parallel with each other) face each other.

In this manner, the developer supply apparatus supplies the developer in a charged state to the latent-image forming surface on which the electrostatic latent image is formed. Thus, the electrostatic latent image is developed (rendered visible) with the developer.

According to the image forming apparatus of the present invention having such a configuration, a mechanical or thermal stress caused by a compressive force or shearing force at the time when the developer is fluidized is very small. Therefore, according to the present invention, the transport and supply of the developer by means of the traveling-wave electric field can be performed more uniformly.

Therefore, according to the present invention, there can be provided an image forming apparatus which can form a satisfactory image, while effectively suppressing the generation of density non-uniformity.
The gas-permeable bottom plate may be provided at least at a position near the furthest upstream portion of the developer transport surface with respect to the developer transport direction.

The above-described “position near the furthest upstream portion of the developer transport surface with respect to the developer transport direction” may be any position so long as the developer which faces the furthest upstream portion of the developer transport surface can be satisfactorily fluidized upon placement of the gas-permeable bottom plate at the position.

That is, the gas-permeable bottom plate may be provided at such a position that the developer satisfactorily fluidized by means of inflow of the gas from the gas-permeable bottom plate can come into contact with the furthest upstream portion of the developer transport surface.

Specifically, the gas-permeable bottom plate may be provided at, for example, at a position corresponding to the furthest upstream portion of the developer transport surface with respect to the developer transport direction.

That is, the gas-permeable bottom plate may be provided at a position at which the gas-permeable bottom plate overlaps the furthest upstream portion of the developer transport surface with respect to the horizontal direction or the vertical direction. Alternatively, the gas-permeable bottom plate may be provided at a position at which the gas-permeable bottom plate faces the furthest upstream portion of the developer transport surface.

In such a configuration, the gas is blown into the developer containing casing from the gas supply section via the gas-permeable bottom plate. Thus, the developer within the developer containing casing located near the furthest upstream portion of the developer transport surface with respect to the developer transport direction is fluidized.

By virtue of such a configuration, the developer can be supplied to the furthest upstream portion of the developer transport surface as uniformly as possible.

Thus, the transport of the developer on the developer transport surface by means of the traveling-wave electric field and the supply of the developer to the latent-image forming surface on which the latent image is formed can be performed uniformly with further reduced non-uniformity.
The image forming apparatus may be configured as follows: the present image forming apparatus further comprises an exhaust section. This exhaust section is configured to exhaust the gas from the developer containing casing. An exhaust port which communicates with the exhaust section is provided in the developer containing casing at a position different from that of the opening portion.

In such a configuration, when the developer within the developer containing casing is to be fluidized, the gas from the gas supply section is blown into the developer containing casing via the gas-permeable bottom plate. Meanwhile, the gas within the developer containing casing is exhausted by the exhaust section via the exhaust port provided at a position different from that of the opening portion.

In the image forming apparatus of the present invention having such a configuration, a negative pressure is generated within the developer containing casing at a position different from that of the opening portion.

Thus, when the gas from the gas supply section is blown into the developer containing casing via the gas-permeable bottom plate, spouting of the developer from the opening portion together with the gas can be suppressed effectively. That is, accidental leakage of the developer from the developer containing casing can be suppressed to the greatest possible extent.
The exhaust port may be diagonally positioned in relation to the gas-permeable bottom plate. The “diagonally posited” expresses the positional relation between one end side and the other end side of the developer containing casing with respect to the vertical direction and the front-rear direction.

For example, needless to say, one end of a diagonal line of the developer containing casing in a side sectional view and its vicinity and the other end opposite the one end and its vicinity are “diagonally positioned” in relation to each other.

In such a configuration, the gas from the gas supply section is blown into the developer containing casing via the gas-permeable bottom plate provided at a position corresponding to the furthest upstream portion of the developer transport surface with respect to the developer transport direction. Thus, the developer within the developer containing casing is fluidized.

Meanwhile, the gas within the developer containing casing is exhausted by the exhaust section via the exhaust port which is provided at a position different from that of the opening portion and which is diagonally positioned in relation to the gas-permeable bottom plate.

That is, in such a configuration, the gas is blown into the developer containing casing from a first position corresponding to the furthest upstream portion of the developer transport surface with respect to the developer transport direction, and the gas within the developer containing casing is exhausted from a second position which differs from that of the opening portion and is diagonally located in relation to the first position.

In the image forming apparatus of the present invention having such a configuration, a negative pressure is generated within the developer containing casing at a position different from that of the opening portion.

Thus, when the gas from the gas supply section is blown into the developer containing casing via the gas-permeable bottom plate, spouting of the developer from the opening portion together with the gas can be suppressed effectively. That is, accidental leakage of the developer from the developer containing casing can be suppressed to the greatest possible extent.
The image forming apparatus may be configured as follows: the present image forming apparatus further comprises a gas circulation passage. This gas circulation passage is configured to connect the exhaust port and the gas-permeable bottom plate outside the developer containing casing. The gas supply section and the exhaust section are formed by a pump interposed in the gas circulation passage.

In such a configuration, when the developer within the developer containing casing is to be fluidized, the pump is driven. As a result, the gas within the developer containing casing is exhausted from the exhaust port provided at a position corresponding to an upstream end portion of the gas circulation passage with respect to the gas flow direction.

Meanwhile, the gas is blown into the developer containing casing from the gas-permeable bottom plate provided at a position corresponding to a downstream end portion of the gas circulation passage with respect to the gas flow direction.

By virtue of such a configuration, through employment of a very simple apparatus structure, the developer within the developer containing casing can be fluidized, and the accidental leakage of the developer from the developer containing casing can be suppressed effectively.
The gas-permeable bottom plate may be provided at least at a position corresponding to a lowest portion of the developer containing casing.

By virtue of the image forming apparatus having such a configuration, even when the storage amount of the developer within the developer containing casing decreases, the developer at the bottom portion of the developer containing casing can be vibrated satisfactorily.

Thus, even in such a case, transport of the developer to the position which faces the latent-image forming surface can be performed properly. Therefore, such a configuration enables satisfactory image formation by the developer even in the above-described case.

(2) A developer supply apparatus of the present invention is configured to be able to supply a developer in a charged state to a developer carrying surface of a developer carrying body along a predetermined developer transport direction. The developer carrying surface is a surface which is parallel to a predetermined main scanning direction and which can carry the developer thereon.

The developer carrying body has the developer carrying surface and is configured such that the developer carrying surface can move along a sub-scanning direction orthogonal to the main scanning direction.

The developer carrying body may be an electrostatic-latent-image carrying body having a latent-image forming surface configured to be able to form an electrostatic latent image thereon by means of electric-potential distribution.

Alternatively, the developer carrying body may be a recording medium (paper) which is transported along the sub-scanning direction.

Alternatively, the developer carrying body may be a roller, a sleeve, or a belt member (a developing roller, a developing sleeve, an intermediate transfer belt, etc.) which is configured and disposed so as to be able to transfer the developer onto the recording medium or the electrostatic-latent-image carrying body by means of facing the recording medium or the electrostatic-latent-image carrying body.

The developer supply apparatus of the present invention comprises a developer containing casing, a developer transport body, and a plurality of transport electrodes.

The developer containing casing is a box-like member which includes a developing-section counter plate and a gas-permeable bottom plate.

The developing-section counter plate has an opening portion formed at a position where the counter plate faces the developer carrying body. The gas-permeable bottom plate is configured to prevent passage of the developer therethrough and permit passage of a gas therethrough. The developer containing casing is configured to be able to contain the developer therein.

The developer transport body has a developer transport surface parallel with the main scanning direction. This developer transport body is disposed within the developer containing casing such that the developer transport surface faces the developer carrying body via the opening portion of the developing-section counter plate.

The plurality of transport electrodes are provided along the developer transport surface such that they face the developer carrying surface. These transport electrodes are arrayed along the sub-scanning direction. The transport electrodes are configured in such a manner as to be able to transport the developer in the developer transport direction on the developer transport surface upon application of traveling-wave voltages.

In the developer supply apparatus of the present invention having such a configuration, the gas can be blown into the developer containing casing via the gas-permeable bottom plate. Therefore, the developer within the developer containing casing can be fluidized.

Further, predetermined traveling-wave voltages are applied to the plurality of transport electrodes arrayed along the sub-scanning direction. As a result, a predetermined electric field is formed in the vicinity of the developer transport surface of the developer transport body. This electric field is a traveling-wave electric field which travels in a direction along the sub-scanning direction.

A portion of the developer within the developer containing casing having been fluidized as described above, the portion being located near the developer transfer surface, is transported on the developer transport surface in the predetermined developer transport direction by means of the traveling-wave electric field. That portion of the developer is supplied to the position (the developing position) where the developer carrying surface and the developer transport surface (which are parallel with each other) face each other.

In this manner, the developer supply apparatus supplies the developer in a charged state to the developer carrying surface, which moves along the sub-scanning direction. Thus, the developer is carried on the developer carrying surface.

According to the developer supply apparatus of the present invention having such a configuration, a mechanical or thermal stress caused by a compressive force or shearing force at the time when the developer is fluidized is very small. Therefore, according to the present invention, it becomes possible to provide a developer supply apparatus which can perform the transport and supply of the developer by means of the traveling-wave electric field more uniformly.
Preferably, the gas-permeable bottom plate is provided at least at a position corresponding to the furthest upstream portion of the developer transport surface with respect to the developer transport direction.

By virtue of such a configuration, the developer is supplied to the furthest upstream portion of the developer transport surface as uniformly as possible. Thus, the transport of the developer on the developer transport surface and the supply of the developer to the developer carrying surface can be performed uniformly with further reduced non-uniformity.
The developer supply apparatus may further comprise a gas supply section. This gas supply section is configured to blow a gas into the interior of the developer containing casing via the gas-permeable bottom plate, to thereby fluidize the developer within the developer containing casing.

In such a configuration, the gas supply section blows the gas into the interior of the developer containing casing via the gas-permeable bottom plate. As a result, the developer within the developer containing casing is fluidized.
The developer supply apparatus may be configured as follows: the present developer supply apparatus further comprises an exhaust section. This exhaust section is configured to exhaust the gas from the developer containing casing. Further, an exhaust port is provided in the developer containing casing at a position different from that of the opening portion. The exhaust section is provided such that it communicates with the exhaust port.

In such a configuration, the gas within the developer containing casing is exhausted to the outside via the exhaust port. That is, a negative pressure can be generated within the developer containing casing at a position different from that of the opening portion.

In the developer supply apparatus of the present invention having such a configuration, when the gas is blown into the developer containing casing via the gas-permeable bottom plate, spouting of the developer from the opening portion together with the gas can be suppressed effectively. That is, accidental leakage of the developer from the developer containing casing can be suppressed to the greatest possible extent.
The exhaust port may be diagonally positioned in relation to the gas-permeable bottom plate.

In such a configuration, the gas is blown into the developer containing casing via the gas-permeable bottom plate from a first position corresponding to the furthest upstream portion of the developer transport surface with respect to the developer transport direction. Meanwhile, the gas within the developer containing casing is exhausted via the exhaust port from a second position which is diagonally located in relation to the first position.

That is, the gas can be blown into the developer containing casing, and a negative pressure can be generated within the developer containing casing at a position separated from the opening portion.

In the developer supply apparatus of the present invention having such a configuration, when the gas is blown into the developer containing casing via the gas-permeable bottom plate, spouting of the developer from the opening portion together with the gas can be suppressed effectively. That is, accidental leakage of the developer from the developer containing casing can be suppressed to the greatest possible extent.
The developer supply apparatus may be configured as follows: the present developer supply apparatus comprises a gas circulation passage. This gas circulation passage is configured to connect the exhaust port and the gas-permeable bottom plate outside the developer containing casing. The gas supply section and the exhaust section are formed by a pump interposed in the gas circulation passage.

By virtue of the developer supply apparatus of the present invention having such a configuration, fluidization of the developer within the developer containing casing and suppression of accidental leakage of the developer can be realized through employment of a very simple apparatus structure.
The gas-permeable bottom plate may be provided at least at a position corresponding to a lowest portion of the developer containing casing.

By virtue of such a configuration, even when the storage amount of the developer within the developer containing casing decreases, the developer at the bottom portion of the developer containing casing can be vibrated satisfactorily.

[1-3]

(1) An image forming apparatus of the present invention comprises an electrostatic-latent-image carrying body and a developer supply apparatus.

The electrostatic-latent-image carrying body has a latent-image forming surface. The latent-image forming surface is configured to be able to form an electrostatic latent image thereon by means of electric-potential distribution. The latent-image forming surface is formed in parallel with a predetermined main scanning direction. The electrostatic-latent-image carrying body is configured such that the latent-image forming surface can move along a sub-scanning direction orthogonal to the main scanning direction.

The developer supply apparatus is disposed in such a manner as to face the electrostatic-latent-image carrying body. The developer supply apparatus is configured to be able to supply the latent-image forming surface with a developer in a charged state. Further, this developer supply apparatus is configured such that it can be attached to and detached from the main body of the image forming apparatus.

The developer supply apparatus comprises a developer containing casing, a developer transport body, a plurality of transport electrodes, and a vibration body.

The developer containing casing is a box-like member, and is configured to be able to contain the developer therein. The developer containing casing has an opening portion formed at a position where the casing faces the electrostatic-latent-image carrying body.

The developer transport body has a developer transport surface parallel with the main scanning direction. This developer transport body is disposed within the developer containing casing such that the developer transport surface faces the electrostatic-latent-image carrying body via the opening portion.

The plurality of transport electrodes are provided along the developer transport surface such that they face the latent-image forming surface. These transport electrodes are arrayed along the sub-scanning direction. The transport electrodes are configured in such a manner as to be able to transport the developer in a predetermined developer transport direction on the developer transport surface upon application of traveling-wave voltages.

The vibration body is disposed in a space inside the developer containing casing.

The main body includes a vibration-body vibrating section. This vibration-body vibrating section is configured such that it can vibrate the vibration body. Further, the vibration-body vibrating section is provided such a position that, when the developer supply apparatus is attached to the main body, the vibration-body vibrating section is located at a position outside the developer containing casing and corresponding to the vibration body.

The image forming apparatus of the present invention having such a configuration operates as described below in formation of an image.

The developer supply apparatus is attached to the main body of the image forming apparatus. As a result, the vibration body provided in the developer supply apparatus is disposed at a position corresponding to the vibration-body vibrating section provided on the main body.

Further, an electrostatic latent image in the form of an electric-potential distribution is formed on the latent-image forming surface of the electrostatic-latent-image carrying body. The latent-image forming surface on which the electrostatic latent image is formed moves along the sub-scanning direction.

Meanwhile, predetermined traveling-wave voltages are applied to the plurality of transport electrodes arrayed along the sub-scanning direction. As a result, a predetermined electric field is formed in the vicinity of the developer transport surface of the developer transport body. This electric field is a traveling-wave electric field which travels in the developer transport direction along the sub-scanning direction.

At that time, the vibration body is vibrated by the vibration-body vibrating section provided on the main body. Due to vibration of the vibration body, the developer is vibrated within the developer containing casing. As a result, a satisfactory fluidity can be imparted to the developer (which is to be transported on the developer transport surface) within the developer containing casing.

A portion of the developer satisfactorily fluidized within the developer containing casing, the portion being located near the developer transfer surface, receives the action of the traveling-wave electric field. As a result, that portion of the developer is transported on the developer transport surface in the developer transport direction toward the developing position. The developing position is a position at which the latent-image forming surface and the developer transport surface (which are parallel with each other) face in the closest proximity to each other.

In this manner, the developer in a charged state is supplied to the developing position by the developer supply apparatus. Thus, the electrostatic latent image on the latent-image forming surface is developed (rendered visible) with the developer.

According to the image forming apparatus of the present invention having such a configuration, the developer (which is to be transported on the developer transport surface) within the developer containing casing of the developer supply apparatus which can be attached to and detached from the main body is effectively fluidized.

By virtue of this, on the developer transport surface, the developer can be transported as uniformly as possible. At that time, application of large stresses, such as aggregation force and shearing force, on the developer can be suppressed to the greatest possible extent.

Thus, according to the developer supply apparatus of the image forming apparatus of the present invention, the transport and supply of the developer by means of the traveling-wave electric field can be performed more uniformly. Therefore, according to the image forming apparatus of the present invention, generation of density non-uniformity is effectively suppressed, and a satisfactory image can be formed.
The vibration body may be disposed at a bottom portion of the space inside the developer containing casing.

In the image forming apparatus of the present invention having such a configuration, the vibration body is vibrated at the bottom portion of the space inside the developer containing casing. Due to the vibration of the vibration body, the developer at the bottom of the space is vibrated.

Thus, a satisfactory fluidity can be imparted to the developer stored within the developer containing casing. The developer stored within the developer containing casing refers to the developer contained within the developer containing casing, excluding the developer on the developer transport surface. That is, the developer stored within the developer containing casing refers to the developer stored at the bottom portion of the space inside the developer containing casing.

According to the image forming apparatus of the present invention having such a configuration, fluidization of the developer stored within the developer containing casing by the vibration body can be performed more reliably.
The vibration body may be configured to be able to vibrate the entirety of the developer stored in the developer containing casing.

Alternatively, the vibration body may be configured to be able to vibrate at least a predetermined developer transport start area of a developer pool.

The developer pool refers to an ensemble of the developer stored within the developer containing casing. Further, the developer transport start area refers to the uppermost end portion of the developer pool within the developer containing casing, the end portion located on the downstream side with respect to the developer transport direction. The position of the developer transport start area changes depending on the amount of the developer pool (the amount of the developer stored within the developer containing casing).

For example, a plurality of vibration bodies may be provided. The vibration-body vibrating section is configured and disposed such that the vibrating states of the plurality of vibration bodies are controlled in accordance with the amount of the developer pool.

In the above-described configurations, by means of vibration of the vibration body, a satisfactory fluidity is imparted to the developer (which is to be transported on the developer transport surface) in the developer transport start area, at which transfer of the developer starts.

Thus, according to the above-described configurations, the developer in the developer transport start area within the developer containing casing of the developer supply apparatus which can be attached to and detached from the main body is satisfactorily fluidized. Therefore, the operation of rendering uniform the transport and supply of the developer by means of the traveling-wave electric field can be performed more reliably.

(2) An image forming apparatus of the present invention comprises an electrostatic-latent-image carrying body and a developer supply apparatus. The electrostatic-latent-image carrying body is configured in the same manner as described in section (1) above.

The developer supply apparatus is disposed in such a manner as to face the electrostatic-latent-image carrying body. The developer supply apparatus is configured to be able to supply the latent-image forming surface with a developer in a charged state.

Specifically, the developer supply apparatus comprises a developer containing casing, a developer transport body, a plurality of transport electrodes, and a developer vibrating section.

The developer containing casing is a box-like member, and is configured to be able to contain the developer therein. The developer containing casing has an opening portion formed at a position where the casing faces the electrostatic-latent-image carrying body.

The developer transport body has a developer transport surface parallel with the main scanning direction. This developer transport body is disposed within the developer containing casing such that the developer transport surface faces the electrostatic-latent-image carrying body via the opening portion.

The plurality of transport electrodes are provided along the developer transport surface such that they face the latent-image forming surface. These transport electrodes are arrayed along the sub-scanning direction. The transport electrodes are configured in such a manner as to be able to transport the developer in a predetermined developer transport direction on the developer transport surface upon application of traveling-wave voltages.

The developer vibrating section is configured to be able to vibrate the developer (which is contained in the developer containing casing and which is to be transported on the developer transport surface) from the outside of the developer containing casing.

The image forming apparatus of the present invention having such a configuration operates as described below in formation of an image.

An electrostatic latent image in the form of an electric-potential distribution is formed on the latent-image forming surface of the electrostatic-latent-image carrying body. The latent-image forming surface on which the electrostatic latent image is formed moves along the sub-scanning direction.

Meanwhile, the developer which is contained (stored) in the developer containing casing and which is to be transported on the developer transport surface is vibrated by the developer vibrating section from the outside of the developer containing casing. Thus, a satisfactory fluidity is imparted to the developer.

Further, predetermined traveling-wave voltages are applied to the plurality of transport electrodes arrayed along the sub-scanning direction. As a result, a traveling-wave electric field which travels in the developer transport direction along the sub-scanning direction is formed in the vicinity of the developer transport surface of the developer transport body.

A portion of the developer within the developer containing casing having been satisfactorily fluidized as described above, the portion being located near the developer transfer surface, is transported on the developer transport surface in the predetermined developer transport direction by means of the traveling-wave electric field. That portion of the developer is supplied to a position (the developing position) where the latent-image forming surface and the developer transport surface (which are parallel with each other) face in the closest proximity to each other.

In this manner, the developer supply apparatus supplies the developer in a charged state to the latent-image forming surface on which the electrostatic latent image is formed. Thus, the electrostatic latent image is developed (rendered visible) with the developer.

According to the image forming apparatus of the present invention having such a configuration, the developer (which is to be transported on the developer transport surface) is effectively fluidized by use of a simple apparatus structure. By virtue of this, on the developer transport surface, the developer can be transported as uniformly as possible. At that time, application of large stresses, such as aggregation force and shearing force, on the developer can be suppressed to the greatest possible extent.

Thus, according to the image forming apparatus of the present invention having such a configuration, the transport and supply of the developer by means of the traveling-wave electric field can be performed more uniformly by use of a simple apparatus structure. Therefore, according to the present invention, generation of density non-uniformity is effectively suppressed, and a satisfactory image can be formed.
The developer vibrating section may be disposed to be able to vibrate the developer at a bottom portion of the space inside the developer containing casing.

In the image forming apparatus of the present invention having such a configuration, the developer at the bottom portion of the space is vibrated by the developer vibrating section. Thus, a satisfactory fluidity can be imparted to the developer stored within the developer containing casing.

According to the image forming apparatus of the present invention having such a configuration, fluidization of the developer stored within the developer containing casing by the vibration body can be performed more reliably.
The developer vibration section may include a vibration body and a vibration-body vibrating section. The vibration body is disposed in the space inside the developer containing casing. The vibration-body vibrating section is configured to be able to vibrate the vibration body. This vibration-body vibrating section is provided outside the developer containing casing at a position corresponding to the vibration body.

In the image forming apparatus of the present invention having such a configuration, at that time, the vibration body is vibrated by the vibration-body vibrating section. Thus, the developer contained (stored) in the developer containing casing is vibrated. As a result, a satisfactory fluidity can be imparted to the developer (which is to be transported on the developer transport surface) within the developer containing casing.

Therefore, accordingly the image forming apparatus of the present invention having such a configuration, fluidization of the developer contained (stored) in the developer containing casing by the vibration body can be performed more reliably by use of a simple apparatus structure.
The image forming apparatus may be configured as follows: the developer supply apparatus is configured such that it can be attached to and detached from the main body of the image forming apparatus. The vibration-body vibrating section is provided on the main body. The vibration-body vibrating section is provided such a position that, when the developer supply apparatus is attached to the main body, the vibration-body vibrating section is located at a position outside the developer containing casing and corresponding to the vibration body.

In the image forming apparatus of the present invention having such a configuration, the vibration body provided in the space inside the developer containing casing is vibrated by the vibration-body vibrating section provided on the main body. As a result, a satisfactory fluidity can be imparted to the developer contained (stored) in the developer containing casing.

Therefore, on the developer transport surface, the developer can be transported as uniformly as possible. At that time, application of large stresses, such as aggregation force and shearing force, on the developer can be suppressed to the greatest possible extent.

Thus, according to the image forming apparatus of the present invention having such a configuration, the transport and supply of the developer to the developing position by means of the traveling-wave electric field can be performed more uniformly by use of a simple apparatus structure. Therefore, generation of density non-uniformity is effectively suppressed, and a satisfactory image can be formed.
The developer vibrating section may be configured to be able to vibrate the developer while suppressing direct transmission of vibration to the developer containing casing.

In such a configuration, when the developer vibrating section vibrates the developer contained (stored) in the developer containing casing, direct transmission of vibration to the developer containing casing can be suppressed. Thus, there is prevented, to the greatest possible extent, a change in the predetermined positional relation between the latent-image forming surface and the developer transport surface at the developing position, which change would otherwise result from the vibration.

Therefore, by virtue of such a configuration, generation of noise due to vibration of the developer containing casing can be suppressed to the greatest possible extent. Further, by virtue of such a configuration, it is possible to suppress, to the greatest possible extent, a distortion of a formed image, which distortion would otherwise occur when the predetermined positional relation changes due to the vibration.
The developer vibrating section may be configured to be able to vibrate the entirety of the developer stored in the developer containing casing. Alternatively, the developer vibrating section may be configured to be able to vibrate at least the developer transport start area of the developer pool.

In these configurations, by means of vibration of the vibration body, a satisfactory fluidity is imparted to the developer (which is to be transported on the developer transport surface) in the developer transport start area, at which transfer of the developer starts.

Thus, according to these configurations, the developer in the developer transport start area can be satisfactorily fluidized within the developer containing casing of the developer supply apparatus which can be attached to and detached from the main body.

(3) The above-described image forming apparatuses may be configured as follows.
The vibration body may be provided within the space of the developer containing casing such that the vibration body is separated from an inner wall surface of the developer containing casing. Further, the vibration body may be supported by the developer containing casing such that it can oscillate. This vibration body may be formed of a wire-shaped or rod-shaped member.

In the image forming apparatus of the present invention having such a configuration, the vibration body is separated from the inner wall surface. Therefore, when the developer contained (stored) in the developer containing casing is vibrated by means of vibration of the vibration body, direct transmission of the vibration from the vibration body to the developer containing casing can be suppressed.

Therefore, according to the image forming apparatus of the present invention having such a configuration, generation of noise due to vibration of the developer containing casing can be suppressed to the greatest possible extent. Further, it is possible to suppress, to the greatest possible extent, a distortion of a formed image, which distortion would otherwise occur when the predetermined positional relation between the latent-image forming surface and the developer transport surface at the developing position changes due to the vibration.
The vibration body may be a vibration rod, which is a rod-shaped member which extends along the main scanning direction. Opposite end portions of the vibration rod with respect to the main scanning direction may be supported on the developer containing casing via an elastic member.

In the image forming apparatus of the present invention having such a configuration, when the developer contained (stored) in the developer containing casing is vibrated by means of vibration of the vibration rod, direct transmission of the vibration from the vibration body to the developer containing casing can be suppressed by the elastic member.

Therefore, according to the image forming apparatus of the present invention having such a configuration, direct transmission of vibration from the vibration rod to the developer containing casing can be suppressed more effectively.
The vibration-body vibrating section may be magnetically coupled with the vibration rod at one end of the vibration rod with respect to the main scanning direction.

According to the image forming apparatus of the present invention, through use of a simple apparatus structure, there can be realized a structure in which the vibration rod provided within the developer containing casing of the developer supply apparatus can be vibrated by the vibration-body vibrating section provided outside the developer containing casing of the developer supply apparatus, which can be attached to and detached from the image forming apparatus.

(4) A developer supply apparatus of the present invention is configured to be able to supply a developer in a charged state to a developer carrying surface of a developer carrying body along a predetermined developer transport direction. The developer carrying surface is a surface which is parallel to a predetermined main scanning direction and which can carry the developer thereon.

The developer carrying body has the developer carrying surface and is configured such that the developer carrying surface can move along a sub-scanning direction orthogonal to the main scanning direction. The developer carrying body may be an electrostatic-latent-image carrying body having a latent-image forming surface configured to be able to form an electrostatic latent image thereon by means of electric-potential distribution. Alternatively, the developer carrying body may be a recording medium (paper) which is transported along the sub-scanning direction. Alternatively, the developer carrying body may be a roller, a sleeve, or a belt member (a developing roller, a developing sleeve, an intermediate transfer belt, etc.) which is configured and disposed so as to be able to transfer the developer onto the recording medium or the electrostatic-latent-image carrying body by means of facing the recording medium or the electrostatic-latent-image carrying body.

The developer supply apparatus of the present invention comprises a developer containing casing, a developer transport body, a plurality of transport electrodes, and a vibration body.

The developer containing casing is a box-like member, and is configured to be able to contain the developer therein. The developer containing casing has an opening portion formed at a position where the casing faces the developer carrying body.

The developer transport body has a developer transport surface parallel with the main scanning direction. This developer transport body is disposed within the developer containing casing such that the developer transport surface faces the developer carrying body via the opening portion.

The plurality of transport electrodes are provided along the developer transport surface such that they face the developer carrying surface. These transport electrodes are arrayed along the sub-scanning direction. The transport electrodes are configured in such a manner as to be able to transport the developer in the developer transport direction on the developer transport surface upon application of traveling-wave voltages.

The vibration body is disposed in a space inside the developer containing casing.

In the developer supply apparatus of the present invention having such a configuration, the developer within the developer containing casing is vibrated as a result of the vibration body vibrating. With this, the developer can be fluidized.

Further, predetermined traveling-wave voltages are applied to the plurality of transport electrodes arrayed along the sub-scanning direction. As a result, a predetermined electric field is formed in the vicinity of the developer transport surface of the developer transport body. This electric field is a traveling-wave electric field which travels in a direction along the sub-scanning direction.

A portion of the developer within the developer containing casing having been fluidized as described above, the portion being located near the developer transfer surface, is transported on the developer transport surface in the predetermined developer transport direction by means of the traveling-wave electric field. That portion of the developer is supplied to a position (facing position) where the developer carrying surface and the developer transport surface (which are parallel with each other) face in the closest proximity to each other.

In this manner, the developer supply apparatus supplies the developer in a charged state to the developer carrying surface, which moves along the sub-scanning direction. Thus, the developer is carried on the developer carrying surface.

According to the developer supply apparatus of the present invention, the developer which is to be transported on the developer transport surface is effectively fluidized. At that time, application of large stresses, such as aggregation force and shearing force, on the developer can be suppressed to the greatest possible extent.

Thus, according to the developer supply apparatus of the present invention, the transport and supply of the developer to the facing position by means of the traveling-wave electric field can be performed more uniformly.
The developer supply apparatus may be configured as follows: the vibration body is disposed at a bottom portion of the space inside the developer containing casing. This vibration body is configured to be able to vibrate the developer which is to be transported on the developer transport surface.

In the developer supply apparatus of the present invention having such a configuration, the vibration body is vibrated at the bottom portion of the space inside the developer containing casing. Due to the vibration of the vibration body, the developer which is stored in the developer containing casing and is to be transported on the developer transport surface is vibrated at the bottom portion of the space.

Therefore, according to the developer supply apparatus of the present invention having such a configuration, fluidization of the developer stored within the developer containing casing by the vibration body can be performed more reliably.
The developer supply apparatus may be configured as follows: the vibration body is provided such that the vibration body is separated from the inner wall surface of the developer containing casing. Further, the vibration body is supported by the developer containing casing such that it can oscillate.

In the developer supply apparatus of the present invention having such a configuration, the vibration body is separated from the inner wall surface. Therefore, when the developer contained (stored) in the developer containing casing is vibrated by means of vibration of the vibration body, direct transmission of the vibration from the vibration body to the developer containing casing can be suppressed.

Therefore, according to the developer supply apparatus of the present invention having such a configuration, generation of noise due to vibration of the developer containing casing can be suppressed to the greatest possible extent. Further, it is possible to suppress, to the greatest possible extent, a distortion of a formed image, which distortion would otherwise occur when the predetermined positional relation between the developer carrying surface and the developer transport surface at the facing position changes due to the vibration.
The vibration body may be formed of a wire-shaped or rod-shaped member.
The developer supply apparatus may be configured as follows: the vibration body is a vibration rod, which is a rod-shaped member which extends along the main scanning direction. Opposite end portions of the vibration rod with respect to the main scanning direction are supported on the developer containing casing via an elastic member.

In the developer supply apparatus of the present invention having such a configuration, when the developer contained (stored) in the developer containing casing is vibrated by means of vibration of the vibration rod, direct transmission of the vibration from the vibration body to the developer containing casing can be suppressed by the elastic member.

Therefore, according to the developer supply apparatus of the present invention having such a configuration, direct transmission of vibration from the vibration rod to the developer containing casing can be suppressed more effectively.

[2] In the conventional electric-field curtain mechanism as described above, the quality (density or uniformity) of a formed image may change with a change in the amount of the developer within the container. Such a change in image quality occurs due to a change in the amount of the developer transported on the plate-shaped member.

That is, the amount of the developer transported on the plate-shaped member changes in accordance with the amount of the developer within the container. As a result, the amount of the developer supplied to the developing section changes. Due to this change in the supply amount, density change and/or density non-uniformity occurs.

In particular, when the amount of the developer contained in the container (storage amount) decreases, the developer stored at the bottom portion of the container may not be supplied to the plate-shaped member properly. In such a case, the lack of the supply amount of the developer to the developing section proceeds rapidly, so that density insufficiency and/or density non-uniformity may occur suddenly.

The present invention has been accomplished in order to solve such problems. That is, an object of the present invention is to provide a developer supply apparatus and an image forming apparatus which can suppress change in image quality to the greatest possible extent, which change occurs due to change in the contained amount (storage amount) of the developer.

(1) An image forming apparatus of the present invention comprises an electrostatic-latent-image carrying body and a developer supply apparatus.

The electrostatic-latent-image carrying body has a latent-image forming surface. The latent-image forming surface is configured to be able to form an electrostatic latent image thereon by means of electric-potential distribution. The latent-image forming surface is formed in parallel with a predetermined main scanning direction.

The electrostatic-latent-image carrying body is configured such that the latent-image forming surface can move along a sub-scanning direction orthogonal to the main scanning direction.

The developer supply apparatus is disposed in such a manner as to face the electrostatic-latent-image carrying body. The developer supply apparatus is configured to be able to supply the latent-image forming surface with a developer in a charged state.

Specifically, the developer supply apparatus of the image forming apparatus of the present invention comprises a developer containing casing, a developer transport body, a plurality of first transport electrodes, and a plurality of second transport electrodes.

The developer containing casing is a box-like member, and is configured to be able to contain the developer therein. The developer containing casing includes a top plate and a bottom plate provided such that it faces the top plate. The top plate of the developer containing casing has an opening portion formed at a position where the top plate faces the electrostatic-latent-image carrying body.

The developer transport body has a developer main transport surface parallel with the main scanning direction. This developer transport body is disposed within the developer containing casing such that the developer main transport surface faces the electrostatic-latent-image carrying body via the opening portion of the top plate.

The plurality of first transport electrodes are provided along the developer main transport surface such that they face the latent-image forming surface. These first transport electrodes are arrayed along the sub-scanning direction. The first transport electrodes are configured in such a manner as to be able to transport the developer in a predetermined developer main transport direction on the developer main transport surface upon application of traveling-wave voltages.

The plurality of second transport electrodes are provided along a sloped developer sub-transport surface and along the bottom plate of the developer containing casing. These second transport electrodes are arrayed along the sub-scanning direction. The second transport electrodes are configured in such a manner as to be able to transport the developer in a predetermined developer sub-transport direction on the developer sub-transport surface upon application of traveling-wave voltages.

In the image forming apparatus of the present invention, the developer sub-transport surface is formed into the form of a flat surface which intersects with a horizontal plane so that the developer sub-transport surface forms a constant angle in relation to the horizontal plane. For example, the developer sub-transport surface may be formed so that the angle formed between the developer sub-transport surface and the horizontal plane always becomes 30 degree or less.

Further, the developer sub-transport surface may form a slope which ascends toward an upstream end portion of the developer main transport surface with respect to the developer main transport direction. In this case, the developer sub-transport direction is a direction in which the developer moves up along the developer sub-transport surface toward the upstream end portion of the developer main transport surface with respect to the developer main transport direction.

The image forming apparatus of the present invention having such a configuration operates as described below in formation of an image.

An electrostatic latent image in the form of an electric-potential distribution is formed on the latent-image forming surface of the electrostatic-latent-image carrying body. The latent-image forming surface on which the electrostatic latent image is formed moves along the sub-scanning direction.

Meanwhile, predetermined traveling-wave voltages are applied to the plurality of first transport electrodes arrayed along the sub-scanning direction. As a result, a predetermined electric field is formed along the developer main transport surface of the developer transport body. This electric field is a traveling-wave electric field which travels in the developer main transport direction along the sub-scanning direction.

Further, predetermined traveling-wave voltages are applied to the plurality of second transport electrodes arrayed along the sub-scanning direction. As a result, a predetermined electric field is formed along the developer sub-transport surface. This electric field is a traveling-wave electric field which travels in the developer sub-transport direction along the sub-scanning direction.

The developer contained within the developer containing casing is transported on the developer sub-transport surface in the developer sub-transport direction by means of the traveling-wave electric field. This transfer of the developer on the developer sub-transport surface starts from a predetermined developer transport start area.

This developer transport start area refers to an area near a position at which the uppermost end portion of a developer pool within the developer containing casing and the developer sub-transport surface are in the closest proximity to each other. The developer pool refers to an ensemble of the developer stored in a space at the bottom portion of the developer containing casing.

Further, the developer is transported on the developer main transport surface in the developer main transport direction by means of the traveling-wave electric field. The developer is supplied to a position (the developing position) where the latent-image forming surface and the developer main transport surface (which are parallel with each other) face each other.

After that, the developer having passed through the developing position returns to the developer pool, while being transported on the developer main transport surface in the developer main transport direction.

In this manner, the developer supply apparatus supplies the developer in a charged state to the latent-image forming surface on which the electrostatic latent image is formed. Thus, the electrostatic latent image is developed (rendered visible) with the developer.

In the image forming apparatus of the present invention having such a configuration, the angle between the top surface of the developer pool and the developer sub-transport surface at the above-described developer transport start area (hereinafter referred to as the “developer contact angle”) becomes substantially constant.

When the developer contact angle changes with change in the contained amount (storage amount) of the developer within the developer containing casing, the state of supply of the developer to the developer sub-transport surface in the developer transport start area and the state of transport of the developer from the developer transport start area to the downstream side with respect to the developer sub-transport direction change.

In contrast, according to the present invention, as described above, change in the developer contact angle with change in the contained amount (storage amount) of the developer within the developer containing casing is suppressed to the greatest possible extent.

Thus, the state of supply of the developer to the developer sub-transport surface in the developer transport start area and the state of transport of the developer from the developer transport start area to the downstream side with respect to the developer sub-transport direction can be stabilized.

Therefore, according to the image forming apparatus of the present invention, change in image quality with change in the contained amount (storage amount) of the developer can be suppressed to the greatest possible extent.

The image forming apparatus may be configured as follows: the second transport electrodes are provided along the developer sub-transport surface and a developer auxiliary transport surface. A downstream end portion of the developer sub-transport surface with respect to the developer sub-transport direction is connected to the developer auxiliary transport surface. The plurality of second transport electrodes are configured to be able to transport the developer toward a predetermined position.

The developer auxiliary transport surface includes at least a surface along an inner wall surface of the top plate of the developer containing casing, the inner wall surface being located on the upstream side of the opening portion with respect to the developer main transport direction. Further, the predetermined position is a position at which an upstream end portion of the developer main transport surface with respect to the developer main transport direction and the developer sub-transport surface or the developer auxiliary transport surface face in the closest proximity to each other.

In such a configuration, on the developer sub-transport surface, the developer is transported in the developer sub-transport direction. As a result, the developer reaches the developer auxiliary transport surface located downstream of the developer sub-transport surface with respect to the developer sub-transport direction.

After that, on the developer auxiliary transport surface, the developer is transported to the above-described predetermined position. Thus, the developer reaches the developer main transport surface. The developer is then transported on the developer main transport surface in the developer main transport direction, whereby the developer is supplied to the developing position.

According to such a configuration, the developer is reliably transported from the developer sub-transport surface to the developer main transport surface. Therefore, the state of supply of the developer to the developer main transport surface and the developing position are stabilized further.
The image forming apparatus may further comprise a developer vibrating section.

The developer vibrating section is configured to be able to vibrate the developer (the developer pool) contained (stored) in the developer containing casing. Preferably, the developer vibrating section is configured to be able to vibrate at least the developer in the developer transport start area.

In such a configuration, the developer stored in the developer containing casing (which is to be transported on the developer main transport surface) is vibrated by the developer vibrating section. Thus, a satisfactory fluidity is imparted to the developer (preferably, in the developer transport start area).

By virtue of such a configuration, the amount of the developer supplied from the developer pool (the developer transport start area) to the developer sub-transport surface can be rendered uniform to the greatest possible extent in the main scanning direction and the sub-scanning direction.

As a result, the amount of the developer transported from the developer pool (the developer transport start area) to the downstream side with respect to the developer sub-transport direction can be rendered uniform to the greatest possible extent in the main scanning direction and the sub-scanning direction.

Further, application of large stresses, such as aggregation force and shearing force, on the developer in the developer pool can be suppressed to the greatest possible extent.

Accordingly, by virtue of such a configuration, generation of density non-uniformity is suppressed effectively, and a satisfactory image can be formed.
The developer vibration section may include a vibration element and a vibration-element drive section.

The vibration element is disposed within the developer containing casing such that the vibration element is separated from the developer sub-transport surface. This vibration element is supported by the developer containing casing such that the vibration element can oscillate.

Further, the vibration-element drive section is configured to be able to vibrate the vibration element from the outside of the developer containing casing. This vibration-element drive section is disposed outside the developer containing casing.

In such a configuration, the vibration element vibrates in a state in which the vibration element is separated from the developer containing casing and the developer transport body. Thus, the vibration generated by the vibration element is not transmitted directly to the developer containing casing and the developer transport body.

Therefore, by virtue of this configuration, there is prevented, to the greatest possible extent, a change in a predetermined positional relation between the latent-image forming surface of the electrostatic-image carrying body and the developer main transport surface of the developer transport body, which change would otherwise result from vibration of the vibration element.

Thus, it is possible to satisfactorily fluidize the developer to thereby render uniform the state of transport of the developer on the developer main transport surface and the developer sub-transport surface, while suppressing adverse influence on development of the electrostatic latent image to the greatest possible extent.

(2) An image forming apparatus of the present invention comprises an electrostatic-latent-image carrying body and a developer supply apparatus. The electrostatic-latent-image carrying body is configured in the same manner as described in section (1) above.

The developer supply apparatus is disposed in such a manner as to face the electrostatic-latent-image carrying body. The developer supply apparatus is configured to be able to supply the latent-image forming surface with a developer in a charged state.

Specifically, the developer supply apparatus comprises a developer containing casing, a developer transport body, a plurality of first transport electrodes, and a plurality of second transport electrodes.

The developer containing casing is a box-like member, and is configured to be able to contain the developer therein. The developer containing casing includes a top plate and a bottom plate provided such that it faces the top plate. The top plate of the developer containing casing has an opening portion formed at a position where the top plate faces the electrostatic-latent-image carrying body.

The developer transport body has a developer main transport surface parallel with the main scanning direction. This developer transport body is disposed within the developer containing casing such that the developer main transport surface faces the electrostatic-latent-image carrying body via the opening portion of the top plate.

The plurality of first transport electrodes are provided along the developer main transport surface such that they face the latent-image forming surface. These first transport electrodes are arrayed along the sub-scanning direction. The first transport electrodes are configured in such a manner as to be able to transport the developer in a predetermined developer main transport direction on the developer main transport surface upon application of traveling-wave voltages.

The plurality of second transport electrodes are provided along a sloped developer sub-transport surface. These second transport electrodes are arrayed along the sub-scanning direction. The second transport electrodes are configured in such a manner as to be able to transport the developer in a predetermined developer sub-transport direction on the developer sub-transport surface upon application of traveling-wave voltages.

In the image forming apparatus of the present invention, the developer sub-transport surface is a surface extending along the upper surface of the bottom plate of the developer containing casing, and is formed such that the angle formed between the developer sub-transport surface and the horizontal plane always becomes 30 degree or less.

The developer sub-transport surface may form a slope which ascends toward an upstream end portion of the developer main transport surface with respect to the developer main transport direction. In this case, the developer sub-transport direction is a direction in which the developer moves up along the developer sub-transport surface toward the upstream end portion of the developer main transport surface with respect to the developer main transport direction.

The image forming apparatus of the present invention having such a configuration operates as described below in formation of an image.

The above-described electrostatic latent image is formed on the latent-image forming surface. The latent-image forming surface on which the electrostatic latent image is formed moves along the sub-scanning direction.

Meanwhile, predetermined traveling-wave voltages are applied to the plurality of first transport electrodes arrayed along the sub-scanning direction. As a result, a traveling-wave electric field which travels in the developer main transport direction is formed along the developer main transport surface of the developer transport body.

Further, predetermined traveling-wave voltages are applied to the plurality of second transport electrodes arrayed along the sub-scanning direction. As a result, a traveling-wave electric field which travels in the developer sub-transport direction is formed along the developer sub-transport surface.

The developer contained within the developer containing casing is transported on the developer sub-transport surface in the developer sub-transport direction by means of the traveling-wave electric field. This transport of the developer starts from a predetermined developer transport start area.

This developer transport start area refers to an area near a position at which the uppermost end portion of a developer pool within the developer containing casing and the developer sub-transport surface are in the closest proximity to each other. The developer pool refers to an ensemble of the developer stored in a space at the bottom portion of the developer containing casing.

The developer is transported on the developer main transport surface in the developer main transport direction by means of the traveling-wave electric field. The developer is supplied to a position (the developing position) where the latent-image forming surface and the developer main transport surface (which are parallel with each other) face each other.

After that, the developer having passed through the developing position returns to the developer pool, while being transported on the developer main transport surface in the developer main transport direction.

In the image forming apparatus having such a configuration, the angle between the top surface of the developer pool and the developer sub-transport surface at the above-described developer transport start area (hereinafter referred to as the “developer contact angle”) always becomes 30 degrees or less. Therefore, the influence of the above-described traveling-wave electric field extends over the greater portion of the developer in the developer transport start area.

Therefore, by virtue such a configuration, the amount of the developer supplied to the developer sub-transport surface in the developer transport start area can be increased to the greatest possible extent. Thus, the amount of the developer transported from the developer transport start area to the downstream side with respect to the developer sub-transport direction and the amount of the developer transported on the developer main transport surface can be secured to the greatest possible extent.

Therefore, according to the image forming apparatus of the present invention, change in image quality can be suppressed to the greatest possible extent.
The image forming apparatus may be configured as follows: the second transport electrodes are provided along the developer sub-transport surface and a developer auxiliary transport surface. A downstream end portion of the developer sub-transport surface with respect to the developer sub-transport direction is connected to the developer auxiliary transport surface. The plurality of second transport electrodes are configured to be able to transport the developer toward a predetermined position.

The developer auxiliary transport surface includes at least a surface along an inner wall surface of the top plate of the developer containing casing, the inner wall surface being located on the upstream side of the opening portion with respect to the developer main transport direction. Further, the predetermined position is a position at which an upstream end portion of the developer main transport surface with respect to the developer main transport direction and the developer sub-transport surface or the developer auxiliary transport surface face in the closest proximity to each other.

According to such a configuration, the developer can be reliably transported from the developer sub-transport surface to the developer main transport surface with the mediation of the auxiliary transport surface. Therefore, the state of supply of the developer to the developer main transport surface and the developing position can be stabilized further.
The image forming apparatus may further comprise a developer vibrating section. This developer vibrating section is configured to be able to vibrate the developer (the developer pool) contained (stored) in the developer containing casing. Preferably, the developer vibrating section is configured to be able to vibrate at least the developer in the developer transport start area.

In such a configuration, the developer stored in the developer containing casing (which is to be transported on the developer main transport surface) is vibrated by the developer vibrating section. Thus, a satisfactory fluidity is imparted to the developer (preferably, in the developer transport start area).

By virtue of such a configuration, the amount of the developer supplied from the developer pool (the developer transport start area) to the developer sub-transport surface and the amount of the developer transported from the developer pool (the developer transport start area) to the downstream side with respect to the developer sub-transport direction can be rendered uniform to the greatest possible extent in the main scanning direction and the sub-scanning direction. Further, application of large stresses, such as aggregation force and shearing force, on the developer in the developer pool can be suppressed to the greatest possible extent. Accordingly, generation of density non-uniformity is suppressed effectively, and a satisfactory image can be formed.
The developer vibration section may include a vibration element and a vibration-element drive section.

The vibration element is disposed within the developer containing casing such that the vibration element is separated from the developer sub-transport surface. This vibration element is supported by the developer containing casing such that the vibration element can oscillate.

Further, the vibration-element drive section is configured to be able to vibrate the vibration element from the outside of the developer containing casing. This vibration-element drive section is disposed outside the developer containing casing.

In such a configuration, the vibration element which vibrates is separated from the developer containing casing and the developer transport body. Therefore, there is prevented, to the greatest possible extent, a change in a predetermined positional relation between the latent-image forming surface of the electrostatic-image carrying body and the developer main transport surface of the developer transport body, which change would otherwise result from vibration of the vibration element.

Therefore, according such a configuration, it is possible to satisfactorily fluidize the developer to thereby render uniform the state of transport of the developer on the developer main transport surface and the developer sub-transport surface, while suppressing adverse influence on development of the electrostatic latent image to the greatest possible extent.

(3) A developer supply apparatus of the present invention is configured to be able to supply a developer in a charged state to a developer carrying surface of a developer carrying body along a predetermined developer transport direction. The developer carrying surface is a surface which is parallel to a predetermined main scanning direction and which can carry the developer thereon.

The developer carrying body has the developer carrying surface and is configured such that the developer carrying surface can move along a sub-scanning direction orthogonal to the main scanning direction.

The developer carrying body may be an electrostatic-latent-image carrying body having a latent-image forming surface configured to be able to form an electrostatic latent image thereon by means of electric-potential distribution.

Alternatively, the developer carrying body may be a recording medium (paper) which is transported along the sub-scanning direction.

Alternatively, the developer carrying body may be a roller, a sleeve, or a belt member (a developing roller, a developing sleeve, an intermediate transfer belt, etc.) which is configured and disposed so as to be able to transfer the developer onto the recording medium or the electrostatic-latent-image carrying body by means of facing the recording medium or the electrostatic-latent-image carrying body.

The developer supply apparatus of the present invention comprises a developer containing casing, a developer transport body, and a plurality of transport electrodes.

The developer containing casing is a box-like member, and is configured to be able to contain the developer therein. The developer containing casing includes a top plate and a bottom plate provided such that it faces the top plate. The top plate of the developer containing casing has an opening portion formed at a position where the top plate faces the developer carrying body.

The developer transport body has a developer main transport surface parallel with the main scanning direction. This developer transport body is disposed within the developer containing casing such that the developer main transport surface faces the developer carrying body via the opening portion of the top plate.

The plurality of first transport electrodes are provided along the developer main transport surface such that they face the developer carrying surface. These first transport electrodes are arrayed along the sub-scanning direction. The first transport electrodes are configured in such a manner as to be able to transport the developer in a predetermined developer main transport direction on the developer main transport surface upon application of traveling-wave voltages.

The plurality of second transport electrodes are provided along a sloped developer sub-transport surface and along the bottom plate of the developer containing casing. These second transport electrodes are arrayed along the sub-scanning direction. The second transport electrodes are configured in such a manner as to be able to transport the developer in a predetermined developer sub-transport direction on the developer sub-transport surface upon application of traveling-wave voltages.

In the developer supply apparatus of the present invention, the developer sub-transport surface is formed into the form of a flat surface which intersects with a horizontal plane so that the developer sub-transport surface forms a constant angle in relation to the horizontal plane. For example, the developer sub-transport surface may be formed so that the angle formed between the developer sub-transport surface and the horizontal plane always becomes 30 degree or less.

Further, the developer sub-transport surface may form a slope which ascends toward an upstream end portion of the developer main transport surface with respect to the developer main transport direction. In this case, the developer sub-transport direction is a direction in which the developer moves up along the developer sub-transport surface toward the upstream end portion of the developer main transport surface with respect to the developer main transport direction.

The developer supply apparatus of the present invention having such a configuration operates as described below.

The developer carrying surface of the developer carrying body moves along the sub-scanning direction.

Meanwhile, predetermined traveling-wave voltages are applied to the plurality of first transport electrodes and the plurality of second transport electrodes arrayed along the sub-scanning direction.

As a result, a traveling-wave electric field which travels in the developer main transport direction along the sub-scanning direction is formed along the developer main transport surface of the developer transport body. Further, a traveling-wave electric field which travels in the developer sub-transport direction along the sub-scanning direction is formed along the developer sub-transport surface.

The developer contained within the developer containing casing is transported on the developer sub-transport surface in the developer sub-transport direction by means of the traveling-wave electric field. This transfer of the developer on the developer sub-transport surface starts from a predetermined developer transport start area of a developer pool.

The developer pool refers to an ensemble of the developer stored in a space at the bottom portion of the developer containing casing. The developer transport start area refers to an area near a position at which the uppermost end portion of the developer pool within the developer containing casing and the developer sub-transport surface are in the closest proximity to each other.

In such a configuration, the angle between the top surface of the developer pool and the developer sub-transport surface at the above-described developer transport start area (hereinafter referred to as the “developer contact angle”) becomes substantially constant.

That is, according to such a configuration, change in the developer contact angle changes with change in the contained amount (storage amount) of the developer within the developer containing casing is suppressed to the greatest possible extent.

Thus, the state of supply of the developer to the developer sub-transport surface in the developer transport start area and the state of transport of the developer from the developer transport start area to the downstream side with respect to the developer sub-transport direction can be stabilized.

After that, the developer is transported on the developer main transport surface in the developer main transport direction by means of the traveling-wave electric field. The developer is then supplied to a position (developer carrying position) where the developer carrying surface and the developer main transport surface (which are parallel with each other) face each other.

The developer having passed through the developer carrying position returns to the developer pool, while being transported on the developer main transport surface in the developer main transport direction.

As described above, according to the developer supply apparatus of the present invention, change in the transport amount of the developer with change in the contained amount (storage amount) of the developer can be suppressed to the greatest possible extent.
The developer supply apparatus may be configured as follows: the second transport electrodes are provided along the developer sub-transport surface and a developer auxiliary transport surface. A downstream end portion of the developer sub-transport surface with respect to the developer sub-transport direction is connected to the developer auxiliary transport surface. The plurality of second transport electrodes are configured to be able to transport the developer toward a predetermined position.

The developer auxiliary transport surface includes at least a surface along an inner wall surface of the top plate of the developer containing casing, the inner wall surface being located on the upstream side of the opening portion with respect to the developer main transport direction. Further, the predetermined position is a position at which the above-described end portion of the developer main transport surface and the developer sub-transport surface or the developer auxiliary transport surface face in the closest proximity to each other.

In such a configuration, when the developer is transported on the developer sub-transport surface in the developer sub-transport direction, the developer reaches the developer auxiliary transport surface. After that, on the developer auxiliary transport surface, the developer is transported to the above-described predetermined position.

Thus, the developer reaches the developer main transport surface. The developer is then transported on the developer main transport surface in the developer main transport direction, whereby the developer is supplied to the developer carrying position.

According to such a configuration, the developer can be reliably transported from the developer sub-transport surface to the developer main transport surface. Therefore, the state of supply of the developer to the developer main transport surface and the developer carrying position are stabilized further.
The developer supply apparatus may further comprise a developer vibrating section. The developer vibrating section is configured to be able to vibrate the developer (the developer pool) contained (stored) in the developer containing casing. Preferably, the developer vibrating section is configured to be able to vibrate at least the developer in the developer transport start area.

In such a configuration, the developer stored in the developer containing casing is vibrated by the developer vibrating section. Thus, a satisfactory fluidity is imparted to the developer.

By virtue of such a configuration, the amount of the developer supplied from the developer pool (the developer transport start area) to the developer sub-transport surface can be rendered uniform to the greatest possible extent in the main scanning direction and the sub-scanning direction. As a result, the amount of the developer transported from the developer pool to the downstream side with respect to the developer sub-transport direction can be rendered uniform to the greatest possible extent.

Further, application of large stresses, such as aggregation force and shearing force, on the developer in the developer pool can be suppressed to the greatest possible extent.
The developer vibration section may include a vibration element and a vibration-element drive section.

The vibration element is disposed within the developer containing casing such that the vibration element is separated from the developer sub-transport surface. This vibration element is supported by the developer containing casing such that the vibration element can oscillate.

Further, the vibration-element drive section is configured to be able to vibrate the vibration element from the outside of the developer containing casing. This vibration-element drive section is disposed outside the developer containing casing.

In such a configuration, the vibration element vibrates in a state in which the vibration element is separated from the developer containing casing and the developer transport body. Thus, the vibration generated by the vibration element is not transmitted directly to the developer containing casing and the developer transport body.

Therefore, by virtue of this configuration, there is prevented, to the greatest possible extent, a change in a predetermined positional relation between the developer carrying surface of the developer carrying body and the developer main transport surface of the developer transport body, which change would otherwise result from vibration of the vibration element.

(4) A developer supply apparatus of the present invention is configured to be able to supply a developer in a charged state to a developer carrying surface of a developer carrying body along a predetermined developer transport direction. The developer carrying surface is a surface which is parallel to a predetermined main scanning direction and which can carry the developer thereon.

The developer carrying body has the developer carrying surface and is configured such that the developer carrying surface can move along a sub-scanning direction orthogonal to the main scanning direction.

The developer carrying body may be an electrostatic-latent-image carrying body having a latent-image forming surface configured to be able to form an electrostatic latent image thereon by means of electric-potential distribution.

Alternatively, the developer carrying body may be a recording medium (paper) which is transported along the sub-scanning direction.

Alternatively, the developer carrying body may be a roller, a sleeve, or a belt member (a developing roller, a developing sleeve, an intermediate transfer belt, etc.) which is configured and disposed so as to be able to transfer the developer onto the recording medium or the electrostatic-latent-image carrying body by means of facing the recording medium or the electrostatic-latent-image carrying body.

The developer supply apparatus of the present invention comprises a developer containing casing, a developer transport body, and a plurality of transport electrodes.

The developer containing casing is a box-like member, and is configured to be able to contain the developer therein. The developer containing casing includes a top plate and a bottom plate provided such that it faces the top plate. The top plate of the developer containing casing has an opening portion formed at a position where the top plate faces the electrostatic-latent-image carrying body.

The developer transport body has a developer main transport surface parallel with the main scanning direction. This developer transport body is disposed within the developer containing casing such that the developer main transport surface faces the developer carrying body via the opening portion of the top plate.

The plurality of first transport electrodes are provided along the developer main transport surface such that they face the developer carrying surface. These first transport electrodes are arrayed along the sub-scanning direction. The first transport electrodes are configured in such a manner as to be able to transport the developer in a predetermined developer main transport direction on the developer main transport surface upon application of traveling-wave voltages.

The plurality of second transport electrodes are provided along a sloped developer sub-transport surface. The developer sub-transport surface is a surface extending along the upper surface of the bottom plate of the developer containing casing, and is formed such that the angle formed between the developer sub-transport surface and the horizontal plane always becomes 30 degree or less.

These second transport electrodes are arrayed along the sub-scanning direction. The second transport electrodes are configured in such a manner as to be able to transport the developer in a predetermined developer sub-transport direction on the developer sub-transport surface upon application of traveling-wave voltages.

The developer sub-transport surface may form a slope which ascends toward an upstream end portion of the developer main transport surface with respect to the developer main transport direction. In this case, the developer sub-transport direction is a direction in which the developer moves up along the developer sub-transport surface toward the upstream end portion of the developer main transport surface with respect to the developer main transport direction.

The developer supply apparatus of the present invention having such a configuration operates as described below.

The developer carrying surface of the developer carrying body moves along the sub-scanning direction.

Meanwhile, predetermined traveling-wave voltages are applied to the plurality of first transport electrodes. As a result, a traveling-wave electric field which travels in the developer main transport direction is formed along the developer main transport surface of the developer transport body.

Further, predetermined traveling-wave voltages are applied to the plurality of second transport electrodes. As a result, a traveling-wave electric field which travels in the developer sub-transport direction is formed along the developer sub-transport surface.

The developer contained within the developer containing casing is transported on the developer sub-transport surface in the developer sub-transport direction by means of the traveling-wave electric field. This transfer of the developer on the developer sub-transport surface starts from a predetermined developer transport start area.

The developer transport start area refers to an area near a position at which the uppermost end portion of a developer pool within the developer containing casing and the developer sub-transport surface are in the closest proximity to each other. The developer pool refers to an ensemble of the developer stored in a space at the bottom portion of the developer containing casing.

The developer is transported on the developer main transport surface in the developer main transport direction by means of the traveling-wave electric field. The developer is then supplied to a position (the developer carrying position) where the developer carrying surface and the developer main transport surface (which are parallel with each other) face each other. After that, the developer having passed through the developer carrying position returns to the developer pool, while being transported on the developer main transport surface in the developer main transport direction.

In such a configuration, the angle between the top surface of the developer pool and the developer sub-transport surface at the above-described developer transport start area (hereinafter referred to as the “developer contact angle”) always becomes 30 degrees or less. Therefore, the influence of the above-described traveling-wave electric field extends over the greater portion of the developer in the developer transport start area.

Therefore, by virtue such a configuration, the amount of the developer supplied to the developer sub-transport surface in the developer transport start area can be increased to the greatest possible extent. Thus, the amount of the developer transported from the developer transport start area to the downstream side with respect to the developer sub-transport direction and the amount of the developer transported on the developer main transport surface can be secured to the greatest possible extent.

Therefore, according to the developer supply apparatus of the present invention, occurrence of lack of the transport amount of the developer can be suppressed to the greatest possible extent.
The developer supply apparatus may be configured as follows: the second transport electrodes are provided along the developer sub-transport surface and a developer auxiliary transport surface. A downstream end portion of the developer sub-transport surface with respect to the developer sub-transport direction is connected to the developer auxiliary transport surface. The plurality of second transport electrodes are configured to be able to transport the developer toward a predetermined position.

The developer auxiliary transport surface includes at least a surface along an inner wall surface of the top plate of the developer containing casing, the inner wall surface being located on the upstream side of the opening portion with respect to the developer main transport direction. Further, the predetermined position is a position at which the above-described end portion of the developer main transport surface and the developer sub-transport surface or the developer auxiliary transport surface face in the closest proximity to each other.

In such a configuration, when the developer is transported on the developer sub-transport surface in the developer sub-transport direction, the developer reaches the developer auxiliary transport surface. After that, on the developer auxiliary transport surface, the developer is transported to the above-described predetermined position.

Thus, the developer reaches the developer main transport surface. The developer is then transported on the developer main transport surface in the developer main transport direction, whereby the developer is supplied to the developer carrying position.

According to such a configuration, the developer can be reliably transported from the developer sub-transport surface to the developer main transport surface. Therefore, the state of supply of the developer to the developer main transport surface and the developer carrying position can be stabilized further.
The developer supply apparatus may further comprise a developer vibrating section. The developer vibrating section is configured to be able to vibrate the developer (the developer pool) contained (stored) in the developer containing casing. Preferably, the developer vibrating section is configured to be able to vibrate at least the developer in the developer transport start area.

In such a configuration, the developer stored in the developer containing casing is vibrated by the developer vibrating section, whereby a satisfactory fluidity is imparted to the developer. At that time, application of large stresses, such as aggregation force and shearing force, on the developer in the developer pool can be suppressed to the greatest possible extent.

By virtue of such a configuration, the amount of the developer supplied to the developer sub-transport surface can be rendered uniform to the greatest possible extent in the main scanning direction and the sub-scanning direction. As a result, the amount of the developer transported from the developer pool to the downstream side with respect to the developer sub-transport direction can be rendered uniform to the greatest possible extent.
The developer vibration section may include a vibration element and a vibration-element drive section.

The vibration element is disposed within the developer containing casing such that the vibration element is separated from the developer sub-transport surface. This vibration element is supported by the developer containing casing such that the vibration element can oscillate.

Further, the vibration-element drive section is configured to be able to vibrate the vibration element from the outside of the developer containing casing. This vibration-element drive section is disposed outside the developer containing casing.

In such a configuration, the vibration element vibrates in a state in which the vibration element is separated from the developer containing casing and the developer transport body. Therefore, there is prevented, to the greatest possible extent, a change in a predetermined positional relation between the developer carrier surface of the developer carrying body and the developer main transport surface of the developer transport body, which change would otherwise result from vibration of the vibration element.

### BRIEF DESCRIPTION OF THE DRAWINGS

FIG. 1 is a side sectional view showing the schematic configuration of a laser printer to which a first embodiment of the present invention is applied.

FIG. 2 is an enlarged side sectional view showing an electrostatic-latent-image forming section and a developing apparatus shown in FIG. 1.

FIG. 3 is an enlarged side sectional view showing a developing opening portion and its periphery of a developer electric-field transport body shown in FIG. 2.

FIG. 4 is a set of graphs showing waveforms of voltages generated by power supply circuits shown in FIG. 3.

FIG. 5 is a set of side sectional views, each showing, on an enlarged scale, the vicinity of a toner transport surface of a transport wiring substrate shown in FIG. 3.

FIG. 6 is a side sectional view showing the configuration of one modification of the developing apparatus shown in FIG. 2.

FIG. 7 is a side sectional view showing the configuration of another modification of the developing apparatus shown in FIG. 2.

FIG. 8 is a side sectional view showing the configuration of another modification of the developing apparatus shown in FIG. 2.

FIG. 9 is a side sectional view showing the configuration of another modification of the developing apparatus shown in FIG. 2.

FIG. 10 is a side sectional view showing the schematic configuration of a laser printer to which a second embodiment of the present invention is applied.

FIG. 11 is an enlarged side sectional view showing an electrostatic-latent-image forming section and a developing apparatus shown in FIG. 10.

FIG. 12 is an enlarged side sectional view showing a developing opening portion and its periphery of a developer electric-field transport body shown in FIG. 11.

FIG. 13 is a side sectional view showing the configuration of one modification of the developing apparatus shown in FIG. 11.

FIG. 14 is a side sectional view showing the configuration of another modification of the developing apparatus shown in FIG. 11.

FIG. 15 is a side sectional view showing the configuration of another modification of the developing apparatus shown in FIG. 11.

FIG. 16 is a side sectional view showing the schematic configuration of a laser printer to which a third embodiment of the present invention is applied.

FIG. 17 is an enlarged side sectional view showing an electrostatic-latent-image forming section and a developing apparatus shown in FIG. 16.

FIG. 18 is an enlarged side sectional view showing a portion of FIG. 17 in the vicinity a development facing position.

FIG. 19 is a sectional view, as viewed from a front side, showing the configuration of one example of a vibration body and a vibration-body drive section shown in FIG. 17.

FIG. 20 is a side sectional view of the development apparatus shown in FIG. 17 showing a state in which the storage amount of toner within a developing casing (the amount of toner pool) has decreased.

FIG. 21 is a side sectional view of the development apparatus shown in FIG. 17 showing a state in which the toner storage amount has decreased further, as compared with the state shown in FIG. 20.

FIG. 22 is a sectional view, as viewed from above, showing the configuration of one modification of the vibration-body drive section shown in FIG. 19.

FIG. 23 is a sectional view, as viewed from the front side, showing the configuration of another modification of the vibration-body drive section shown in FIG. 19.

FIG. 24A is an enlarged fragmental plan view showing the configuration of a modification of the vibration body shown in FIG. 19.

FIG. 24B is an enlarged fragmental plan view showing the configuration of another modification of the vibration body shown in FIG. 19.

FIG. 24C is an enlarged fragmental plan view showing the configuration of another modification of the vibration body shown in FIG. 19.

FIG. 25 is a side sectional view showing the configuration of one modification of the laser printer shown in FIG. 16.

FIG. 26 is a side sectional view showing the configuration of one modification of the developing apparatus shown in FIG. 17.

FIG. 27 is a side sectional view showing the configuration of another modification of the developing apparatus shown in FIG. 17 (a modification of the developing apparatus shown in FIG. 26).

FIG. 28 is a side sectional view showing the configuration of another modification of the developing apparatus shown in FIG. 17.

FIG. 29 is a side sectional view showing the configuration of another modification of the developing apparatus shown in FIG. 17.

FIG. 30 is a side sectional view showing the schematic configuration of a laser printer to which one embodiment of the present invention is applied.

FIG. 31 is an enlarged side sectional view showing an electrostatic-latent-image forming section and a developing apparatus shown in FIG. 30.

FIG. 32 is an enlarged side sectional view showing a developing opening portion and its periphery of a developer electric-field transport body shown in FIG. 31.

FIG. 33 is a sectional view, as viewed from a front side, of a portion of the developing casing shown in FIG. 31 in the vicinity of a vibration element.

FIG. 34 is a side sectional view of the development apparatus shown in FIG. 31 showing a state in which the storage amount of toner within a developing casing (amount of toner pool) has decreased.

FIG. 35 is a side sectional view of the development apparatus shown in FIG. 31 showing a state in which the toner storage amount has decreased further, as compared with the state shown in FIG. 34.

FIG. 36 is a side sectional view showing the configuration of one modification of the laser printer shown in FIG. 30.

FIG. 37 is a side sectional view showing the configuration of another modification of the laser printer shown in FIG. 30.

FIG. 38 is a side sectional view showing the configuration of another modification of the developing apparatus shown in FIG. 30.

FIG. 39 is a side sectional view of the development apparatus shown in FIG. 38 showing a state in which the storage amount of toner within a developing casing (amount of toner pool) has decreased.

### BEST MODE FOR CARRYING OUT THE INVENTION

Embodiments of the present invention (embodiments which the applicant contemplated as the best at the time of filing the present application) will next be described with reference to the drawings.

Notably, the following description of the embodiments merely describes a concrete example of the present invention specifically to the greatest possible extent so as to satisfy requirements regarding a specification (requirement regarding description and requirement regarding practicability) required under the law. Therefore, as described below, the present invention is not limited to the specific structures of the embodiments and modifications which will be described below. That is, those component elements which partially constitute the means for solving the problems to be solved by the invention and are described operationally and functionally include not only the specific structures disclosed in the following embodiments and modifications but also any other structures that can implement the operations and functions of the elements.

For example, application of the present invention is not limited to a so-called monochromatic laser printer which can form a monochromatic image. For example, the present invention can be preferably applied to so-called electrophotographic image forming apparatus, such as color laser printers which form a multi-color (full color) image and monochromatic and color copying machines.

Also, the present invention can be preferably applied to image forming apparatus of other than the above-mentioned electrophotographic system (for example, toner jet image forming apparatus, ion flow image forming apparatus, etc. which do not use a photosensitive body).

[1-1]

<Overall Configuration of First Laser Printer>

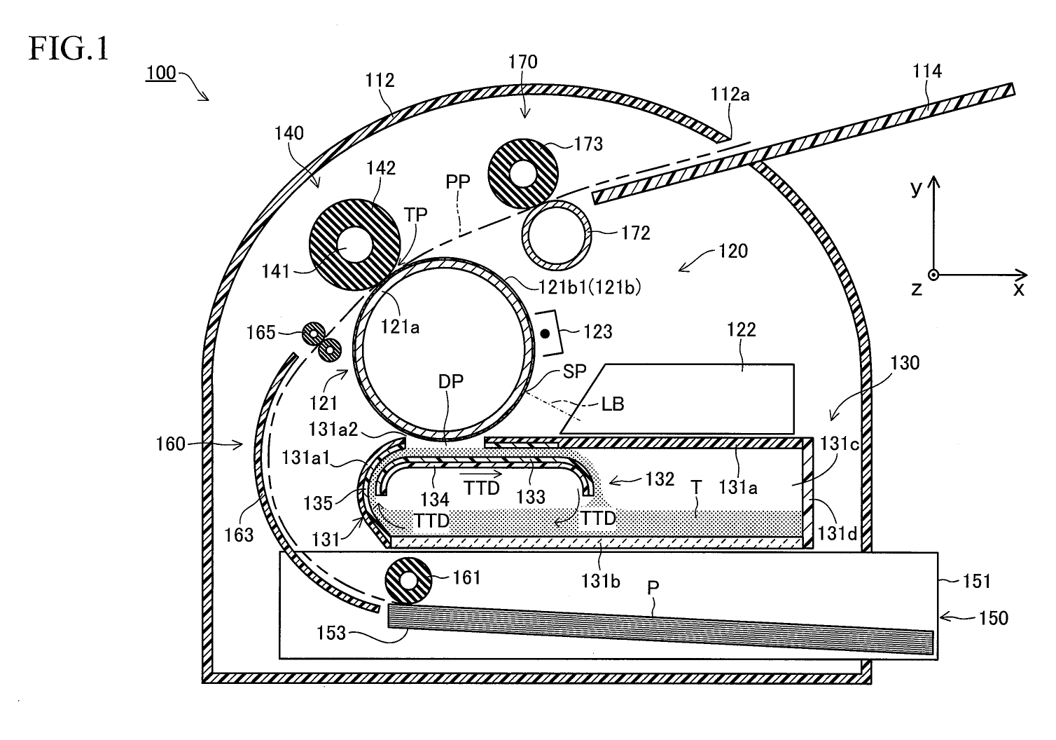

FIG. 1 is a side sectional view showing the schematic configuration of a laser printer 100 to which the first embodiment of the present invention is applied.

In FIG. 1, the alternate-long-and-two-short-dashes line indicates a paper path PP along which a paper P is transported. The paper P serves as a recording medium on which an image is formed. A direction tangent to the paper path PP is called the paper transport direction.

In FIG. 1, an x-axis direction is called the front-rear direction. With respect to the front-rear direction, a side toward one end of the laser printer 100 (right side in FIG. 1) is called the “front” side. A side toward the other end, opposite the one end, of the laser printer 100 (left side in FIG. 1) is called the “rear” side.

Furthermore, a direction orthogonal to a height direction (the y-axis direction in FIG. 1) of the laser printer 100, to the paper transport direction, and to the front-rear direction is called the paper width direction (the z-axis direction in FIG. 1).

<<Body Section>>

Referring to FIG. 1, the laser printer 100, which corresponds to the image forming apparatus of the present invention, includes a body casing 112. The body casing 112 is a member which constitutes an outer cover of the laser printer 100. The body casing 112 is integrally formed from a synthetic resin plate.

The body casing 112 has a paper ejection port 112a in the form of a slit-like through-hole located at an upper front portion thereof.

A catch tray 114 is attached to an upper front portion of the body casing 112 at a position corresponding to the paper ejection port 112a. The catch tray 114 is configured to receive the paper P which is ejected through the paper ejection port 112a and on which an image has been formed. <<Electrostatic-Latent-Image Forming Section>>

The body casing 112 houses an electrostatic-latent-image forming section 120. The electrostatic-latent-image forming section 120 includes a photoconductor drum 121, which corresponds to the electrostatic-latent-image carrying body and the developer carrying body of the present invention.

The photoconductor drum 121 is a generally cylindrical member and is disposed such that its center axis of rotation is in parallel with the paper width direction. The photoconductor drum 121 is configured to be able to be rotatably driven clockwise in FIG. 1.

Specifically, the photoconductor drum 121 includes a drum body 121a and a photoconductor layer 121b.

The drum body 121a is a metal tube of an aluminum alloy or the like. The photoconductor layer 121b is a positively chargeable photoconductive layer which exhibits electrical conductivity upon irradiation with light having a predetermined wavelength. This photoconductor layer 121b is formed on the outer circumference of the drum body 121a.

The photoconductor drum 121 has an image carrying surface 121b1, which corresponds to the latent-image forming surface and the developer carrying surface of the present invention. The circumferential surface of the photoconductor layer 121b serves as the image carrying surface 121b1.

The image carrying surface 121b1 is formed in parallel with the paper width direction and a main scanning direction, which will be described later. The image carrying surface 121b1 is configured such that an electrostatic latent image can be formed by electric-potential distribution.

That is, the photoconductor drum 121 is configured such that the image carrying surface 121b1 can move along a sub-scanning direction, which is orthogonal to the main scanning direction and will be described later.

The electrostatic-latent-image forming section 120 includes a scanner unit 122 and a charger 123.

The scanner unit 122 is configured and disposed such that the image carrying surface 121b1 can be irradiated at a predetermined scanning position SP with a laser beam LB having the above-described predetermined wavelength and modulated on the basis of image information. The laser beam LB is caused to sweep along the main scanning direction (the z-axis direction in FIG. 1) parallel to the paper width direction.

The charger 123 is disposed upstream of the scanning direction SP with respect to the direction of movement of the image carrying surface 121b1 (direction of rotation of the photoconductor drum 121). The charger 123 is configured and disposed so as to be able to uniformly, positively charge the image carrying surface 121b1 at a position located upstream of the scanning position SP with respect to the above-mentioned direction.

The electrostatic-latent-image forming section 120 is configured such that the scanner unit 122 irradiates, with the laser beam LB, the image carrying surface 121b1 which is uniformly, positively charged by the charger 123, whereby an electrostatic latent image by electric-potential distribution (charge distribution) can be formed on the image carrying surface 121b1.

The electrostatic-latent-image forming section 120 is configured to be able to move the image carrying surface 121b1 on which an electrostatic latent image is formed, along the sub-scanning direction, which will be described later.

The “sub-scanning direction” is an arbitrary direction orthogonal to the main scanning direction. Usually, the sub-scanning direction is a direction which intersects with a vertical line. Typically, the sub-scanning direction may be a direction along the front-rear direction of the laser printer 100 (the x-axis direction in FIG. 1).

<<Developing Apparatus>>

The body casing 112 houses a developing apparatus 130, which corresponds to the developer supply apparatus of the present invention. The developing apparatus 130 is disposed in such a manner as to face the photoconductor drum 121 at a developing position DP.

The developing apparatus 130 is configured such that it stores a toner T, which is a dry developer in the form of fine particles (powder developer), and can transport the toner T while circulating it along a toner transport direction TTD, as indicated by arrows in FIG. 1.

That is, the toner transport direction TTD, which corresponds to the developer transport direction of the present invention, is a direction tangent to a circulating transport path at an arbitrary point. The circulating transport path is formed within the developing apparatus 130 such that the path assumes a generally oval (elliptical) shape as viewed in a side sectional view, and the toner T circulates along the circulating transport path.

The developing apparatus 130 is configured and disposed as described below so as to be able to supply the image carrying surface 121b1 on which an electrostatic latent image is formed, with the toner T in a charged state in the vicinity of the developing position DP. Notably, the toner T used in the present embodiment is a non-magnetic 1-component developer for use in electrophotography.

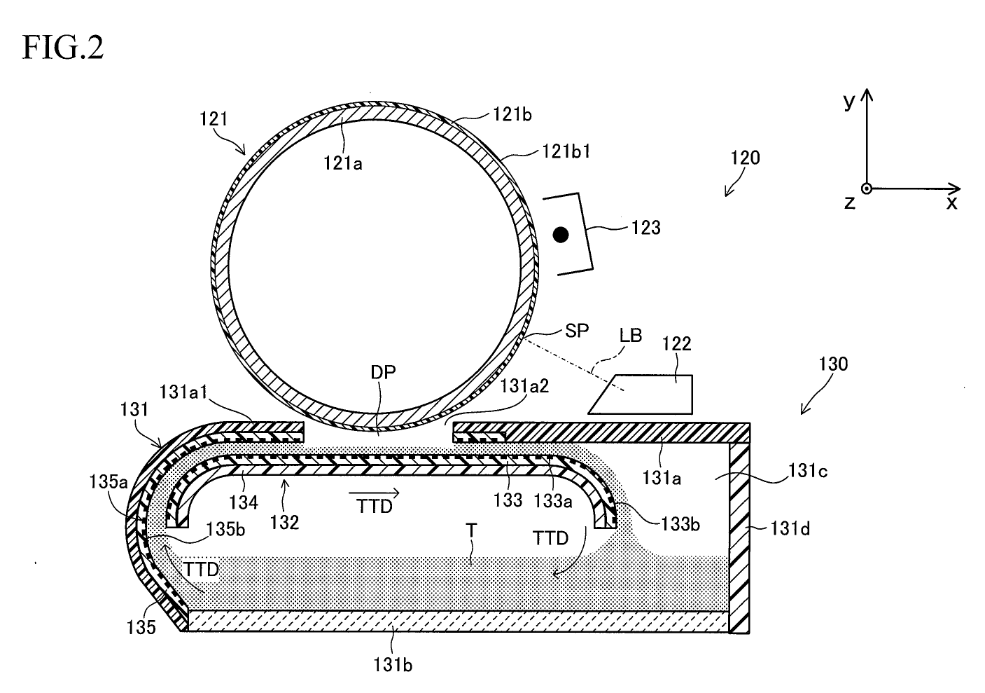

FIG. 2 is an enlarged side sectional view showing the electrostatic-latent-image forming section 120 and the developing apparatus 130 shown in FIG. 1.

Referring to FIGS. 1 and 2, the developing apparatus 130 is disposed below the photoconductor drum 121 in such a manner as to face the image carrying surface 121b1 at a position located downstream of the scanning position SP with respect to the direction of movement of the image carrying surface 121b1.

<<<Developing Casing>>>

Referring to FIGS. 1 and 2, a developing casing 131 is a box-like member and is configured to be able to contain the toner T therein without leaking the toner T to the outside. The developing casing 131 corresponds to the developer containing casing of the present invention.

A developing-section counter plate 131a1 is a rear portion of a casing top cover 131a, which serves as the top plate of the developing casing 131. The developing-section counter plate 131a1 is formed to have a generally J-like shape in a side sectional view. That is, the developing-section counter plate 131a1 is composed of a flat plate portion which is located below the photoconductor drum 121 and disposed generally horizontally, and a half-pipe portion connected to a rear end of the flat plate portion. A lower end portion of the half-pipe portion is formed to have a slope which slops downward toward the front side.

The developing-section counter plate 131a1 is thinner than the remaining portion of the casing top cover 131a. That is, a recess is formed on an inner surface of the casing top cover 131a at a position corresponding to the developing-section counter plate 131a1.

A developing opening portion 131a2, which corresponds to the opening portion of the present invention, is formed in the flat plate portion of the developing-section counter plate 131a1. The developing opening portion 131a2 is provided in the developing-section counter plate 131a1 at a position facing the image carrying surface 121b1 such that the developing opening portion 131a2 surrounds the developing position DP.

A casing bottom plate 131b is a flat-plate-like member which serves as the bottom plate of the developing casing 131. A rear end portion of the casing bottom plate 131b is connected to the lower end of the half-pipe portion of the casing top cover 131a.

That is, the casing bottom plate 131b and the developing-section counter plate 131a are formed integrally with each other in such a manner as to have a cross-sectional shape resembling the letter U at the rear end portion of the developing casing 131.

A pair of casing side plates 131c are closingly attached to the opposite ends, with respect to the paper width direction, of the casing top cover 131a and to those of the casing bottom plate 131b. Also, a casing front closing plate 131d is closingly attached to the front end of the casing top cover 131a, to that of the casing bottom plate 131b, and to those of the paired casing side plates 131c.

In the present embodiment, the casing bottom plate 131b, which corresponds to the developer vibrating section of the present invention, is formed by a laminate composed of a piezoelectric ceramic and electrode films. That is, in the present embodiment, the developer vibrating section of the present invention is provided in the casing bottom plate 131b, which serves as the bottom plate of the developing casing 131.

The casing bottom plate 131b is configured such that the casing bottom plate 131b can vibrate upon application of an AC voltage output from an unillustrated power supply unit. That is, the casing bottom plate 131b is configured such that the casing bottom plate 131b can vibrate the toner T stored within the developing casing 131.

Referring to FIG. 2, in the present embodiment, a rear end portion (a left end portion in FIG. 2) of the casing bottom plate 131b is provided substantially immediately under a furthest upstream portion (an end portion located at the lower left side in FIG. 2), with respect to the toner transport direction TTD, of a transport wiring substrate 133 to be described later provided on a toner electric-field transport body 132 to be described later. Further, the rear end portion of the casing bottom plate 131b is provided such that it is located adjacent to a furthest upstream portion, with respect to the toner transport direction TTD, of a counter wiring substrate 135 to be described later.

That is, in the present embodiment, the rear end portion (a left end portion in FIG. 2) of the casing bottom plate 131b is provided in the vicinity of a furthest upstream portion of a region in which the toner T is transported in the toner transport direction TTD by means of traveling-wave electric fields generated on the counter wiring substrate 135 and the transport wiring substrate 133.

In other words, in the present embodiment, the casing bottom plate 131b adapted to vibrate the toner T stored in the developing casing 131 is provided to correspond to the furthest upstream portion of the region in which the toner T is transported by means of the counter wiring substrate 135 and the transport wiring substrate 133.

The rear end portion of the casing bottom plate 131b is provided such that it can fluidize, by means of vibration, a portion of the toner T to be transported by means of the transport wiring substrate 133 (a toner transport surface 133b to be described later).

Further, the rear end portion of the casing bottom plate 131b is provided such that it can fluidize, by means of vibration, a portion of the toner T which faces the furthest upstream portion, with respect to the toner transport direction TTD, of the counter wiring substrate 135 (a toner transport surface 135b to be described later).

Moreover, the casing bottom plate 131b is configured and disposed such that it can fluidize, by means of vibration, substantially the entirety of the toner T stored at a bottom portion of the inner space of the developing casing 131.

<<<Developer Electric-Field Transport Body>>>

Referring to FIG. 2, the developing casing 131 houses a toner electric-field transport body 132, which corresponds to the developer transport body of the present invention. That is, the toner electric-field transport body 132 is enclosed within the developing casing 131.

The toner electric-field transport body 132 is disposed in the inner space of the developing casing 131 at a rearward position, in such a manner as to face the image carrying surface 121b1 with the developing opening portion 131a2 therebetween. That is, the toner electric-field transport body 132 is provided such that the photoconductor drum 121 and the toner electric-field transport body 132 face each other with the developing opening portion 131a2 therebetween.

The opposite ends of the toner electric-field transport body 132 are supported by the paired casing side plates 131c in such a manner that the toner electric-field transport body 132 is supported at a position located above the casing bottom plate 131b while facing the developing-section counter plate 131a1 with a predetermined gap therebetween.

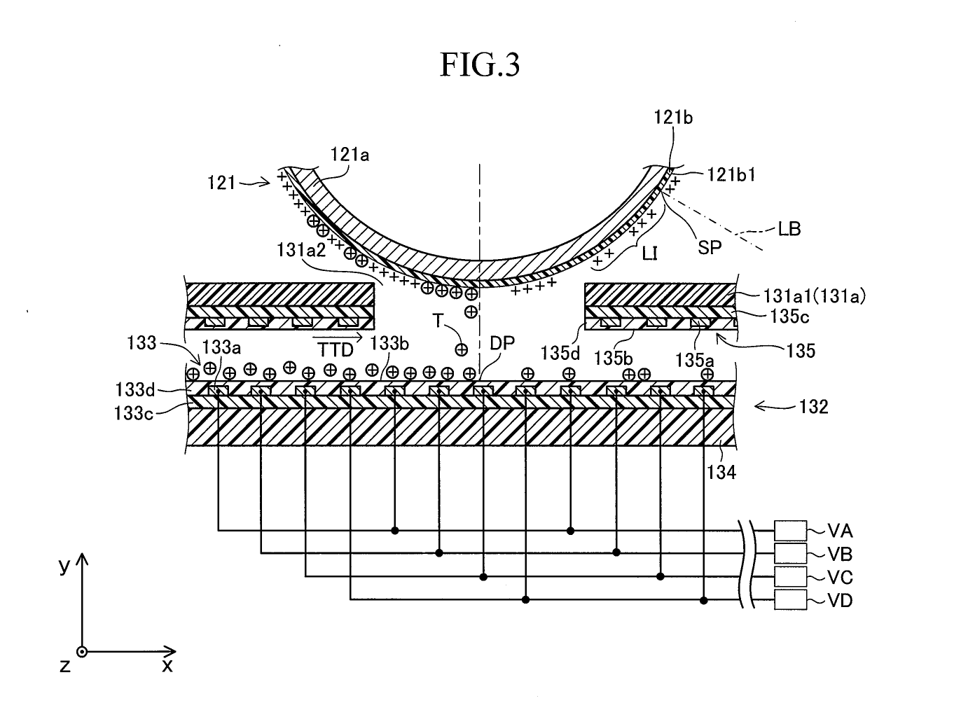

FIG. 3 is an enlarged side sectional view showing a portion of the toner electric-field transport body 132 (shown in FIG. 2) in the vicinity of the developing opening portion 131a2. Referring to FIGS. 2 and 3, the toner electric-field transport body 132 includes the transport wiring substrate 133. The transport wiring substrate 133 is disposed in such a manner as to face the image carrying surface 121b1 with the developing opening portion 131a2 therebetween.

Referring to FIG. 3, the transport wiring substrate 133 has a structure similar to that of a flexible printed wiring board, and includes a plurality of transport electrodes 133a. The transport electrodes 133a are disposed along the toner transport surface 133b, which corresponds to the developer transport surface of the present invention.

The toner transport surface 133b is an upper surface of the transport wiring substrate 133 in FIG. 2, which surface faces the photoconductor drum 121. That is, the transport electrodes 133a are disposed in the vicinity of the toner transport surface 133b.

Further, the toner transport surface 133b is a surface of the transport wiring substrate 133, which surface faces the image carrying surface 121b1, and is formed in parallel with the main scanning direction (the z direction in FIG. 2). The toner transport surface 133b and the image carrying surface 121b1 are in the closest proximity to each other at the developing position DP.

The transport electrodes 133a are formed of a copper foil having a thickness of about several tens of micrometers. The transport electrodes 133a are formed in a strip-like wiring pattern such that their longitudinal direction becomes parallel with the main scanning direction (orthogonal to the sub-scanning direction). The plurality of transport electrodes 133a are disposed in parallel with one another.

These transport electrodes 133a are arrayed along the toner transport direction TTD (along the sub-scanning direction).

The large number of transport electrodes 133a arrayed along the sub-scanning direction are connected to power supply circuits such that every fourth transport electrode 133a is connected to the same power supply circuit. That is, the transport electrode 133a connected to a power supply circuit VA, the transport electrode 133a connected to a power supply circuit VB, the transport electrode 133a connected to a power supply circuit VC, the transport electrode 133a connected to a power supply circuit VD, the transport electrode 133a connected to the power supply circuit VA, the transport electrode 133a connected to the power supply circuit VB, . . . , are sequentially arrayed along the sub-scanning direction.

The transport wiring substrate 133 also includes a transport-electrode support substrate 133c and a transport-electrode coating layer 133d.

The transport-electrode support substrate 133c is a flexible film of an electrically insulative synthetic resin, such as polyimide resin. The transport electrodes 133a are provided on the upper surface of the transport-electrode support substrate 133c.

The transport-electrode coating layer 133d is provided on the upper surface of the transport-electrode support substrate 133c on which the transport electrodes 133a are formed. The transport-electrode coating layer 133d is provided to cover the transport electrodes 133a. The transport-electrode coating layer 133d covers the transport-electrode support substrate 133c and the transport electrodes 133a, thereby making the toner transport surface 133b smooth.

Referring to FIGS. 2 and 3, the toner electric-field transport body 132 includes a transport-substrate support member 134. The transport-substrate support member 134 is provided so as to support the transport wiring substrate 133 from underneath.

Referring to FIG. 2, a rear end portion of the transport-substrate support member 134 is curved downward along the casing top cover 131a of the developing casing 131. Also, a front end portion of the transport-substrate support member 134 is curved downward in a manner similar to that of the rear end portion. A portion of the transport-substrate support member 134 between the above-mentioned front and rear portions assumes the form of a generally flat plate. That is, the transport-substrate support member 134 is formed in a shape resembling the inverted letter U as viewed from the lateral direction.

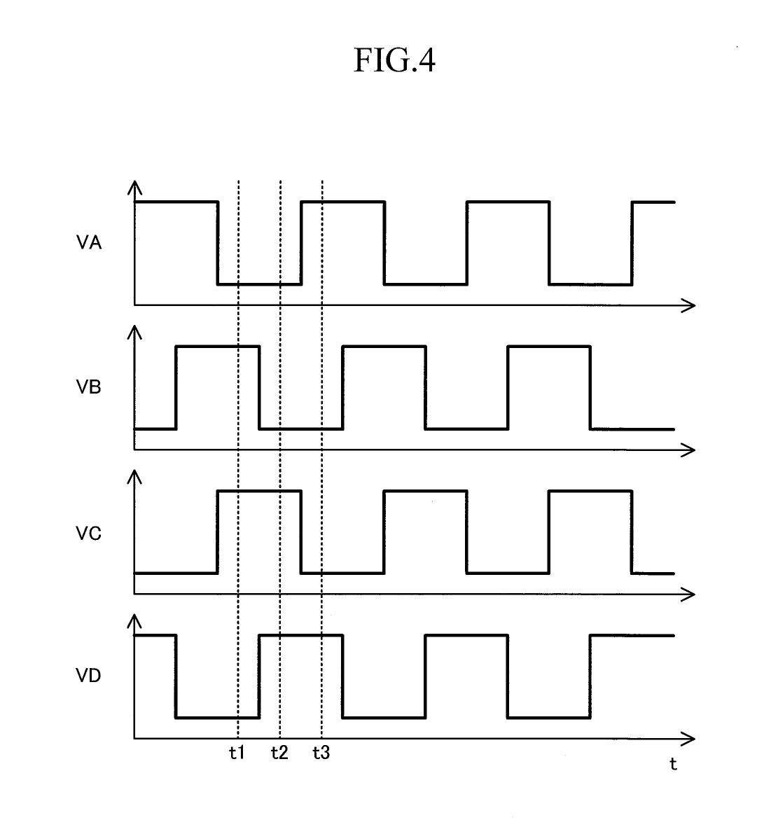

FIG. 4 is a set of graphs showing waveforms of voltages generated by the power supply circuits VA to VD shown in FIG. 3. As shown in FIG. 4, the power supply circuits VA to VD are configured to generate AC voltages of substantially the same waveform.

The waveforms of voltages generated by the power supply circuits VA to VD shift 900 in phase from one another. An unillustrated control circuit controls the power supply circuits VA to VD such that, in the sequence of the power supply circuits VA to VD, the phase of voltage delays in increments of 90°.

Referring to FIGS. 2 and 3, the toner electric-field transport body 132 is configured to be able to transport the toner T as follows. Transport voltages as shown in FIG. 4 are applied to the transport electrodes 133a of the transport wiring substrate 133, thereby generating traveling-wave electric fields along the toner transport direction TTD. By this procedure, the positively charged toner T can be transported in the toner transport direction TTD.

Referring to FIGS. 1 and 2, the counter wiring substrate 135 is attached to the above-described recess formed on the inner surface of the casing top cover 131a at a position corresponding to the developing-section counter plate 131a1. That is, the counter wiring substrate 135 is supported on the inner wall surface of the developing-section counter plate 131a1 having the developing opening portion 131a2, in such a manner as to face the toner transport surface 133b with a predetermined gap therebetween.

The counter wiring substrate 135 has a configuration similar to that of the above-described transport wiring substrate 133.

That is, as shown in FIG. 3, the counter electrodes 135a are formed of a copper foil having a thickness of about several tens of micrometers. The counter electrodes 135a are formed in a strip-like wiring pattern such that their longitudinal direction becomes parallel with the main scanning direction (orthogonal to the sub-scanning direction). The plurality of counter electrodes 135a are disposed in parallel with one another.

These counter electrodes 135a are arrayed along the predetermined toner transport direction TTD (along the sub-scanning direction). The counter electrodes 135a are connected to power supply circuits such that every fourth counter electrode 135a is connected to the same power supply circuit.

The counter wiring substrate 135 also includes a counter-electrode support substrate 135c and a counter-electrode coating layer 135d.

The counter-electrode support substrate 135c is a flexible film of an electrically insulative synthetic resin, such as polyimide resin. The counter electrodes 135a are provided on the lower surface of the counter-electrode support substrate 135c in FIG. 3.

The counter-electrode coating layer 135d is provided on the lower surface of the counter-electrode support substrate 135c on which the counter electrodes 135a are formed.

The counter-electrode coating layer 135d is provided to cover the counter electrodes 135a. The counter-electrode coating layer 135d covers the counter-electrode support substrate 135c and the counter electrodes 135a, thereby making the toner transport surface 135b smooth.

Like the above-described transport wiring substrate 133, the counter wiring substrate 135 is configured to be able to transport the toner T as follows. Predetermined voltages are applied to the plurality of counter electrodes 135a, thereby generating traveling-wave electric fields along the toner transport direction TTD. By this procedure, the positively charged toner T can be transported in the toner transport direction TTD.

<<Transfer Section>>

Referring again to FIG. 1, a transfer section 140 is provided in such a manner as to face the image carrying surface 121b1 at a position located downstream, with respect to the direction of rotation of the photoconductor drum 121, of the position where the photoconductor drum 121 and the developing apparatus 130 face each other.

The transfer section 140 includes a rotary center shaft 141, which is a roller-like member and is made of a metal, and a semiconductive rubber layer 142, which is circumferentially provided on the rotary center shaft 141.

The rotary center shaft 141 is disposed in parallel with the main scanning direction (the z-axis direction in FIG. 1). A high-voltage power supply is connected to the rotary center shaft 141. The semiconductive rubber layer 142 is formed of a synthetic rubber containing carbon black or the like kneadingly mixed thereinto such that the rubber layer exhibits semiconductivity.

The transfer section 140 is configured to be able to transfer the toner T from the image carrying surface 121b1 to the paper P by means of being rotatably driven counterclockwise while a predetermined transfer voltage is applied between the transfer section 140 and the drum body 121a of the photoconductor drum 121.

<<Paper Feed Cassette>>

A paper feed cassette 150 is disposed under the developing apparatus 130.

A paper feed cassette case 151 is a box-like member used to form the casing of the paper feed cassette 150 and opens upward. The paper feed cassette case 151 is configured to be able to contain a large number of sheets of the paper P of up to size A4 (210 mm width×297 mm length) in a stacked state.

A paper-pressing plate 153 is disposed within the paper feed cassette case 151. The paper-pressing plate 153 is supported by the paper feed cassette case 151 in such a manner as to pivotally move on a pivot at its front end portion, so that its rear end can move vertically in FIG. 1. An unillustrated spring urges the rear end portion of the paper-pressing plate 153 upward.

<<Paper Transport Section>>

A paper transport section 160 is housed within the body casing 112. The paper transport section 160 is configured to be able to feed the paper P to a transfer position TP where the transfer section 140 and the image carrying surface 121b1 face each other with a smallest gap therebetween. The paper transport section 160 includes a paper feed roller 161, a paper guide 163, and paper transport guide rollers 165.

The paper feed roller 161 includes a rotary center shaft parallel to the main scanning direction and a rubber layer, which is circumferentially provided on the rotary center shaft. The paper feed roller 161 is disposed in such a manner as to face a leading end portion, with respect to the paper transport direction, of the paper P stacked on the paper-pressing plate 153 housed within the paper feed cassette case 151. The paper guide 163 and the paper transport guide rollers 165 are configured to be able to guide to the transfer position TP the paper P which has been delivered by the paper feed roller 161.

<<Fixing Section>>

A fixing section 170 is housed within the body casing 112. The fixing section 170 is disposed downstream of the transfer position TP with respect to the paper transport direction.

The fixing section 170 is configured to apply pressure and heat to the paper P which has passed the transfer position TP and bears an image in the toner T, thereby fixing the image in the toner T on the paper P. The fixing section 170 includes a heating roller 172 and a pressure roller 173.

The heating roller 172 includes a cylinder which is made of a metal and whose surface is exfoliation-treated, and a halogen lamp which is housed within the cylinder. The pressure roller 173 includes a rotary center shaft which is made of a metal, and a silicone rubber layer which is circumferentially provided on the rotary center shaft. The heating roller 172 and the pressure roller 173 are disposed in such a manner as to press against each other under a predetermined pressure.

The heating roller 172 and the pressure roller 173 are configured and disposed so as to be able to deliver the paper P toward the paper ejection port 112a while applying pressure and heat to the paper P.

<Outline of Image Forming Operation of the Laser Printer>

The outline of an image forming operation of the laser printer 100 having such a configuration will next be described with reference to the drawings.

<<Paper Feed Operation>>

Referring to FIG. 1, the paper-pressing plate 153 urges the paper P stacked thereon upward toward the paper feed roller 161. This causes the top paper P of a stack of the paper P on the paper-pressing plate 153 to come into contact with the circumferential surface of the paper feed roller 161.

When the paper feed roller 161 is rotatably driven clockwise in FIG. 1, a leading end portion with respect to the paper transport direction of the top paper P is moved toward the paper guide 163. Then, the paper guide 163 and the paper transport guide rollers 165 transport the paper P to the transfer position TP.

<<Formation of Toner Image on Image Carrying Surface>>

While the paper P is being transported to the transfer position TP as described above, an image in the toner T is formed as described below on the image carrying surface 121b1, which is the circumferential surface of the photoconductor drum 121.

<<<Formation of Electrostatic Latent Image>>>

First, the charger 123 uniformly charges a portion of the image carrying surface 121b1 of the photoconductor drum 121 to positive polarity.

Referring to FIG. 3, as a result of the clockwise rotation of the photoconductor drum 121, the portion of the image carrying surface 121b1 which has been charged by the charger 123 moves along the sub-scanning direction to the scanning position SP, where the portion of the image carrying surface 121b1 faces (faces straight toward) the scanner unit 122.

At the scanning position SP, the charged portion of the image carrying surface 121b1 is irradiated with the laser beam LB modulated on the basis of image information, while the laser beam LB sweeps along the main scanning direction. Certain positive charges are lost from the charged portion of the image carrying surface 121b1, according to a state of modulation of the laser beam LB. By this procedure, an electrostatic latent image LI in the form of an imagewise distribution of positive charges is formed on the image carrying surface 121b1.

As a result of the clockwise rotation of the photoconductor drum 121 in FIG. 3, the electrostatic latent image LI formed on the image carrying surface 121b1 moves toward the developing position DP.

<<<Fluidization of Toner>>>

Referring to FIG. 2, as a result of the predetermined AC voltage being output to the casing bottom plate 131b from the unillustrated power supply unit, the casing bottom plate 131b vibrates.

By means of the vibration of the casing bottom plate 131b, the toner T stored within the developing casing 131 is vibrated. The vibrated toner T is fluidized so that the toner T behaves like a liquid. Hereinafter, the ensemble of the fluidized toner T at a lower portion of the developing casing 131 will be referred to as the “toner pool.”

<<<Transport of Charged Toner>>

Referring to FIG. 2, predetermined voltages (similar to those shown in FIG. 4) are applied to the counter wiring substrate 135, thereby forming predetermined traveling-wave electric fields on the counter wiring substrate 135.

Thus, the sufficiently fluidized toner T at a rear end portion of the above-described toner pool (the toner T which is to be transported on the counter wiring substrate 135 and the transport wiring substrate 133) is transported, by means of the traveling-wave electric fields, from a furthest upstream portion (located at the lower left side in FIG. 2), with respect to the toner transport direction TTD, of the counter wiring substrate 135 to a position where a rear end portion of the transport wiring substrate 133 and the counter wiring substrate 135 face each other, in such a manner that the toner T moves up along the sloped portion of the toner transport surface 135b.

In the case where the furthest upstream portion is covered with the toner T (toner pool), the transport is started from a position where the transport wiring substrate 133 is exposed from the toner T (toner pool).

The toner T residing between the transport wiring substrate 133 and the counter wiring substrate 135 is transported toward the developing position DP (the developing opening portion 131a2) by the effect of traveling-wave electric fields generated along the toner transport surface 133b of transport wiring substrate 133 and the toner transport surface 135b of the counter wiring substrate 135.

The toner T having passed through the developing position DP falls down from a frontmost end portion of the toner transport surface 133b, so that the toner T returns to the above-described toner pool.

Toner-T-transporting operation effected by the counter wiring substrate 135 is similar to that effected by the transport wiring substrate 133. Thus, the toner-T-transporting operation effected by the transport wiring substrate 133 will be described below in detail.

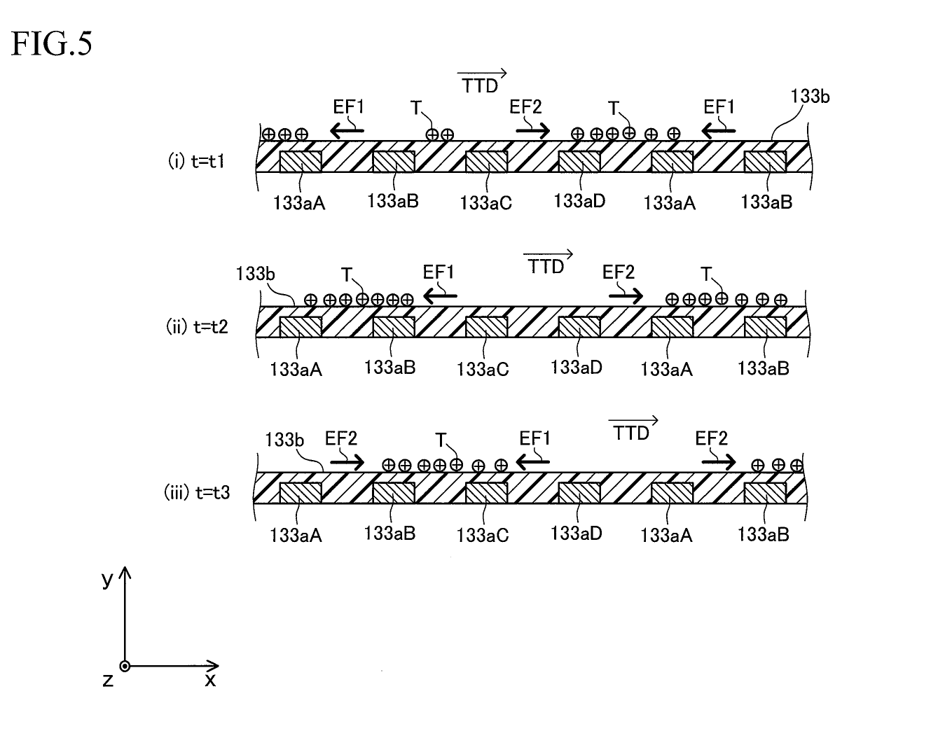

FIG. 5 is an enlarged side sectional view showing the toner transport surface 133b of the transport wiring substrate 133 shown in FIG. 3, and its periphery. Notably, the transport electrodes 133a connected to the power supply circuit VA in FIG. 3 are represented as transport electrodes 133aA in FIG. 5. This convention applies to transport electrodes 133aB through 133aD.

Referring to FIGS. 4 and 5, at time t1 in FIG. 4, an electric field EF1 directed opposite the toner transport direction TTD (directed opposite the x direction in FIG. 5) is formed in a section AB between the transport electrode 133aA and the transport electrode 133aB, as shown in FIG. 5(i).

Meanwhile, an electric field EF2 directed in the toner transport direction TTD (the x direction in FIG. 5) is formed in a section CD between the transport electrode 133aC and the transport electrode 133aD.

No electric field directed along the toner transport direction TTD is formed in a BC section between the transport electrode 133aB and the transport electrode 133aC and in a DA section between the transport electrode 133aD and the transport electrode 133aA.

That is, at time t1, the positively charged toner T in the sections AB is subjected to electrostatic force directed opposite the toner transport direction TTD. The positively charged toner T in the sections BC and DA is hardly subjected to electrostatic force directed along the toner transport direction TTD. The positively charged toner T in the CD sections is subjected to electrostatic force directed in the toner transport direction TTD.

Thus, at time t1, the positively charged toner T is collected in the DA sections.

Similarly, at time t2, the positively charged toner T is collected in the sections AB. When time t3 is reached, the positively charged toner T is collected in the sections BC.

In this manner, areas where the toner T is collected move with time in the toner transport direction TTD along the toner transport surface 133b.

<<<Development of Electrostatic Latent Image>>>

Referring to FIG. 3, the positively charged toner T is transported to the developing position DP as described above.

In the vicinity of the developing position DP, the toner T adheres to portions of the electrostatic latent image LI on the image carrying surface 121b1 at which positive charges are lost. That is, the electrostatic latent image LI on the image carrying surface 121b1 of the photoconductor drum 121 is developed with the toner T. Thus, an image in the toner T is carried on the image carrying surface 121b1.

<<Transfer of Toner Image from Image Carrying Surface to Paper>>

Referring to FIG. 1, as a result of clockwise rotation of the image carrying surface 121b1, an image in the toner T which has been carried on the image carrying surface 121b1 of the photoconductor drum 121 as described above is transported toward the transfer position TP. At the transfer position TP, the image in the toner T is transferred from the image carrying surface 121b1 onto the paper P.

<<Fixing and Ejection of Paper>>

The paper P onto which an image in the toner T has been transferred at the transfer position TP is sent to the fixing section 170 along the paper path PP.

The paper P is nipped between the heating roller 172 and the pressure roller 173, thereby being subjected to pressure and heat. By this procedure, the image in the toner T is fixed on the paper P. Subsequently, the paper P is sent to the paper ejection port 112a and is then ejected onto the catch tray 114 through the paper ejection port 112a.

<Actions and Effects Achieved by the Configuration of the Embodiment>

According to the configuration of the present embodiment, the toner T within the developing casing 131 to be transported on the toner transport surface 133b is vibrated by means of vibrating the casing bottom plate 131b. As a result, the toner T is fluidized. Stresses, such as compressive force and shearing force, acting on the toner T at that time are very small.

Therefore, by virtue of such a configuration, the toner T to be transported on the toner transport surface 133b is fluidized more satisfactorily within the developing casing 131. As a result, the toner T can be supplied to the toner transport surface 133b more uniformly. Thus, the toner T can be transported more uniformly on the toner transport surface 133b.

As described above, the configuration of the present embodiment renders more uniform the transport of the toner T on the toner transport surface 133b by means of the traveling-wave electric fields and the supply of the toner T to the developing position DP. Accordingly, generation of density non-uniformity can be effective suppressed, whereby satisfactory image formation becomes possible.

In the configuration of the present embodiment, the structure for vibrating the toner T within the developing casing 131 is provided at least at a position near the furthest upstream portion of the toner transport surface 133b with respect to the toner transport direction TTD.

By virtue of such a configuration, the toner T near the furthest upstream portion of the toner transport surface 133b with respect to the toner transport direction TTD is fluidized satisfactorily. Thus, the satisfactorily-fluidized toner T is supplied to the furthest upstream portion. Therefore, the transport of the toner T on the toner transport surface 133b can be performed as uniformly as possible.

In the configuration of the present embodiment, the structure for vibrating the toner T within the developing casing 131 corresponds not only to a position near the furthest upstream portion of the toner transport surface 133b with respect to the toner transport direction TTD, but also to substantially the entire space in which the toner T can be stored within the developing casing 131.

By virtue of such a configuration, substantially the entirety of the toner T within the developing casing 131 is fluidized satisfactorily by means of vibration. Therefore, the toner T within the developing casing 131 is uniformly provided for transport on the toner transport surface 133b.

Accordingly, it is possible to suppress, to the greatest possible extent, deterioration of a portion of the toner T which portion would otherwise be frequently transported on the toner transport surface 133b.

In the configuration of the present embodiment, the structure for vibrating the toner T within the developing casing 131 is formed by the casing bottom plate 131b, which serves as the bottom plate of the developing casing 131.

Therefore, in the present embodiment, the toner T within the developing casing 131 can be fluidized satisfactorily by employment of a very simple apparatus structure.

In the configuration of the present embodiment, the structure for vibrating the toner T within the developing casing 131 is provided at a position corresponding to the lowest portion of the developing casing 131.

By virtue of such a configuration, even when the storage amount of the toner T within the developing casing 131 decreases, the toner T at the bottom portion of the developing casing 131 can be vibrated satisfactorily. Thus, even in such a case, the transfer of the toner T to the developing position DP can be performed satisfactorily.

Accordingly, by virtue of such a configuration, even when the storage amount of the toner T within the developing casing 131 decreases, satisfactory formation of an image by the toner T can be performed.

In the configuration of the present embodiment, the structure (the casing bottom plate 131b) for vibrating the toner T within the developing casing 131 is located adjacent to the furthest upstream portion of the counter wiring substrate 135 with respect to the toner transport direction TTD.

By virtue of such a configuration, the transport state of the toner T can be made more uniform at the beginning of the transport of the toner T performed by the counter wiring substrate 135 through use of the traveling-wave electric fields.

Moreover, in the configuration of the present embodiment, the structure for vibrating the toner T within the developing casing 131 is located adjacent to the furthest upstream portion of a region in which the toner T is transported by the transport wiring substrate 133 and the counter wiring substrate 135 through use of the traveling-wave electric fields.

By virtue of such a configuration, the transport state of the toner T can be made more uniform at the beginning of the transport of the toner T performed by use of the traveling-wave electric fields.

<Modifications>

As mentioned previously, the above-described embodiment is a mere example of a typical embodiment of the present invention which the applicant contemplated as the best at the time of filing the present application. The present invention is not limited to the above-described embodiment. Various modifications to the above-described embodiment are possible, so long as the invention is not modified in essence.

Various modifications will next be exemplified. In the following description of the modifications, members similar in structure and function to those used in the above-described embodiment are denoted by the same reference numerals as those of the above-described embodiment. As for the description of these members, an associated description appearing in the description of the above embodiment can be cited, so long as no technical inconsistencies are involved.

Needless to say, modifications are not limited to those exemplified below. Also, the plurality of modifications can be combined as appropriate, so long as no technical inconsistencies are involved.

The above-described embodiment and the following modifications should not be construed as limiting the present invention (particularly, those components which partially constitute the means for solving the problems to be solved by the invention and are described operationally and functionally).

Such limiting construal unfairly impairs the interests of an applicant (who is motivated to file as quickly as possible under the first-to-file system) while unfairly benefiting imitators, is contrary to the purpose of the patent law which promotes protection and utilization of inventions, and is thus impermissible.

(1) No particular limitation is imposed on the configurations of the toner electric-field transport body 132, the transport wiring substrate 133, and the counter wiring substrate 135 in the above-described embodiment.

For example, the transport electrodes 133a can be embedded in the transport-electrode support substrate 133c so as not to project from the surface of the transport-electrode support substrate 133c. The transport-electrode coating layer 133d can be omitted. The transport electrodes 133a can be formed directly on the transport-substrate support member 134.

The counter electrodes 135a can also be, for example, embedded in the counter-electrode support substrate 135c so as not to project from the surface of the counter-electrode support substrate 135c. The counter-electrode coating layer 135d can be omitted. The counter electrodes 135a can be formed directly on the inner wall surface of the developing casing 131.

The longitudinal direction of the transport electrodes 133a and that of the counter electrodes 135a may be in parallel with the main scanning direction as in the case of the above-described embodiment or may intersect with the main scanning direction. The direction of arraying the transport electrodes 133a and that of arraying the counter electrodes 135a may be in parallel with the sub-scanning direction as viewed in plane as in the case of the above-described embodiment or may intersect with the sub-scanning direction as viewed in plane.

No particular limitation is imposed on the transport electrodes 133a and the counter electrodes 135a with respect to shape and the configuration of electrical connections. For example, in place of the form of a straight line as in the case of the above-described embodiment, the transport electrodes 133a and the counter electrodes 135a can assume various other forms, such as V-shaped, arc, waves, and serrated.

The pattern of connecting the electrodes is not limited to that of connecting every fourth electrode as in the case of the above-described embodiment. For example, every other electrode or every third electrode may be connected. In this case, the corresponding power circuits are not of four kinds, but can be modified as appropriate such that the phase shift of voltage waveforms is 180°, 120°, etc. Furthermore, the voltage waveform can be rectangular waves, sine waves, and waves of various other shapes.

(2) The present invention is not limited to the configuration of the above-described embodiment in which the entire casing bottom plate 131b vibrates.

For example, a portion for vibrating the toner T (the developer vibrating section of the present invention) may be provided at least at a position facing the toner electric-field transport body 132.

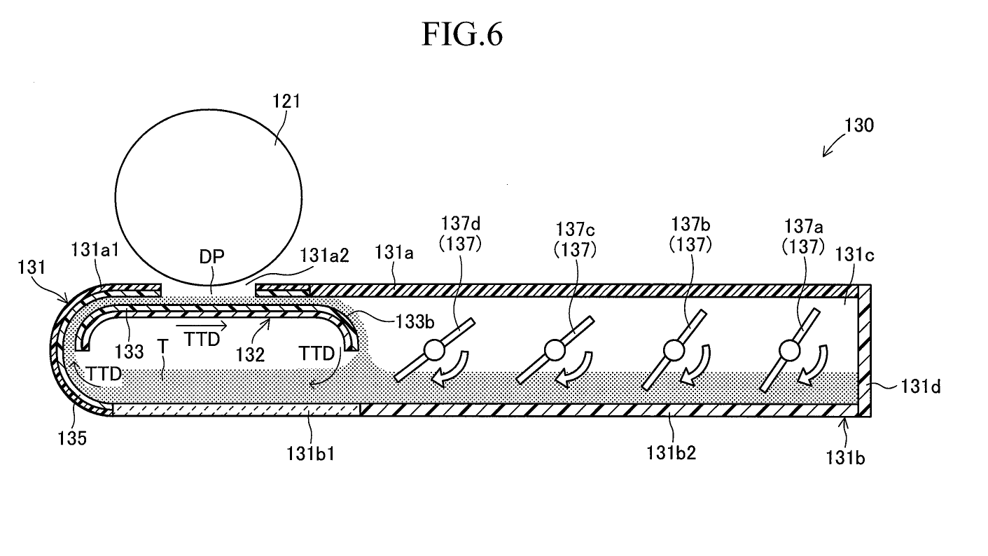

FIG. 6 is a side sectional view showing one modification of the developing apparatus 130 shown in FIG. 2.

Referring to FIG. 6, in the present modification, the above-described half-pipe portion, which is the rear end portion of the casing top cover 131a (the developing-section counter plate 131a1), is formed into a generally semi-cylindrical shape.

Further, a vibrating section 131b1, which corresponds to the developer vibrating section of the present invention, is formed in a rear portion of the casing bottom plate 131b such that the vibrating section 131b1 faces the toner electric-field transport body 132. As in the case of the above-described embodiment, the vibrating section 131b1 is formed from a piezoelectric ceramic.

In the present modification, a front end portion of the vibrating section 131b1 is provided at a position corresponding to a front end portion of the toner electric-field transport body 132. Further, a rear end portion of the vibrating section 131b1 is provided at a position slightly separated from the furthest upstream portion of the toner transport surface 133b with respect to the toner transport direction TTD.

The length of the vibrating section 131b1 as measured along the front-rear direction is set such that the length becomes approximately equal to that of the toner electric-field transport body 132. That is, the vibrating section 131b1 is provided below the toner electric-field transport body 132.

The remaining portion (a front portion) of the casing bottom plate 131b in which the vibrating section 131b1 is not provided serves as a non-vibrating section 131b2.

By virtue of such a configuration, the vibrating section 131b1 vibrates the toner T in the vicinity of the toner electric-field transport body 132. As a result, the toner T to be transported on the toner transport surface 133b is fluidized satisfactorily by means of vibration generated by the vibrating section 131b1. Thus, the satisfactorily fluidized toner T can be supplied to the furthest upstream portion of the toner transport surface 133b with respect to the toner transport direction TTD. Accordingly, the transport of the toner T on the toner transport surface 133b can be rendered uniform satisfactorily.

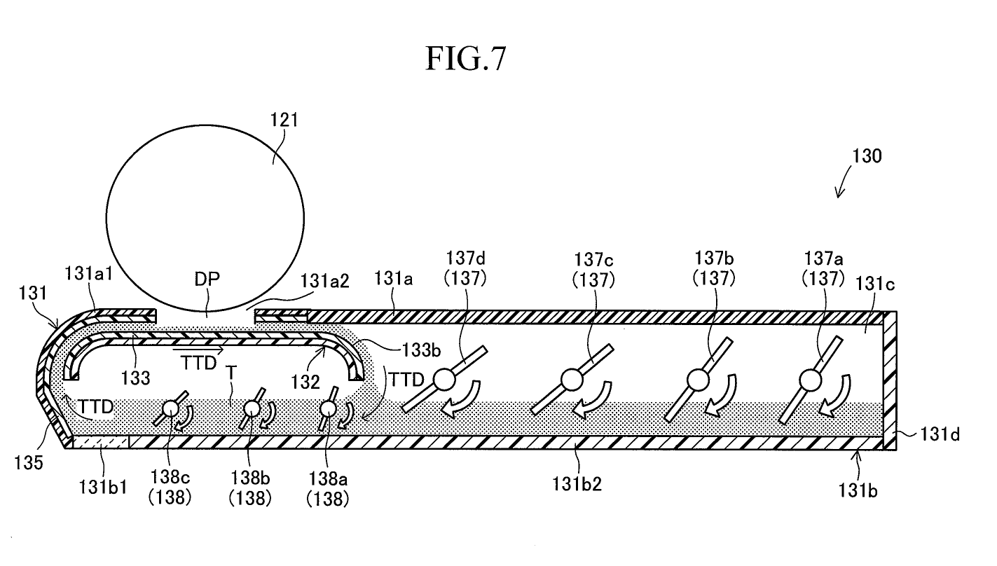

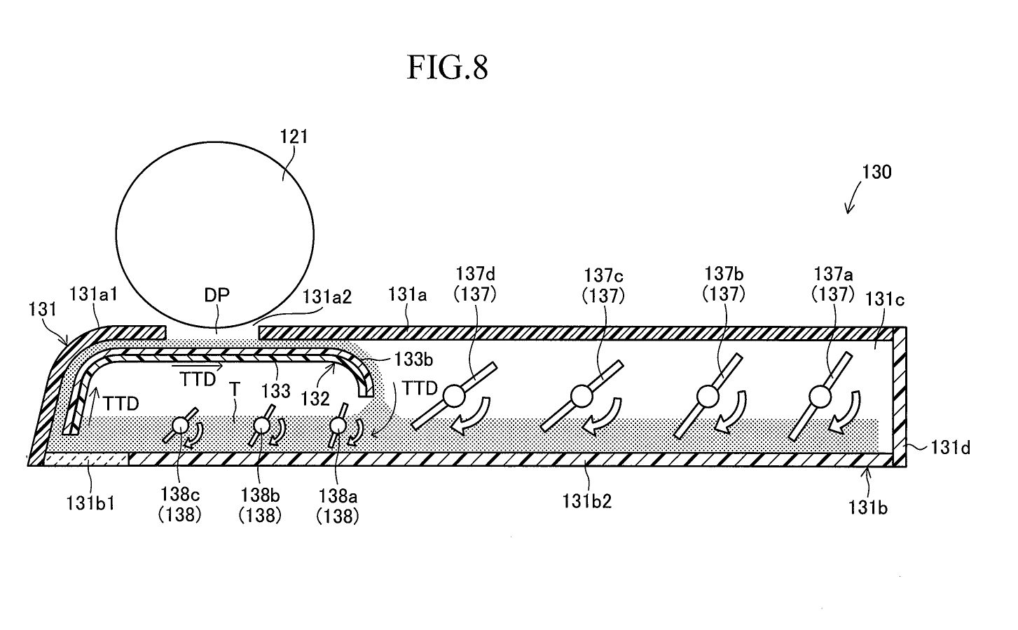

FIGS. 7 and 8 are side sectional views showing other modifications of the developing apparatus 130 shown in FIG. 2.

In the modification shown in FIG. 7, like the structure of the above-described embodiment shown in FIG. 2, a lower end portion of the rear side of the casing top cover 131a is formed to have a slope which slops downward toward the front side and toward the rear end portion of the casing bottom plate 131b, as viewed in the side sectional view.

Further, the vibrating section 131b1 is provided at a rearmost end portion of the casing bottom plate 131b such that the vibrating section 131b1 is connected to the lower end portion of the rear side of the casing top cover 131a.

In the modification shown in FIG. 8, the lower end portion of the rear side of the casing top cover 131a is formed to have a slope which slops downward toward the rear side and toward the rear end portion of the casing bottom plate 131b, as viewed in the side sectional view. As in the above-described modification, the vibrating section 131b1 is provided at the rearmost end portion of the casing bottom plate 131b such that the vibrating section 131b1 is connected to the lower end portion of the rear side of the casing top cover 131a.

That is, as shown in FIGS. 7 and 8, in these modifications, the vibrating section 131b1 is provided only at a position near the furthest upstream portion (a left-side lower end portion in these drawings) of the toner electric-field transport body 132 (the transport wiring substrate 133) with respect to the toner transport direction TTD. Specifically, the vibrating section 131b1 is provided immediately below the furthest upstream portion of the toner electric-field transport body 132 (the transport wiring substrate 133) with respect to the toner transport direction TTD.

Further, in FIG. 8, the vibrating section 131b1 is provided such that, with respect the horizontal direction, it overlaps the furthest upstream portion of the toner transport surface 133b with respect to the toner transport direction TTD.

Further, in FIG. 8, the vibrating section 131b1 is provided such that it faces the furthest upstream portion of the toner transport surface 133b with respect to the toner transport direction TTD.

In these configurations, the toner T at a position corresponding to the furthest upstream portion of the toner transport surface 133b with respect to the toner transport direction TTD is fluidized satisfactorily. The satisfactorily fluidized toner T is supplied to the furthest upstream portion of the toner transport surface 133b. As a result, the transport of the toner T at the furthest upstream portion of the toner transport surface 133b can be made uniform. Accordingly, the transport of the toner T on the toner transport surface 133b and the supply of the toner T to the developing position DP can be performed uniformly with the non-uniformity being reduced further.

Notably, in the configurations shown in FIGS. 6 to 8, the vibrating section 131b1 may be provided such that the vibrating section 131b1 corresponds (is located in close proximity or adjacent) only to the furthest upstream portion of the counter wiring substrate 135 (the toner transport surface 135b) with respect to the toner transport direction TTD. That is, the vibrating section 131b1 may be provided at a position (e.g., a position located diagonally in relation to the toner electric-field transport body 132 and the toner transport surface 133b) separated from the toner electric-field transport body 132 (the toner transport surface 133b), and also provided such that the vibrating section 131b1 corresponds to the counter wiring substrate 135 (the toner transport surface 135b).

(3) As shown in FIG. 6, at least one agitator 137, which serves as an agitating member, may be provided within the developing casing 131. The agitator 137 is rotatably supported within the developing casing 131.

In such a configuration, even when the agitator 137 is not rotated violently, fluidization of the toner T within the developing casing 131 can be performed satisfactorily.

In the case where the casing bottom plate 131b has the non-vibrating section 131b2, the agitator 137 is preferably provided at a position corresponding to the non-vibrating section 131b2, as shown in FIG. 6.

By virtue of such a configuration, when the amount of the toner pool on the vibrating section 131b1 decreases, the toner T can be added to the toner pool in a small amount at a time by means of rotating the agitator 137. Since the excess toner T continuously stored within the developing casing 131 is agitated, deterioration of the toner T can be suppressed to the greatest possible extent.

Notably, in order to decrease the frequency of maintenance by increasing the amount of the excess toner T, the developing casing 131 may be formed such that its length as measured along the front-rear direction becomes sufficiently greater than that of the toner electric-field transport body 132 (e.g., at least two times that of the toner electric-field transport body 132). In such a case, a plurality of agitators 137 may be provided.

In the configuration of FIG. 6, four agitators 137 are provided; i.e., an upstream agitator 137a, a first intermediate agitator 137b, a second intermediate agitator 137c, and a downstream agitator 137d.

In such a configuration, the drive states of the upstream agitator 137a, the first intermediate agitator 137b, the second intermediate agitator 137c, and the downstream agitator 137d are properly controlled in accordance with the degree of consumption of the toner T within the developing casing 131.

For example, when the degree of consumption of the toner T is small (in an initial stage), the upstream agitator 137a, the first intermediate agitator 137b, and the second intermediate agitator 137c are stopped continuously; and only the downstream agitator 137d is properly rotated in accordance with the degree of decrease in the amount of the toner pool.

As the degree of consumption of the toner T within the developing casing 131 increases, the number of the agitators 137, which are rotated in response to a decrease in the amount of the toner pool, is increased. That is, the number of the rotated agitators 137 is increased in such a manner that in a second stage the second intermediate agitator 137c and the downstream agitator 137d are rotated; in a third stage the first intermediate agitator 137b, the second intermediate agitator 137c, and the downstream agitator 137d are rotated; and in a final stage all the agitators 137 are rotated.

(4) The agitating members such as agitators may be provided at positions located away from the toner electric-field transport body 132 as shown in FIG. 6, or at positions corresponding to the toner electric-field transport body 132 (below the toner electric-field transport body 132).

Further, as shown in FIG. 7, in addition to the agitators 137 provided at positions located away from the toner electric-field transport body 132, a sub-agitator 138, which is smaller in size than the agitators 137, may be provided at a position corresponding to the toner electric-field transport body 132 (below the toner electric-field transport body 132).

In this case, preferably, the sub-agitator 138 is provided below a downstream portion of the toner electric-field transport body 132 with respect to the toner transport direction TTD.

By virtue of this configuration, a portion of the toner T returned from the downstream portion of the toner electric-field transport body 132 with respect to the toner transport direction TTD can be agitated satisfactorily. Thus, that portion of the toner T is supplied satisfactorily to the furthest upstream portion (the lower end portion in FIG. 7) of the counter wiring substrate 135 with respect to the toner transport direction TTD.

Further, a plurality of sub-agitators 138 may be provided, as shown in FIG. 7.

In the configuration of FIG. 7, three sub-agitators 138 are provided; i.e., an upstream sub-agitator 138a, an intermediate sub-agitator 138b, and a downstream sub-agitator 138c. These sub-agitators 138 are properly rotated in accordance with the degree of decrease in the amount of the toner pool in a manner similar to that in the above-described example.

Further, in the case where, as shown in FIG. 7, the vibrating section 131b1 of the casing bottom plate 131b is formed only in a region corresponding to an upstream portion of the toner electric-field transport body 132 with respect to the toner transport direction TTD, a sub-agitator 138 (or a plurality of sub-agitators 138) is provided above a portion of the non-vibrating section 131b2, the portion being located below the toner electric-field transport body 132; and an agitator 137 (a plurality of agitators 137) is provided above a portion of the non-vibrating section 131b2, which portion does not correspond to the toner electric-field transport body 132.

By virtue of such a configuration, through fine control of rotations of the agitators 137 and the sub-agitators 138 in accordance with the amount of the toner T within the developing casing 131 and the amount of the toner pool, the state of supply of the toner T to the toner electric-field transport body 132 can be optimized further.

(5) The material of the casing bottom plate 131b (the vibrating section 131b1) is not limited to piezoelectric ceramic. For example, a synthetic resin or a like material which exhibits piezoelectric properties may be preferably used.

(6) The counter wiring substrate 135 may be omitted partially or entirely. FIG. 8 is a side sectional view showing such a modification (or a modification of the developing apparatus 130 of the modification shown in FIG. 7).

In this case, as shown in FIG. 8, preferably, the end portion (the left-side lower end portion in FIG. 8) of the toner electric-field transport body 132 (the transport wiring substrate 133) located on the furthest upstream side with respect to the toner transport direction TTD extends downward to such a position that the end portion is immersed into the toner pool substantially at all times.

(7) The developer transport body of the present invention should not be construed as being limited to the toner electric-field transport body 132. That is, for example, depending on the structure of the developing apparatus 130, the counter wiring substrate 135 may serve as the developer transport body of the present invention.

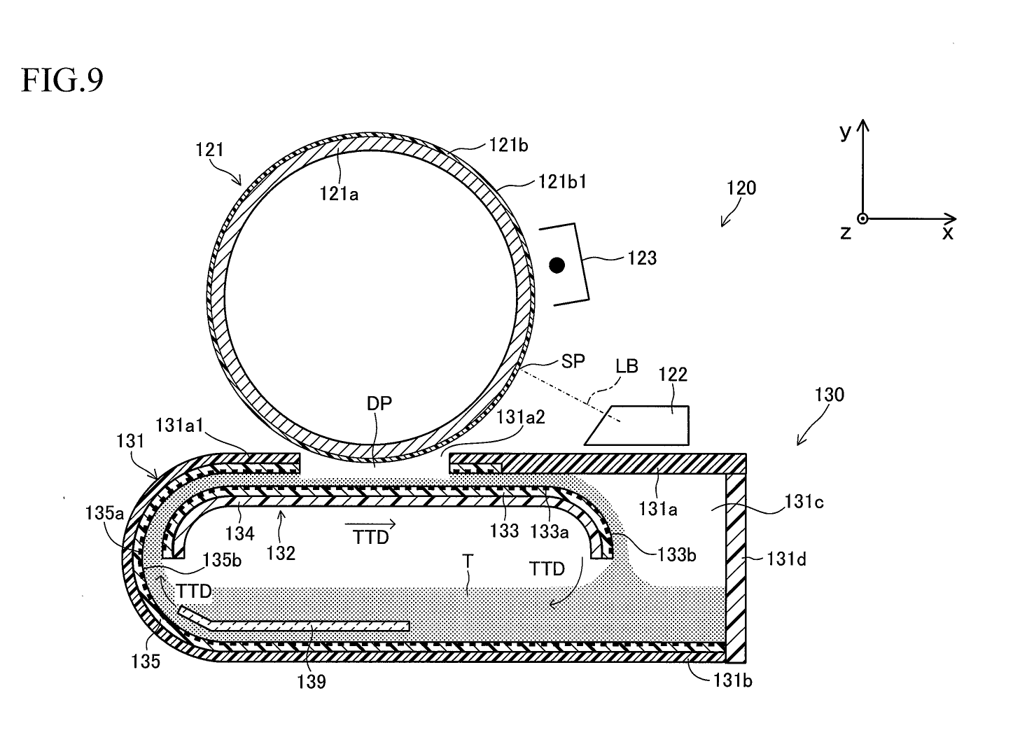

(8) FIG. 9 is a side sectional view showing another modification of the developing apparatus 130 shown in FIG. 2.

As shown in FIG. 9, a vibration plate 139, which is a vibration member, may be disposed within the developing casing 131. The vibration plate 139 is configured such that the vibration plate 139 vibrates upon application of an AC voltage being output from an unillustrated power supply unit. The vibration plate 139 is separated from the toner electric-field transport body 132 and the inner wall surface (the toner transport surface 135b of the counter wiring substrate 135) at the bottom portion of the developing casing 131.

As shown in FIG. 9, a rear end portion (a left end portion in FIG. 9) of the vibration plate 139 may be provided at a position near the furthest upstream portion of the toner transport surface 133b with respect to the toner transport direction TTD. That is, the rear end portion of the vibration plate 139 may be provided at a position corresponding to the furthest upstream portion of the toner transport surface 133b with respect to the toner transport direction TTD.

Further, as shown in FIG. 9, the vibration plate 139 may be provided such that the vibration plate 139 faces a rear (about half) portion, with respect to the front-rear direction, of the casing bottom plate 131b (which does not constitute the developer vibrating section in the present modification).

In such a configuration, the vibration plate 139, which vibrates, is separated from the developing casing 131 and the toner electric-field transport body 132. Therefore, vibration generated by the vibration plate 139 is not transmitted directly to the developing casing 131 and the toner electric-field transport body 132.

Accordingly, such a configuration can suppress, to the greatest possible extent, change in a predetermined positional relation between the image carrying surface 121b1 and the toner transport surface 133b at the developing position DP, which change would otherwise occur due to vibration of the vibration plate 139. Thus, adverse influence on development of an electrostatic latent image by the operation of rendering uniform the state of transport of toner on the toner transport surface 133b can be suppressed to the greatest possible extent.

[1-2]

<Overall Configuration of Second Laser Printer>

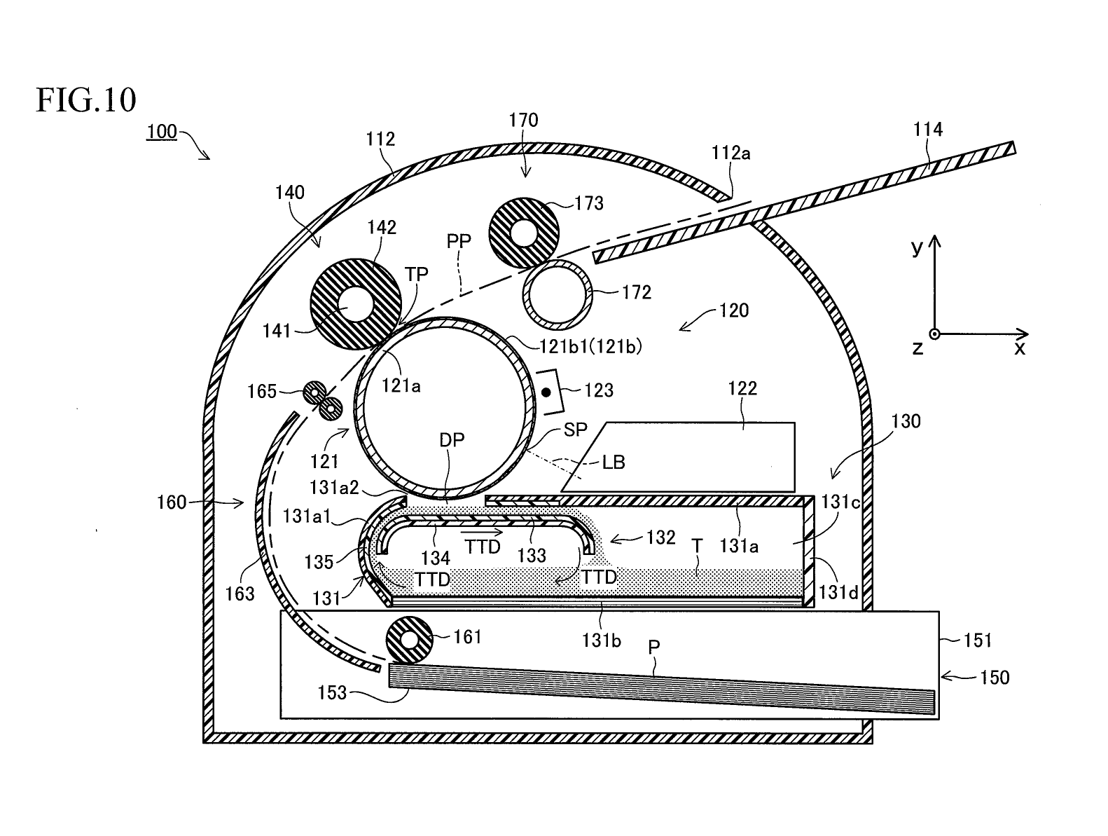

FIG. 10 is a side sectional view showing the schematic configuration of a laser printer 100 to which the second embodiment of the present invention is applied.

<<Body Section>>

Referring to FIG. 10, the laser printer 100, which corresponds to the image forming apparatus of the present invention, includes a body casing 112. The body casing 112 is a member which constitutes an outer cover of the laser printer 100, and is integrally formed from a synthetic resin plate. The body casing 112 has a paper ejection port 112a in the form of a slit-like through-hole located at an upper front portion thereof.

A catch tray 114 is attached to an upper front portion of the body casing 112 at a position corresponding to the paper ejection port 112a. The catch tray 114 is configured to receive the paper P which is ejected through the paper ejection port 112a and on which an image has been formed.

<<Electrostatic-Latent-Image Forming Section>>

The body casing 112 houses an electrostatic-latent-image forming section 120. The electrostatic-latent-image forming section 120 includes a photoconductor drum 121, which corresponds to the electrostatic-latent-image carrying body and the developer carrying body of the present invention.

The photoconductor drum 121 is a generally cylindrical member and is disposed such that its center axis of rotation is in parallel with the paper width direction. The photoconductor drum 121 is configured to be able to be rotatably driven clockwise in FIG. 10.

Specifically, the photoconductor drum 121 includes a drum body 121a and a photoconductor layer 121b.

The drum body 121a is a metal tube of an aluminum alloy or the like. The photoconductor layer 121b is a positively chargeable photoconductive layer, and is formed on the outer circumference of the drum body 121a.

The photoconductor drum 121 has an image carrying surface 121b1, which corresponds to the latent-image forming surface and the developer carrying surface of the present invention. The circumferential surface of the photoconductor layer 121b serves as the image carrying surface 121b1.

The image carrying surface 121b1 is formed in parallel with the paper width direction and a main scanning direction, which will be described later. The image carrying surface 121b1 is configured such that an electrostatic latent image can be formed by electric-potential distribution.

That is, the photoconductor drum 121 is configured such that the image carrying surface 121b1 can move along a sub-scanning direction, which is orthogonal to the main scanning direction and will be described later.

The electrostatic-latent-image forming section 120 includes a scanner unit 122 and a charger 123.

The scanner unit 122 is configured and disposed such that the image carrying surface 121b1 can be irradiated at a predetermined scanning position SP with a laser beam LB having the above-described predetermined wavelength and modulated on the basis of image information. The laser beam LB is caused to sweep along the main scanning direction (the z-axis direction in FIG. 10) parallel to the paper width direction.

The charger 123 is disposed upstream of the scanning direction SP with respect to the direction of movement of the image carrying surface 121b1 (direction of rotation of the photoconductor drum 121). The charger 123 is configured and disposed so as to be able to uniformly, positively charge the image carrying surface 121b1 at a position located upstream of the scanning position SP with respect to the above-mentioned direction.

The electrostatic-latent-image forming section 120 is configured such that the scanner unit 122 irradiates, with the laser beam LB, the image carrying surface 121b1 which is uniformly, positively charged by the charger 123, whereby an electrostatic latent image by electric-potential distribution (charge distribution) can be formed on the image carrying surface 121b1.

The electrostatic-latent-image forming section 120 is configured to be able to move the image carrying surface 121b1 on which an electrostatic latent image is formed, along the sub-scanning direction, which will be described later.

The “sub-scanning direction” is an arbitrary direction orthogonal to the main scanning direction. Usually, the sub-scanning direction is a direction which intersects with a vertical line. Typically, the sub-scanning direction may be a direction along the front-rear direction of the laser printer 100 (the x-axis direction in FIG. 10).

<<Developing Apparatus>>

The body casing 112 houses a developing apparatus 130, which corresponds to the developer supply apparatus of the present invention. The developing apparatus 130 is disposed in such a manner as to face the photoconductor drum 121 at a development facing position DP (developing position).

The developing apparatus 130 is configured such that it stores a toner T, which is a dry developer in the form of fine particles (powder developer), and can transport the toner T while circulating it along a toner transport direction TTD, as indicated by arrows in FIG. 10.

That is, the toner transport direction TTD is a direction tangent to a circulating transport path at an arbitrary point. The circulating transport path is formed within the developing apparatus 130 such that the path assumes a generally oval shape as viewed in a side sectional view, and the toner T circulates along the circulating transport path.

The developing apparatus 130 is configured and disposed as described below so as to be able to supply the image carrying surface 121b1 on which an electrostatic latent image is formed, with the toner T in a charged state in the vicinity of the development facing position DP. Notably, the toner T used in the present embodiment is a non-magnetic 1-component developer for use in electrophotography.

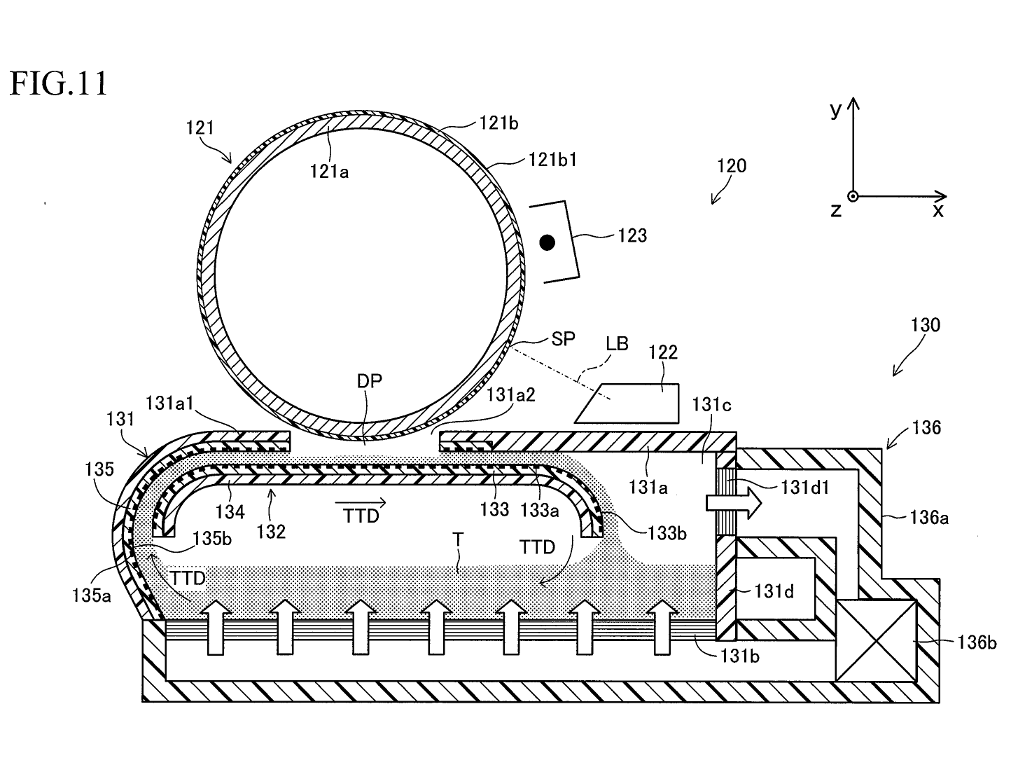

FIG. 11 is an enlarged side sectional view showing the electrostatic-latent-image forming section 120 and the developing apparatus 130 shown in FIG. 10.

Referring to FIGS. 10 and 11, the developing apparatus 130 is disposed below the photoconductor drum 121 in such a manner as to face the image carrying surface 121b1 at a position located downstream of the scanning position SP with respect to the direction of movement of the image carrying surface 121b1.

<<<Developing Casing>>>

A developing casing 131, which corresponds to the developer containing casing of the present invention, is a box-like member and is configured to be able to contain the toner T therein without leaking the toner T to the outside.

A developing-section counter plate 131a1 is a rear portion of a casing top cover 131a, which serves as the top plate of the developing casing 131. The developing-section counter plate 131a1 is formed to have a generally J-like shape in a side sectional view.

That is, the developing-section counter plate 131a1 is composed of a flat plate portion which is located below the photoconductor drum 121 and disposed generally horizontally, and a half-pipe portion connected to a rear end of the flat plate portion. A lower end portion of the half-pipe portion is formed to have a slope which slops downward toward the front side.

The developing-section counter plate 131a1 is thinner than the remaining portion of the casing top cover 131a. That is, a recess is formed on an inner surface of the casing top cover 131a at a position corresponding to the developing-section counter plate 131a1.

A developing opening portion 131a2, which corresponds to the opening portion of the present invention, is formed in the flat plate portion of the developing-section counter plate 131a1. The developing opening portion 131a2 is provided in the developing-section counter plate 131a1 at a position facing the image carrying surface 121b1 such that the developing opening portion 131a2 surrounds the development facing position DP.

A casing bottom plate 131b, which corresponds to the gas-permeable bottom plate of the present invention, is a flat-plate-like member which serves as the bottom plate of the developing casing 131. This casing bottom plate 131b is configured to prevent passage of the toner T therethrough and permit passage of air therethrough. Specifically, the casing bottom plate 131b is formed of a porous ceramic.

The average diameter of openings of the porous ceramic that constitutes the casing bottom plate 131b is set to be smaller than a −2σ, where “a” is a number-average particle size of the toner T and σ is a standard deviation.

That is, the casing bottom plate 131b is configured such that, under the assumption that the particle size distribution of the toner T is Gaussian, the amount of the toner T which can pass through the casing bottom plate 131b is very small (less than about 2.28% of the total amount of the toner T (on calculation)).

(Notably, it is generally rare that pores of the porous ceramic penetrate straight the porous ceramic in the thickness direction thereof. Therefore, even when the porous ceramic has the above-described opening diameter, in actuality, the toner T hardly leaks downward through the casing bottom plate 131b.)

A rear end portion (a left end portion in FIG. 11) of the casing bottom plate 131b is connected to the lower end of the half-pipe portion of the casing top cover 131a. That is, the casing bottom plate 131b and the casing top cover 131a are formed integrally with each other in such a manner as to have a cross-sectional shape resembling the letter U at the rear end portion of the developing casing 131.

A pair of casing side plates 131c are closingly attached to the opposite ends, with respect to the paper width direction, of the casing top cover 131a and to those of the casing bottom plate 131b. Also, a casing front closing plate 131d is closingly attached to the front end of the casing top cover 131a, to that of the casing bottom plate 131b, and to those of the paired casing side plates 131c.

Referring to FIG. 11, a gas-permeable closing plate 131d1, which is an upper portion of the casing front closing plate 131d, is formed from a porous ceramic plate. A lower portion of the casing front closing plate 131d in which the gas-permeable closing plate 131d1 is not provided is formed from a non-porous synthetic rein plate.

That is, the exhaust port of the present invention is constituted by the gas-permeable closing plate 131d1, which is the porous ceramic portion formed in the upper portion of the casing front closing plate 131d. The gas-permeable closing plate 131d1 is formed in the upper portion of the developing casing 131 at a position most separated from the developing opening portion 131a2.

<<<Developer Electric-Field Transport Body>>>

Referring to FIG. 11, the developing casing 131 houses a toner electric-field transport body 132, which corresponds to the developer transport body of the present invention. That is, the toner electric-field transport body 132 is enclosed within the developing casing 131.

The toner electric-field transport body 132 is disposed in the inner space of the developing casing 131 at a rearward position, in such a manner as to face the image carrying surface 121b1 with the developing opening portion 131a2 therebetween. That is, the toner electric-field transport body 132 is provided such that the photoconductor drum 121 and the toner electric-field transport body 132 face each other with the developing opening portion 131a2 therebetween.

The opposite ends of the toner electric-field transport body 132 are supported by the paired casing side plates 131c in such a manner that the toner electric-field transport body 132 is supported at a position located above the casing bottom plate 131b while facing the developing-section counter plate 131a1 with a predetermined gap therebetween.

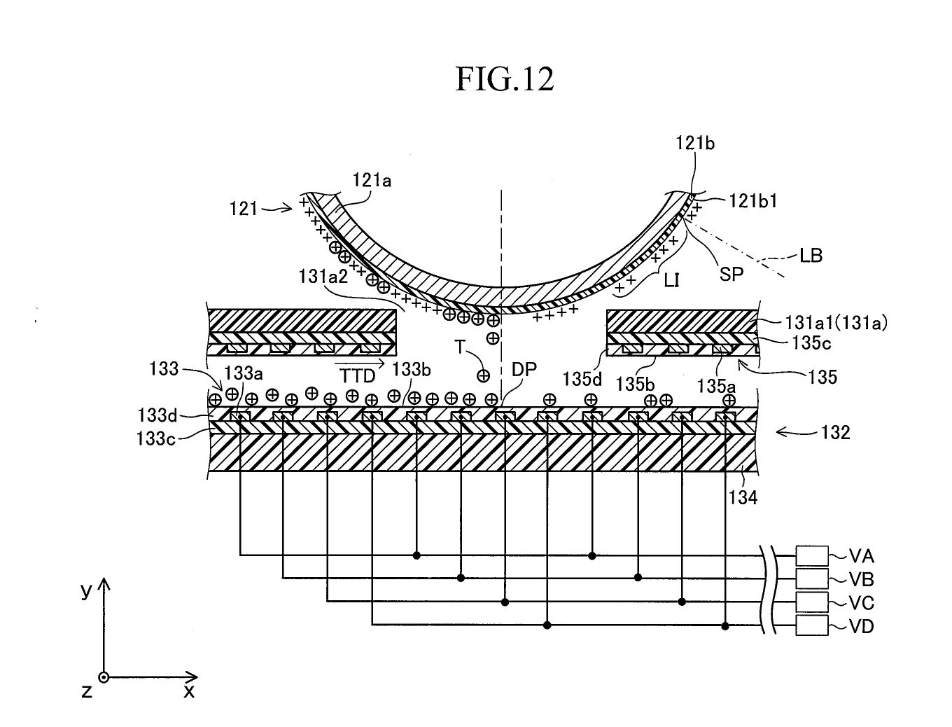

FIG. 12 is an enlarged side sectional view showing a portion of the toner electric-field transport body 132 (shown in FIG. 11) in the vicinity of the developing opening portion 131a2. Referring to FIGS. 11 and 12, the toner electric-field transport body 132 includes the transport wiring substrate 133. The transport wiring substrate 133 is disposed in such a manner as to face the image carrying surface 121b1 with the developing opening portion 131a2 therebetween.

Referring to FIG. 12, the transport wiring substrate 133 has a structure similar to that of a flexible printed wiring board, and includes a plurality of transport electrodes 133a.

The transport electrodes 133a are disposed along the toner transport surface 133b, which corresponds to the developer transport surface of the present invention.

The toner transport surface 133b is an upper surface of the transport wiring substrate 133 in FIG. 12, which surface faces the photoconductor drum 121. Further, the toner transport surface 133b is a surface of the transport wiring substrate 133, which surface faces the image carrying surface 121b1.

The toner transport surface 133b is formed in parallel with the main scanning direction (the z-direction in FIG. 12). The toner transport surface 133b and the image carrying surface 121b1 are in the closest proximity to each other at the development facing position DP.

The transport electrodes 133a are disposed in the vicinity of the toner transport surface 133b.

The transport electrodes 133a are formed of a copper foil having a thickness of about several tens of micrometers. The transport electrodes 133a are formed in a strip-like wiring pattern such that their longitudinal direction becomes parallel with the main scanning direction (orthogonal to the sub-scanning direction).

The plurality of transport electrodes 133a are disposed in parallel with one another. These transport electrodes 133a are arrayed along the toner transport direction TTD (along the sub-scanning direction).

The large number of transport electrodes 133a arrayed along the sub-scanning direction are connected to power supply circuits such that every fourth transport electrode 133a is connected to the same power supply circuit.

That is, the transport electrode 133a connected to a power supply circuit VA, the transport electrode 133a connected to a power supply circuit VB, the transport electrode 133a connected to a power supply circuit VC, the transport electrode 133a connected to a power supply circuit VD, the transport electrode 133a connected to the power supply circuit VA, the transport electrode 133a connected to the power supply circuit VB, . . . , are sequentially arrayed along the sub-scanning direction.

The transport wiring substrate 133 also includes a transport-electrode support substrate 133c and a transport-electrode coating layer 133d.

The transport-electrode support substrate 133c is a flexible film of an electrically insulative synthetic resin, such as polyimide resin. The transport electrodes 133a are provided on the upper surface of the transport-electrode support substrate 133c.

The transport-electrode coating layer 133d is provided on the upper surface of the transport-electrode support substrate 133c on which the transport electrodes 133a are formed.

The transport-electrode coating layer 133d is provided to cover the transport electrodes 133a. The transport-electrode coating layer 133d covers the transport-electrode support substrate 133c and the transport electrodes 133a, thereby making the toner transport surface 133b smooth.

Referring to FIGS. 11 and 12, the toner electric-field transport body 132 includes a transport-substrate support member 134. The transport-substrate support member 134 is provided so as to support the transport wiring substrate 133 from underneath.

Referring to FIG. 11, a rear end portion of the transport-substrate support member 134 is curved downward along the casing top cover 131a of the developing casing 131. Also, a front end portion of the transport-substrate support member 134 is curved downward in a manner similar to that of the rear end portion. A portion of the transport-substrate support member 134 between the above-mentioned front and rear portions assumes the form of a generally flat plate.

That is, the transport-substrate support member 134 is formed in a shape resembling the inverted letter U as viewed from the lateral direction.

Referring to FIGS. 11 and 12, the toner electric-field transport body 132 is configured to be able to transport the toner T as follows. Transport voltages as shown in FIG. 4 are applied to the transport electrodes 133a of the transport wiring substrate 133, thereby generating traveling-wave electric fields along the toner transport direction TTD. By this procedure, the positively charged toner T can be transported in the toner transport direction TTD.

Referring to FIGS. 10 and 11, the counter wiring substrate 135 is attached to the above-described recess formed on the inner surface of the casing top cover 131a at a position corresponding to the developing-section counter plate 131a1. That is, the counter wiring substrate 135 is supported on the inner wall surface of the developing-section counter plate 131a1 having the developing opening portion 131a2, in such a manner as to face the toner transport surface 133b with a predetermined gap therebetween.

The counter wiring substrate 135 has a configuration similar to that of the above-described transport wiring substrate 133.

That is, as shown in FIG. 12, the counter electrodes 135a are formed of a copper foil having a thickness of about several tens of micrometers. The counter electrodes 135a are formed in a strip-like wiring pattern such that their longitudinal direction becomes parallel with the main scanning direction (orthogonal to the sub-scanning direction). The plurality of counter electrodes 135a are disposed in parallel with one another.

These counter electrodes 135a are arrayed along the toner transport direction TTD (along the sub-scanning direction). The counter electrodes 135a are connected to power supply circuits such that every fourth counter electrode 135a is connected to the same power supply circuit.

The counter wiring substrate 135 also includes a counter-electrode support substrate 135c and a counter-electrode coating layer 135d.

The counter-electrode support substrate 135c is a flexible film of an electrically insulative synthetic resin, such as polyimide resin. The counter electrodes 135a are provided on the lower surface of the counter-electrode support substrate 135c in FIG. 12.

The counter-electrode coating layer 135d is provided on the lower surface of the counter-electrode support substrate 135c on which the counter electrodes 135a are formed.

The counter-electrode coating layer 135d is provided to cover the counter electrodes 135a. The counter-electrode coating layer 135d covers the counter-electrode support substrate 135c and the counter electrodes 135a, thereby making the toner transport surface 135b smooth.

Like the above-described transport wiring substrate 133, the counter wiring substrate 135 is configured to be able to transport the toner T as follows. Predetermined voltages are applied to the plurality of counter electrodes 135a, thereby generating traveling-wave electric fields along the toner transport direction TTD. By this procedure, the positively charged toner T can be transported in the toner transport direction TTD.

Referring to FIG. 11, in the present embodiment, the furthest upstream portion of the counter wiring substrate 135 with respect to the toner transport direction TTD is provided adjacent to the casing bottom plate 131b having gas permeability.

That is, in the present embodiment, the casing bottom plate 131b having gas permeability is provided such that it corresponds to the furthest upstream portion of a region in which the toner T is transported by the transport wiring substrate 133 and the counter wiring substrate 135 through use of the traveling-wave electric fields.

<<<Air Circulation Apparatus>>>

Referring to FIG. 11, the developing apparatus 130 includes an air circulation apparatus 136, which serves as the gas supply section and exhaust section of the present invention.

The air circulation apparatus 136 is configured in such a manner as to fluidize the toner T within the developing casing 131 by blowing air into the developing casing 131 via the gas-permeable casing bottom plate 131b.

Further, the air circulation apparatus 136 is configured in such a manner as to exhaust air within the developing casing 131.

Specifically, the air circulation apparatus 136 is composed of an air circulation passage 136a and a pump 136b.

The air circulation passage 136a, which serves as the gas circulation passage of the present invention, is configured to air-tightly connect the gas-permeable closing plate 131d1 and the casing bottom plate 131b together externally of the developing casing 131. The pump 136b is interposed in the air circulation passage 136a.

The air circulation apparatus 136 is configured such that, when the pump 136b is driven, air within the developing casing 131 is exhausted via the gas-permeable closing plate 131d1, and is returned to the interior of the developing casing 131 via the casing bottom plate 131b having gas permeability.

<<Transfer Section>>

Referring again to FIG. 10, a transfer section 140 is provided in such a manner as to face the image carrying surface 121b1 at a position located downstream, with respect to the direction of rotation of the photoconductor drum 121, of the position where the photoconductor drum 121 and the developing apparatus 130 face each other.

The transfer section 140 includes a rotary center shaft 141, which is a roller-like member and is made of a metal, and a semiconductive rubber layer 142, which is circumferentially provided on the rotary center shaft 141.

The rotary center shaft 141 is disposed in parallel with the main scanning direction (the z-axis direction in FIG. 10). A high-voltage power supply is connected to the rotary center shaft 141. The semiconductive rubber layer 142 is formed of a synthetic rubber containing carbon black or the like kneadingly mixed thereunto such that the rubber layer exhibits semiconductivity.

The transfer section 140 is configured to be able to transfer the toner T from the image carrying surface 121b1 to the paper P by means of being rotatably driven counterclockwise while a predetermined transfer voltage is applied between the transfer section 140 and the drum body 121a of the photoconductor drum 121.

<<Paper Feed Cassette>>

A paper feed cassette 150 is disposed under the developing apparatus 130.

A paper feed cassette case 151 is a box-like member used to form the casing of the paper feed cassette 150 and opens upward. The paper feed cassette case 151 is configured to be able to contain a large number of sheets of the paper P of up to size A4 (210 mm width×297 mm length) in a stacked state.

A paper-pressing plate 153 is disposed within the paper feed cassette case 151. The paper-pressing plate 153 is supported by the paper feed cassette case 151 in such a manner as to pivotally move on a pivot at its front end portion, so that its rear end can move vertically in FIG. 1. An unillustrated spring urges the rear end portion of the paper-pressing plate 153 upward.

<<Paper Transport Section>>

A paper transport section 160 is housed within the body casing 112.

The paper transport section 160 is configured to be able to feed the paper P to a transfer position TP where the transfer section 140 and the image carrying surface 121b1 face each other with a smallest gap therebetween. The paper transport section 160 includes a paper feed roller 161, a paper guide 163, and paper transport guide rollers 165.

The paper feed roller 161 includes a rotary center shaft parallel to the main scanning direction and a rubber layer, which is circumferentially provided on the rotary center shaft. The paper feed roller 161 is disposed in such a manner as to face a leading end portion, with respect to the paper transport direction, of the paper P stacked on the paper-pressing plate 153 housed within the paper feed cassette case 151.

The paper guide 163 and the paper transport guide rollers 165 are configured to be able to guide to the transfer position TP the paper P which has been delivered by the paper feed roller 161.

<<Fixing Section>>

A fixing section 170 is housed within the body casing 112. The fixing section 170 is disposed downstream of the transfer position TP with respect to the paper transport direction.

The fixing section 170 is configured to apply pressure and heat to the paper P which has passed the transfer position TP and bears an image in the toner T, thereby fixing the image in the toner T on the paper P. The fixing section 170 includes a heating roller 172 and a pressure roller 173.

The heating roller 172 includes a cylinder which is made of a metal and whose surface is exfoliation-treated, and a halogen lamp which is housed within the cylinder.

The pressure roller 173 includes a rotary center shaft which is made of a metal, and a silicone rubber layer which is circumferentially provided on the rotary center shaft. The heating roller 172 and the pressure roller 173 are disposed in such a manner as to press against each other under a predetermined pressure.

The heating roller 172 and the pressure roller 173 are configured and disposed so as to be able to deliver the paper P toward the paper ejection port 112a while applying pressure and heat to the paper P.

<Outline of Image Forming Operation of the Laser Printer>

The outline of an image forming operation of the laser printer 100 having such a configuration will next be described with reference to the drawings.

<<Paper Feed Operation>>

Referring to FIG. 10, the paper-pressing plate 153 urges the paper P stacked thereon upward toward the paper feed roller 161. This causes the top paper P of a stack of the paper P on the paper-pressing plate 153 to come into contact with the circumferential surface of the paper feed roller 161.

When the paper feed roller 161 is rotatably driven clockwise in FIG. 10, a leading end portion with respect to the paper transport direction of the top paper P is moved toward the paper guide 163. Then, the paper guide 163 and the paper transport guide rollers 165 transport the paper P to the transfer position TP.

<<Formation of Toner Image on Image Carrying Surface>>

While the paper P is being transported to the transfer position TP as described above, an image in the toner T is formed as described below on the image carrying surface 121b1, which is the circumferential surface of the photoconductor drum 121.

<<<Formation of Electrostatic Latent Image>>>

First, the charger 123 uniformly charges a portion of the image carrying surface 121b1 of the photoconductor drum 121 to positive polarity.

Referring to FIG. 12, as a result of the clockwise rotation of the photoconductor drum 121, the portion of the image carrying surface 121b1 which has been charged by the charger 123 moves along the sub-scanning direction to the scanning position SP, where the portion of the image carrying surface 121b1 faces (faces straight toward) the scanner unit 122.

At the scanning position SP, the charged portion of the image carrying surface 121b1 is irradiated with the laser beam LB modulated on the basis of image information, while the laser beam LB sweeps along the main scanning direction. Certain positive charges are lost from the charged portion of the image carrying surface 121b1, according to a state of modulation of the laser beam LB. By this procedure, an electrostatic latent image LI in the form of an imagewise distribution of positive charges is formed on the image carrying surface 121b1.

As a result of the clockwise rotation of the photoconductor drum 121 in FIG. 12, the electrostatic latent image LI formed on the image carrying surface 121b1 moves toward the development facing position DP.

<<<Fluidization of Toner>>>

Referring to FIG. 11, as a result of the pump 136b of the air circulation apparatus 136 being driven, a flow of air is formed within the air circulation passage 136a such that air flows from the gas-permeable closing plate 131d1 toward the casing bottom plate 131b.

As a result, a negative pressure is generated in a space on the front side (the right side in FIG. 11) of the gas-permeable closing plate 131d1; that is, at the furthest upstream portion of the air circulation passage 136a with respect to the air flow direction. Due to this negative pressure, air within the developing casing 131 is exhausted to the air circulation passage 136a via the gas-permeable closing plate 131d1.

Meanwhile, the pump 136b feeds air into a space under the casing bottom plate 131b; that is, the furthest downstream portion of the air circulation passage 136a. As a result, air is blown into the lowest portion of the internal space of the developing casing 131 via the casing bottom plate 131b.

When air is blown from the lower side of the casing bottom plate 131b by means of the air circulation apparatus 136 as described above, the toner T stored in a lower portion of the internal space of the developing casing 131 is fluidized so that the toner T behaves like a liquid. Hereinafter, the ensemble of the fluidized toner T at the lower portion of the developing casing 131 will be referred to as the “toner pool.”

<<<Transport of Charged Toner>>>

Referring to FIG. 11, predetermined voltages (similar to those shown in FIG. 4) are applied to the counter wiring substrate 135, thereby forming predetermined traveling-wave electric fields on the counter wiring substrate 135. Thus, the sufficiently fluidized toner T at a rear end portion of the above-described toner pool is transported, by means of the electric fields, from a furthest upstream portion (located at the lower left side in FIG. 11), with respect to the toner transport direction TTD, of the counter wiring substrate 135 to a position where a rear end portion of the transport wiring substrate 133 and the counter wiring substrate 135 face each other, in such a manner that the toner T moves up along the sloped portion of the toner transport surface 135b.

In the case where the furthest upstream portion is covered with the toner T (toner pool), the transport is started from a position where the transport wiring substrate 133 is exposed from the toner T (toner pool).

The toner T residing between the transport wiring substrate 133 and the counter wiring substrate 135 is transported toward the development facing position DP by the effect of traveling-wave electric fields generated along the toner transport surface 133b of transport wiring substrate 133 and the toner transport surface 135b of the counter wiring substrate 135.

The toner T having passed through the development facing position DP falls down from a frontmost end portion of the toner transport surface 133b, so that the toner T returns to the above-described toner pool.

<<<Development of Electrostatic Latent Image>>>

Referring to FIG. 12, the positively charged toner T is transported to the development facing position DP as described above.

In the vicinity of the development facing position DP, the toner T adheres to portions of the electrostatic latent image LI on the image carrying surface 121b1 at which positive charges are lost. That is, the electrostatic latent image LI on the image carrying surface 121b1 of the photoconductor drum 121 is developed with the toner T. Thus, an image in the toner T is carried on the image carrying surface 121b1.

<<Transfer of Toner Image from Image Carrying Surface to Paper>>

Referring to FIG. 10, as a result of clockwise rotation of the image carrying surface 121b1, an image in the toner T which has been carried on the image carrying surface 121b of the photoconductor drum 121 as described above is transported toward the transfer position TP.

At the transfer position TP, the image in the toner T is transferred from the image carrying surface 121b1 onto the paper P.

<<Fixing and Ejection of Paper>>

The paper P onto which an image in the toner T has been transferred at the transfer position TP is sent to the fixing section 170 along the paper path PP.

The paper P is nipped between the heating roller 172 and the pressure roller 173, thereby being subjected to pressure and heat. By this procedure, the image in the toner T is fixed on the paper P.

Subsequently, the paper P is sent to the paper ejection port 112a and is then ejected onto the catch tray 114 through the paper ejection port 112a.

<Actions and Effects Achieved by the Configuration of the Embodiment>

According to the configuration of the present embodiment, air is blown from the bottom portion of the developing casing 131 into the interior of the developing casing 131 via the gas-permeable casing bottom plate 131b.

As a result, the toner T is fluidized. Stresses, such as compressive force and shearing force, acting on the toner T at that time are very small.

By virtue of such a configuration, the toner T is fluidized more satisfactorily within the developing casing 131. Thus, the toner T can be supplied to the toner transport surface 133b more uniformly. The, the toner T can be transported on the transport surface 133b more uniformly.

As described above, the configuration of the present embodiment enables more uniform performance of the transport of the toner T on the toner transport surface 133b and the supply of the toner T to the development facing position DP by means of the traveling-wave electric fields. Accordingly, generation of density non-uniformity can be suppressed effectively, whereby satisfactory image formation becomes possible.

In the configuration of the present embodiment, the rear end portion of the gas-permeable casing bottom plate 131b is located at a position near the furthest upstream portion of the toner transport surface 133b with respect to the toner transport direction TTD. That is, in the configuration of the present embodiment, the gas-permeable casing bottom plate 131b is provided such that it corresponds to the furthest upstream portion of the toner transport surface 133b with respect to the toner transport direction TTD.

By virtue of such a configuration, the transport state of the toner T can be made uniform at the beginning of transport of the toner T on the toner transport surface 133b by means of traveling-wave electric fields.

Further, in the configuration of the present embodiment, the rear end portion of the casing bottom plate 131b is located adjacent to the furthest upstream portion of the counter wiring substrate 135 with respect to the toner transport direction TTD.

By virtue of such a configuration, the transport state of the toner T can be made uniform at the beginning of transport of the toner T on the toner transport surface 135b by means of traveling-wave electric fields.

Moreover, in the configuration of the present embodiment, the rear end portion of the gas-permeable casing bottom plate 131b is located adjacent to the furthest upstream portion of a region in which the toner T is transported by the transport wiring substrate 133 and the counter wiring substrate 135 through use of the traveling-wave electric fields.

By virtue of such a configuration, the transport state of the toner T can be made more uniform at the beginning of the transport of the toner T performed by use of the traveling-wave electric fields.

In the configuration of the present embodiment, the gas-permeable casing bottom plate 131b corresponds not only to a position near the furthest upstream portion of the toner transport surface 133b with respect to the toner transport direction TTD, but also to substantially the entire space in which the toner T can be stored within the developing casing 131.

By virtue of such a configuration, substantially the entirety of the toner T within the developing casing 131 is fluidized satisfactorily by means of blowing of air. Therefore, the toner T within the developing casing 131 is uniformly provided for transport on the toner transport surface 133b. Accordingly, it is possible to suppress, to the greatest possible extent, deterioration of a portion of the toner T which portion would otherwise be frequently transported on the toner transport surface 133b.

In the configuration of the present embodiment, by means of the air circulation apparatus 136, air is blown into the developing casing 131 via the casing bottom plate 131b, and air is exhausted from the developing casing 131 via the gas-permeable closing plate 131d1 provided at a location different from that of the developing opening portion 131a2.

By virtue of such a configuration, a negative pressure is generated within the developing casing 131 at a position separated from the developing opening portion 131a2.

Thus, when gas is blown into the developing casing 131 via the casing bottom plate 131b, spouting of the toner T from the developing opening portion 131a2 together with air can be suppressed effectively. That is, accidental leakage of the toner T from the developing casing 131 can be suppressed to the greatest possible extent.

<Modifications>

(1) No particular limitation is imposed on the configurations of the toner electric-field transport body 132, the transport wiring substrate 133, and the counter wiring substrate 135 in the above-described embodiment.

For example, the transport electrodes 133a can be embedded in the transport-electrode support substrate 133c so as not to project from the surface of the transport-electrode support substrate 133c. The transport-electrode coating layer 133d can be omitted. The transport electrodes 133a can be formed directly on the transport-substrate support member 134.

The counter electrodes 135a can also be, for example, embedded in the counter-electrode support substrate 135c so as not to project from the surface of the counter-electrode support substrate 135c. The counter-electrode coating layer 135d can be omitted. The counter electrodes 135a can be formed directly on the inner wall surface of the developing casing 131.

The longitudinal direction of the transport electrodes 133a and that of the counter electrodes 135a may be in parallel with the main scanning direction as in the case of the above-described embodiment or may intersect with the main scanning direction. The direction of arraying the transport electrodes 133a and that of arraying the counter electrodes 135a may be in parallel with the sub-scanning direction as viewed in plane as in the case of the above-described embodiment or may intersect with the sub-scanning direction as viewed in plane.

No particular limitation is imposed on the transport electrodes 133a and the counter electrodes 135a with respect to shape and the configuration of electrical connections. For example, in place of the form of a straight line as in the case of the above-described embodiment, the transport electrodes 133a and the counter electrodes 135a can assume various other forms, such as V-shaped, arc, waves, and serrated.

The pattern of connecting the electrodes is not limited to that of connecting every fourth electrode as in the case of the above-described embodiment. For example, every other electrode or every third electrode may be connected. In this case, the corresponding power circuits are not of four kinds, but can be modified as appropriate such that the phase shift of voltage waveforms is 180°, 120°, etc. Furthermore, the voltage waveform can be rectangular waves, sine waves, and waves of various other shapes.

(2) The entire casing bottom plate 131b is not required to have gas permeability.

For example, a gas-permeable portion may be formed at least at a position facing the toner electric-field transport body 132.

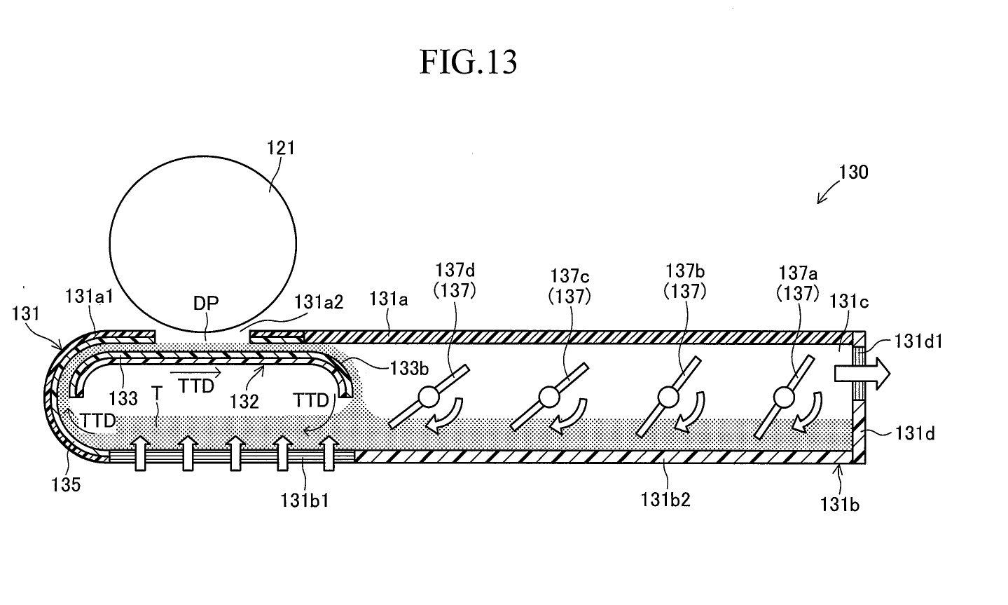

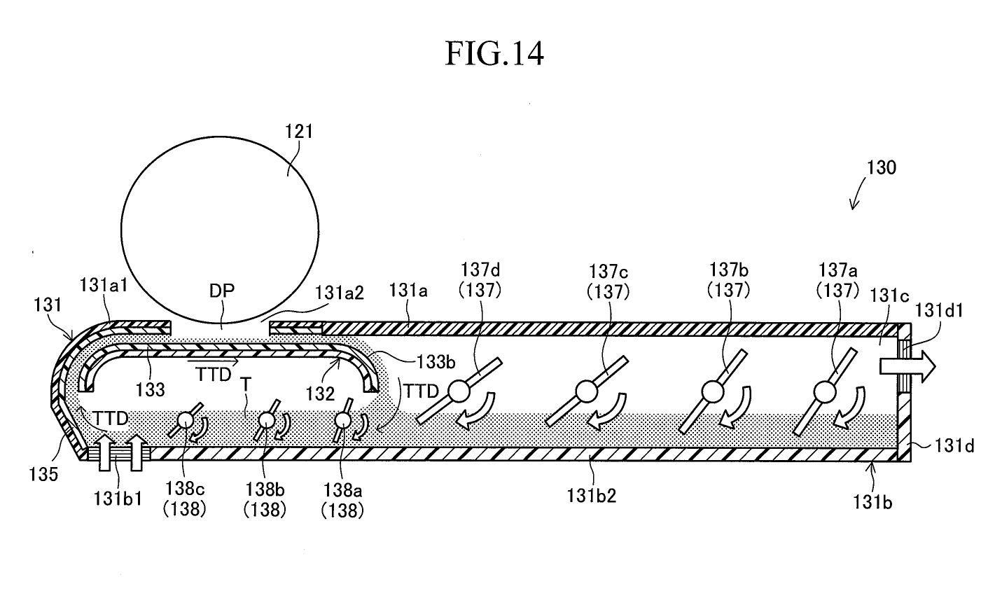

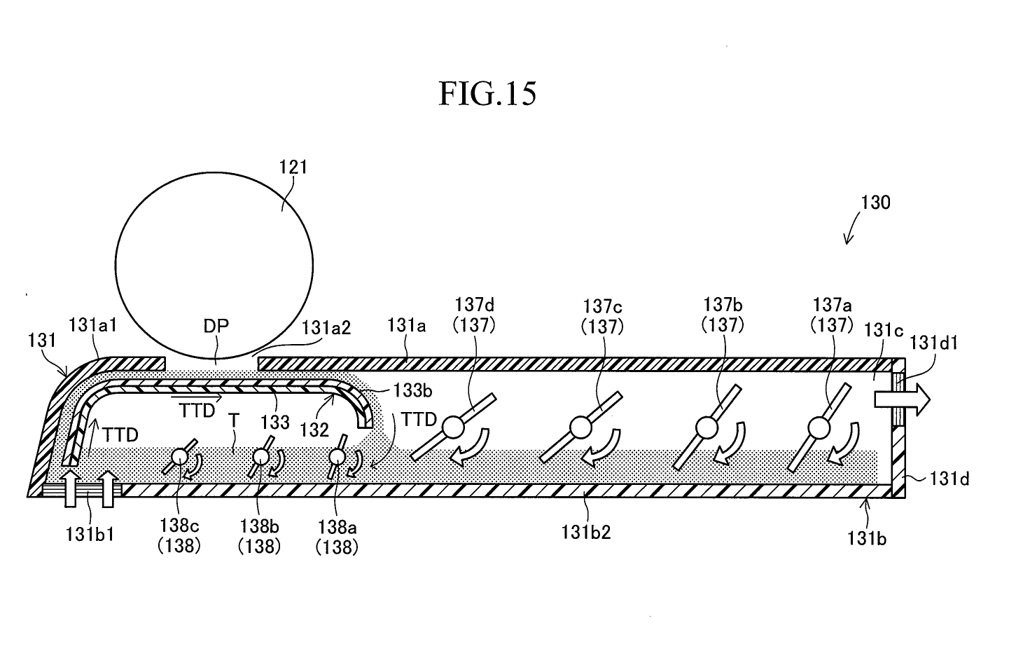

FIG. 13 is a side sectional view showing one modification of the developing apparatus 130 shown in FIG. 11 (in FIG. 13, the air circulation apparatus 136 shown in FIG. 11 is omitted. Similarly, the air circulation apparatus 136 is omitted in FIGS. 14 and 15, which will be later).

Referring to FIG. 13, in the present modification, the above-described half-pipe portion, which is the rear end portion of the casing top cover 131a (the developing-section counter plate 131a1), is formed into a generally semi-cylindrical shape.

Further, a ventilating section 131b1 is formed in a rear portion of the casing bottom plate 131b at a position facing the toner electric-field transport body 132. A non-ventilating section 131b2 is provided in a front portion of the casing bottom plate 131b in which the ventilating section 131b1 is not provided.

As in the above-described embodiment, the ventilating section 131b1 is formed of a porous ceramic. A front end portion of the ventilating section 131b1 is provided at a position corresponding to a front end portion of the toner electric-field transport body 132. That is, the ventilating section 131b1 is provided below the toner electric-field transport body 132.

Further, a rear end portion of the ventilating section 131b1 is located at a position slightly separated from the furthest upstream portion of the toner transfer surface 133b with respect to the toner transport direction TTD.

FIG. 14 is a side sectional view showing another modification of the developing apparatus 130 shown in FIG. 11.

In the modification shown in FIG. 14, a lower end portion of the rear side of the casing top cover 131a is formed to have a slope which slops downward toward the front side and toward the rear end portion of the casing bottom plate 131b, as viewed in the side sectional view. Further, the ventilating section 131b1 is provided at the rearmost end portion of the casing bottom plate 131b such that the ventilating section 131b1 is connected to the lower end portion of the rear side of the casing top cover 131a.

In the modification shown in FIG. 15, the lower end portion of the rear side of the casing top cover 131a is formed to have a slope which slops downward toward the rear side and toward the rear end portion of the casing bottom plate 131b, as viewed in the side sectional view. Further, as in the above-described case, the ventilating section 131b1 is provided at the rearmost end portion of the casing bottom plate 131b such that the ventilating section 131b1 is connected to the lower end portion of the rear side of the casing top cover 131a.

That is, as shown in FIGS. 14 and 15, in these modifications, the ventilating section 131b1 is provided only at a position (a left-side lower end portion in these drawings) corresponding to the furthest upstream portion of the toner electric-field transport body 132 (the transport wiring substrate 133) with respect to the toner transport direction TTD.

Specifically, the ventilating section 131b1 is provided immediately below the furthest upstream portion of the toner electric-field transport body 132 (the transport wiring substrate 133) with respect to the toner transport direction TTD. Further, in FIG. 15, the ventilating section 131b1 is provided such that, with respect the horizontal direction, it overlaps the furthest upstream portion of the toner transport surface 133b with respect to the toner transport direction TTD. Moreover, in FIG. 15, the ventilating section 131b1 is provided such that it faces the furthest upstream portion of the toner transport surface 133b with respect to the toner transport direction TTD.

In these configurations, the toner T at a position corresponding to the furthest upstream portion of the toner transport surface 133b with respect to the toner transport direction TTD is fluidized satisfactorily. The satisfactorily fluidized toner T is supplied to the furthest upstream portion of the toner transport surface 133b. As a result, the transport of the toner T at the furthest upstream portion of the toner transport surface 133b can be made uniform. Accordingly, the transport of the toner T on the toner transport surface 133b and the supply of the toner T to the development facing position DP can be performed uniformly with the non-uniformity being reduced further.

Further, in the configurations of the modifications shown in FIGS. 13 and 14, the ventilating section 131b1 and the gas-permeable closing plate 131d1 are provided at diagonally opposite positions. That is, in the configurations shown in FIGS. 13 and 14, while the gas-permeable closing plate 131d1 is provided at an upper right position in a side sectional view of the developing casing 131, the ventilating section 131b1 is provided at a lower left position in the view.

By virtue of the configurations of these modifications, a negative pressure is generated within the developing casing 131 at a position more separated from the developing opening portion 131a2. Thus, when air is blown into the developing casing 131 via the casing bottom plate 131b, spouting of the toner T from the developing opening portion 131a2 together with air can be suppressed more effectively.

Notably, the ventilating section 131b1 may be provided at a position which is separated from the toner transport surface 133b (for example, a position diagonally located in relation to the toner transport surface 133b) and is located adjacent to the toner transport surface 135b.

(3) As shown in FIG. 13, at least one agitator 137, which serves as an agitating member, may be provided within the developing casing 131. The agitator 137 is rotatably supported within the developing casing 131.

In such a configuration, even when the agitator 137 is not rotated violently, fluidization of the toner T within the developing casing 131 can be performed satisfactorily.

In the case where the casing bottom plate 131b has the non-ventilating section 131b2, the agitator 137 may be preferably provided at a position corresponding to the non-ventilating section 131b2, as shown in FIG. 13.

By virtue of such a configuration, when the amount of the toner pool on the ventilating section 131b1 decreases, the toner T can be added to the toner pool in a small amount at a time by means of rotating the agitator 137. Since the excess toner T continuously stored within the developing casing 131 is agitated, deterioration of the toner T can be suppressed to the greatest possible extent.

Notably, in order to decrease the frequency of maintenance by increasing the amount of the excess toner T, the developing casing 131 may be formed such that its length as measured along the front-rear direction becomes sufficiently greater than that of the toner electric-field transport body 132 (e.g., at least two times that of the toner electric-field transport body 132). In such a case, a plurality of agitators 137 may be provided.

In the configuration of FIG. 13, four agitators 137 are provided; i.e., an upstream agitator 137a, a first intermediate agitator 137b, a second intermediate agitator 137c, and a downstream agitator 137d.

In such a configuration, the drive states of the upstream agitator 137a, the first intermediate agitator 137b, the second intermediate agitator 137c, and the downstream agitator 137d are properly controlled in accordance with the degree of consumption of the toner T within the developing casing 131.

For example, when the degree of consumption of the toner T is small (in an initial stage), the upstream agitator 137a, the first intermediate agitator 137b, and the second intermediate agitator 137c are stopped continuously; and only the downstream agitator 137d is properly rotated in accordance with the degree of decrease in the amount of the toner pool.

As the degree of consumption of the toner T within the developing casing 131 increases, the number of the agitators 137, which are rotated in response to a decrease in the amount of the toner pool, is increased.

That is, the number of the rotated agitators 137 is increased in such a manner that in a second stage the second intermediate agitator 137c and the downstream agitator 137d are rotated; in a third stage the first intermediate agitator 137b, the second intermediate agitator 137c, and the downstream agitator 137d are rotated; and in a final stage all the agitators 137 are rotated.

(4) The agitating members such as agitators may be provided at positions located away from the toner electric-field transport body 132 as shown in FIG. 13, or at positions corresponding to the toner electric-field transport body 132 (below the toner electric-field transport body 132).

Further, as shown in FIG. 14, in addition to the agitators 137 provided at positions located away from the toner electric-field transport body 132, a sub-agitator 138, which is smaller in size than the agitators 137, may be provided at a position corresponding to the toner electric-field transport body 132 (below the toner electric-field transport body 132).

In this case, preferably, the sub-agitator 138 is provided below a downstream portion of the toner electric-field transport body 132 with respect to the toner transport direction TTD.

By virtue of this configuration, a portion of the toner T returned from the downstream portion of the toner electric-field transport body 132 with respect to the toner transport direction TTD can be agitated satisfactorily. Thus, that portion of the toner T is supplied satisfactorily to the furthest upstream portion (the lower end portion in FIG. 14) of the counter wiring substrate 135 with respect to the toner transport direction TTD.

Further, a plurality of sub-agitators 138 may be provided, as shown in FIG. 14. In the configuration of FIG. 14, three sub-agitators 138 are provided; i.e., an upstream sub-agitator 138a, an intermediate sub-agitator 138b, and a downstream sub-agitator 138c.

These sub-agitators 138 are properly rotated in accordance with the degree of decrease in the amount of the toner pool in a manner similar to that in the above-described example.

Further, in the case where, as shown in FIG. 14, the ventilating section 131b1 of the casing bottom plate 131b is formed only in a region corresponding to an upstream portion of the toner electric-field transport body 132 with respect to the toner transport direction TTD, a sub-agitator 138 (or a plurality of sub-agitators 138) is provided above a portion of the non-ventilating section 131b2, the portion being located below the toner electric-field transport body 132; and an agitator 137 (a plurality of agitators 137) is provided above a portion of the non-ventilating section 131b2, which portion does not corresponds to the toner electric-field transport body 132.

By virtue of such a configuration, through fine control of rotations of the agitators 137 and the sub-agitators 138 in accordance with the amount of the toner T within the developing casing 131 and the amount of the toner pool, the state of supply of the toner T to the toner electric-field transport body 132 can be optimized further.

(5) The configurations of the gas-permeable bottom plate and the exhaust port of the present invention are not limited to those of the above-described embodiment and modifications.

For example, the opening diameter of the porous ceramic which constitutes the casing bottom plate 131b (the ventilating section 131b1) and the gas-permeable closing plate 131d1 is not limited to that employed in the above-described embodiment.

Further, the materials of the casing bottom plate 131b (the ventilating section 131b1) and the gas-permeable closing plate 131d1 are not limited to porous ceramic. For example, in place of the casing bottom plate 131b (the ventilating section 131b1) and the gas-permeable closing plate 131d1, which are made of porous ceramic, there may be used through holes formed in the developing casing 131 and filters which cover the through holes from the outside.

Moreover, the exhaust port of the present invention may be provided at a front end portion of the casing top cover 131a.

(6) The counter wiring substrate 135 may be omitted partially or entirely.

In this case, as shown in FIG. 15, preferably, the end portion (the left-side lower end portion in FIG. 15) of the toner electric-field transport body 132 (the transport wiring substrate 133) located on the furthest upstream side with respect to the toner transport direction TTD extends downward to such a position that the end portion is immersed into the toner pool substantially at all times.

[1-3]

<Overall Configuration of Third Laser Printer>

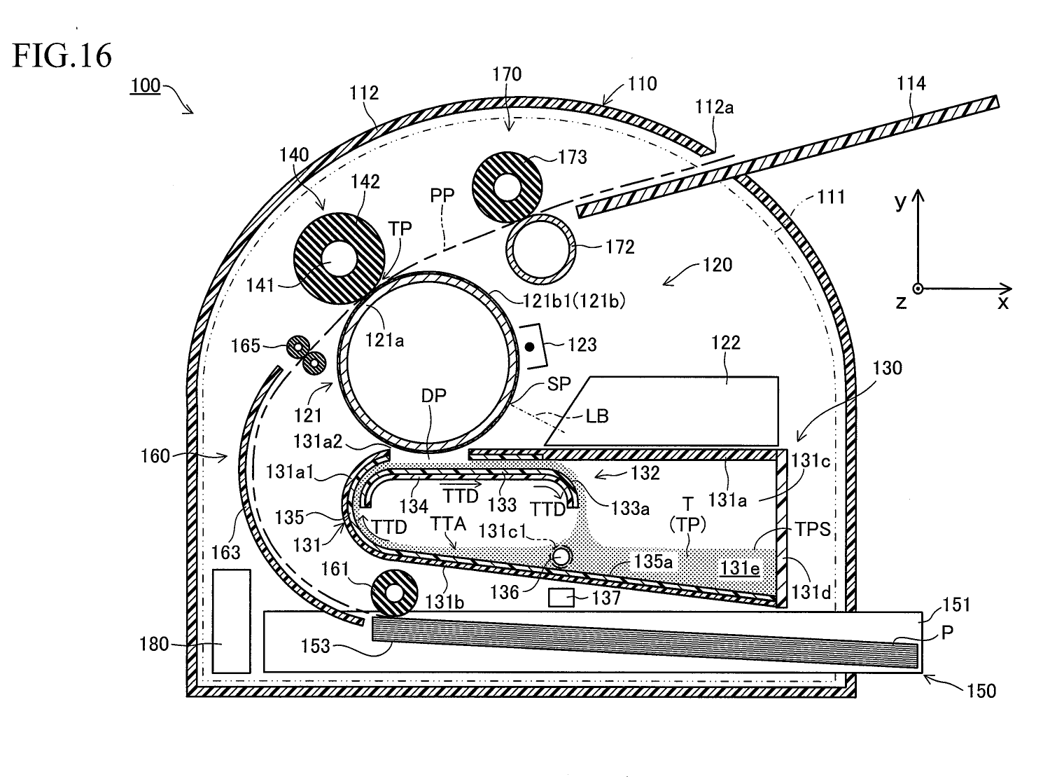

FIG. 16 is a side sectional view showing the schematic configuration of a laser printer 100 to which the third embodiment of the present invention is applied.

<<Body Section>>

Referring to FIG. 16, the laser printer 100, which corresponds to the image forming apparatus of the present invention, includes a body portion 110. The body portion 110 constitutes a main part of the laser printer 100, and includes a body frame 111 and a body casing 112.

The body frame 111 is covered with the body casing 112. The body frame 111 supports various members to be described later which are provided for image forming operation of the laser printer 100. The body casing 112 is a member which constitutes an outer cover of the laser printer 100, and is integrally formed from a synthetic resin plate.

The body casing 112 has a paper ejection port 112a in the form of a slit-like through-hole located at an upper front portion thereof.

A catch tray 114 is attached to an upper front portion of the body casing 112 at a position corresponding to the paper ejection port 112a. The catch tray 114 is configured to receive the paper P which is ejected through the paper ejection port 112a and on which an image has been formed.

<<Electrostatic-Latent-Image Forming Section>>

The body casing 112 houses an electrostatic-latent-image forming section 120. The electrostatic-latent-image forming section 120 includes a photoconductor drum 121, which corresponds to the electrostatic-latent-image carrying body and the developer carrying body of the present invention.

The photoconductor drum 121 is a generally cylindrical member. The center axis of rotation of the photoconductor drum 121 is in parallel with the paper width direction. The photoconductor drum 121 is configured to be able to be rotatably driven clockwise in FIG. 16.

Specifically, the photoconductor drum 121 includes a drum body 121a and a photoconductor layer 121b.

The drum body 121a is a metal tube of an aluminum alloy or the like. The photoconductor layer 121b is formed on the outer circumference of the drum body 121a.

The photoconductor layer 121b is formed by a positively chargeable photoconductive layer. That is, the photoconductor layer 121b is formed of a substance which exhibits electrical conductivity, with holes serving as a carrier, when it is irradiated with light within a predetermined wavelength band.

The photoconductor drum 121 has an image carrying surface 121b1, which serves as the latent-image forming surface and the developer carrying surface of the present invention.

The circumferential surface of the photoconductor layer 121b serves as the image carrying surface 121b1. The image carrying surface 121b1 is formed in parallel with the paper width direction and a main scanning direction, which will be described later. The image carrying surface 121b1 is configured such that an electrostatic latent image can be formed by electric-potential distribution.

The photoconductor drum 121 is configured such that the image carrying surface 121b1 can move along a sub-scanning direction to be described later (a direction orthogonal to a main scanning direction to be described later).

The electrostatic-latent-image forming section 120 includes a scanner unit 122 and a charger 123.

The scanner unit 122 is configured to generate a laser beam LB. This laser beam LB has a wavelength band which is contained in the above-described predetermined wavelength band in which the photoconductor layer 121b exhibits electrical conductivity, and is modulated in accordance with image information.

The scanner unit 122 is configured such that it can sweep the laser beam LB along the main scanning direction. The main scanning direction is a direction (the z-axis direction in FIG. 16) parallel to the paper width direction.

That is, the scanner unit 122 is configured and disposed such that it can irradiate the image carrying surface 121b1 with the laser beam LB at a predetermined scanning position SP, while sweeping the laser beam LB along the main scanning direction.

The charger 123 is disposed upstream of the scanning direction SP with respect to the direction of movement of the image carrying surface 121b1 (direction of rotation of the photoconductor drum 121). The charger 123 is configured and disposed so as to be able to uniformly, positively charge the image carrying surface 121b1 at a position located upstream of the scanning position SP with respect to the above-mentioned direction.

The electrostatic-latent-image forming section 120 is configured such that the scanner unit 122 irradiates, with the laser beam LB, the image carrying surface 121b1 which is uniformly, positively charged by the charger 123, whereby an electrostatic latent image by electric-potential distribution (charge distribution) can be formed on the image carrying surface 121b1.

The electrostatic-latent-image forming section 120 is configured to be able to move the image carrying surface 121b1 on which an electrostatic latent image is formed, along the sub-scanning direction.

The “sub-scanning direction” is an arbitrary direction orthogonal to the main scanning direction. Usually, the sub-scanning direction is a direction which intersects with a vertical line. Typically, the sub-scanning direction may be a direction along the front-rear direction of the laser printer 100 (the x-axis direction in FIG. 16).

<<Developing Apparatus>>

The body casing 112 houses a developing apparatus 130, which corresponds to the developer supply apparatus of the present invention. The developing apparatus 130 is attached to the body frame 111 of the body portion 110. This developing apparatus 130 is configured such that it can be easily attached to and detached from the body frame 111.

A toner T, which is a dry developer in the form of fine particles (powder developer) is stored within the developing apparatus 130. This developing apparatus 130 is disposed in such a manner as to face the photoconductor drum 121 at a development facing position DP (developing position; facing position).

The developing apparatus 130 is configured to transport the toner T, while circulating it along a circulating transport path formed to have a generally oval (elliptical) shape as viewed in a side sectional view. That is, the toner transport direction TTD, which corresponds to the developer transport direction of the present invention, is a direction tangent to the circulating transport path at an arbitrary point in the side sectional view.

The toner transport direction TTD is set such that, when viewed from above (when viewed in a direction parallel with the y-axis direction in FIG. 16), the toner transport direction TTD becomes generally parallel with the sub-scanning direction (the x-axis direction in FIG. 16) (Notably, the toner transport direction TTD may partially extend parallel to the height direction (the y-axis direction in FIG. 16)).

The developing apparatus 130 is configured and disposed as described below such that it can transport the toner T in a charged state in the toner transport direction TTD along the above-described circulating transport path, and supply the image carrying surface 121b1 on which an electrostatic latent image is formed, with the toner T in the vicinity of the development facing position DP.

Notably, the toner T used in the present embodiment is a non-magnetic 1-component developer for use in electrophotography.

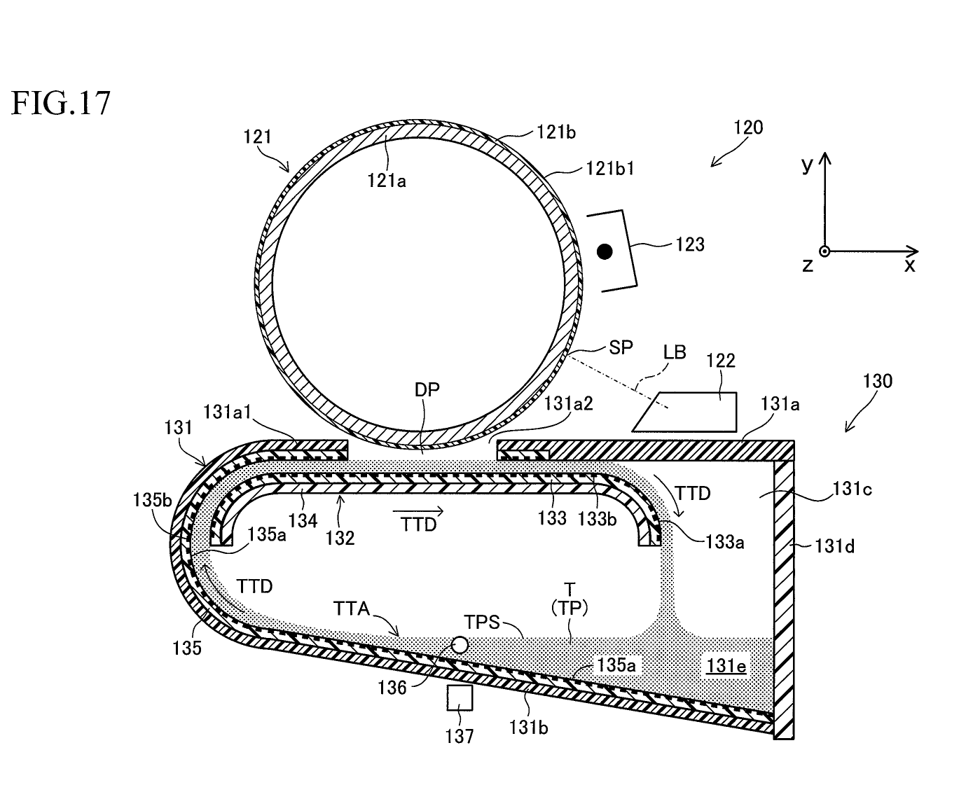

FIG. 17 is an enlarged side sectional view showing the electrostatic-latent-image forming section 120 and the developing apparatus 130 shown in FIG. 16.

Referring to FIGS. 16 and 17, the developing apparatus 130 is disposed below the photoconductor drum 12. This developing apparatus 130 is provided in such a manner as to face the image carrying surface 121b1 at a position located downstream of the scanning position SP with respect to the direction of movement of the image carrying surface 121b1.

<<<Developing Casing>>>

Referring to FIGS. 16 and 17, a developing casing 131, which corresponds to the developer containing casing of the present invention, is a box-like member formed of a synthetic resin. This developing casing 131 is configured as described below such that it can contain (store) the toner T therein.

The developing casing 131 has a casing top cover 131a. The casing top cover 131a is formed to assume a generally J-like shape as viewed in a side sectional view. A developing-section counter plate 131a1, which is a rear portion of the casing top cover 131a, is smaller in thickness than the remaining portion.

The developing-section counter plate 131a1 is composed of a flat plate portion which is located below the photoconductor drum 121, and a semi-cylindrical portion connected to a rear end of the flat plate portion.

A developing opening portion 131a2, which corresponds to the opening portion of the present invention, is formed in the flat plate portion of the developing-section counter plate 131a1. The developing opening portion 131a2 is provided in the developing-section counter plate 131a1 at a position facing the image carrying surface 121b1 such that the developing opening portion 131a2 surrounds the development facing position DP.

Further, the developing casing 131 has a casing bottom plate 131b. The casing bottom plate 131b is provided to face the casing top cover 131a. This casing bottom plate 131b is formed from a flat-plate-shaped member having the same thickness as the developing-section counter plate 131a1.

The casing bottom plate 131b is provided in an inclined state such that the casing bottom plate 131b forms a constant angle (e.g., 30 degrees or less) in relation to a horizontal plane. That is, the casing bottom plate 131b is disposed in such a manner that the surface of the casing bottom plate 131b located on the upper side in FIG. 16 forms a (gentle) slope which ascends from the front side toward the rear side.

A rear end portion of the casing bottom plate 131b is connected to a lower end of the semi-cylindrical portion of the casing top cover 131a. That is, the casing bottom plate 131b and the casing top cover 131a are integrally formed such that they are smoothly connected at the rear end of the developing casing 131.

Further, the developing casing 131 includes a pair of casing side plates 131c. The casing side plates 131c are formed from flat plates made of a synthetic resin.

The pair of casing side plates 131c are closingly attached to the opposite ends, with respect to the paper width direction, of the casing top cover 131a and to those of the casing bottom plate 131b. A casing through hole 131c1 is formed in at least one of the paired casing side plates 131c. This casing through hole 131c1 is provided in the vicinity of the casing bottom plate 131b.

A casing front closing plate 131d is closingly attached to the front end of the casing top cover 131a, to that of the casing bottom plate 131b, and to those of the paired casing side plates 131c.

That is, a space surrounded by the casing top cover 131a, the casing bottom plate 131b, the paired casing side plates 131c, and the casing front closing plate 131d constitutes a toner containing space 131e.

When the laser printer 100 is not operated, the toner T is stored at a bottom portion of the toner containing space 131e. The ensemble of the toner T stored at the bottom portion of the toner containing space 131e will be referred to as a “toner pool TP.” That is, this toner pool TP is stored at the bottom portion of the toner containing space 131e formed within the developing casing 131.

<<<Toner Electric-Field Transport Body>>

Referring to FIG. 17, the developing casing 131 houses a toner electric-field transport body 132, which corresponds to the developer transport body of the present invention. The toner electric-field transport body 132 is disposed in the inner space of the developing casing 131 at a rearward position, in such a manner as to face the image carrying surface 121b1 with the developing opening portion 131a2 therebetween. That is, the toner electric-field transport body 132 is provided such that the photoconductor drum 121 and the toner electric-field transport body 132 face each other with the developing opening portion 131a2 therebetween.

The opposite ends of the toner electric-field transport body 132 are supported by the paired casing side plates 131c in such a manner that the toner electric-field transport body 132 is supported at a position located above the casing bottom plate 131b while facing the developing-section counter plate 131a1 with a predetermined gap therebetween.

The toner electric-field transport body 132 includes the transport wiring substrate 133. The transport wiring substrate 133 is disposed in such a manner as to face the image carrying surface 121b1 with the developing opening portion 131a2 therebetween.

A toner main transport surface 133a, which is the surface of the transport wiring substrate 133 located on the upper side (outer side) in FIG. 17 and serves as the developer transport surface of the present invention, is formed in a shape resembling the inverted letter U as viewed from the lateral direction. That is, a rear end portion of the toner main transport surface 133a is curved downward along the casing top cover 131a of the developing casing 131.

Also, a front end portion of the toner main transport surface 133a is curved downward in a manner similar to that of the rear end portion. A portion of the toner main transport surface 133a between the above-mentioned front and rear portions assumes the form of a generally flat plate.

The toner main transport surface 133a is formed in parallel with the main scanning direction (the z-direction in FIG. 17). Further, the toner main transport surface 133a is disposed to face the image carrying surface 121b1 of the photoconductor drum 121. The toner main transport surface 133a and the image carrying surface 121b1 are in the closest proximity to each other at the above-described development facing position DP.

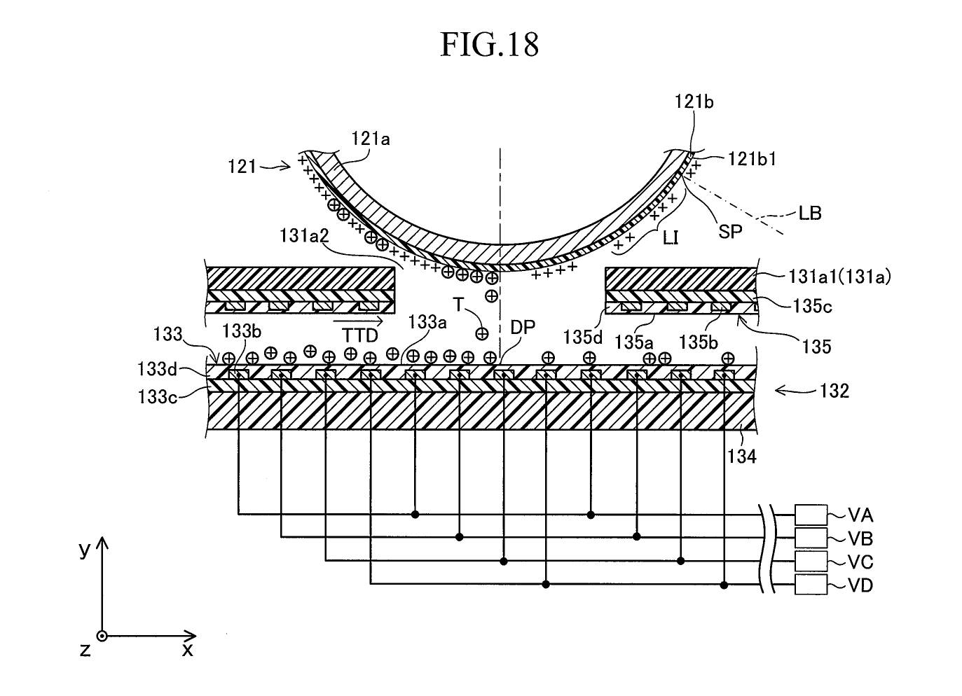

FIG. 18 is an enlarged side sectional view showing a portion of FIG. 17 in the vicinity of the development facing position DP.

Referring to FIG. 18, the transport wiring substrate 133 has a structure similar to that of a flexible printed wiring board.

Specifically, the transport wiring substrate 133 includes a plurality of transport electrodes 133b. These transport electrodes 133b are formed on the surface of a transport-electrode support film 133c. The transport electrodes 133b and the transport-electrode support film 133c are covered with a transport-electrode coating layer 133d.

The transport electrodes 133b are formed of a copper foil having a thickness of about several tens of micrometers. The transport electrodes 133b are formed in a strip-like wiring pattern such that their longitudinal direction becomes parallel with the main scanning direction (orthogonal to the sub-scanning direction).

The plurality of transport electrodes 133b are disposed in parallel with one another. These transport electrodes 133b are arrayed along the sub-scanning direction.

The large number of transport electrodes 133b arrayed along the sub-scanning direction are connected to power supply circuits such that every fourth transport electrodes 133b is connected to the same power supply circuit.

That is, the transport electrode 133b connected to a power supply circuit VA, the transport electrode 133b connected to a power supply circuit VB, the transport electrode 133b connected to a power supply circuit VC, the transport electrode 133b connected to a power supply circuit VD, the transport electrode 133b connected to the power supply circuit VA, the transport electrode 133b connected to the power supply circuit VB, . . . , are sequentially arrayed along the sub-scanning direction.

Referring to FIGS. 17 and 18, these transport electrodes 133b are arranged along the toner main transport surface 133a. That is, the transport electrodes 133b are arranged in the vicinity of the toner main transport surface 133a.

Referring to FIG. 18, the transport-electrode support substrate 133c is a flexible film of an electrically insulative synthetic resin, such as polyimide resin. The transport-electrode coating layer 133d is provided on the surface of the transport-electrode support substrate 133c on which the transport electrodes 133b are formed.

The transport-electrode coating layer 133d is provided to cover the transport-electrode support substrate 133c and the transport electrodes 133b, thereby making the toner main transport surface 133a smooth.

Referring to FIGS. 17 and 18, the toner electric-field transport body 132 includes a transport-substrate support member 134. The transport-substrate support member 134 is provided so as to support the transport wiring substrate 133 from underneath.

Referring to FIG. 17, a rear end portion of the transport-substrate support member 134 is curved downward along the casing top cover 131a of the developing casing 131. Also, a front end portion of the transport-substrate support member 134 is curved downward in a manner similar to that of the rear end portion. A portion of the transport-substrate support member 134 between the above-mentioned front and rear portions assumes the form of a generally flat plate.

That is, the transport-substrate support member 134 is formed in a shape resembling the inverted letter U as viewed from the lateral direction. The transport wiring substrate 133 is supported by the transport-substrate support member 134 in a state in which the transport wiring substrate 133 is bent in a shape resembling the inverted letter U as viewed from the lateral direction.

Referring to FIGS. 17 and 18, the toner electric-field transport body 132 is configured to be able to transport the toner T as follows. Traveling-wave voltages (see FIG. 4) as described above are applied to the plurality of transport electrodes 133b, whereby traveling-wave electric fields are generated on the toner main transport surface 133a, whereby the positively charged toner T can be transported in the toner transport direction TTD.

<<<Counter Wiring Substrate>>>

Referring to FIGS. 16 and 17, as described above, a recess is formed on the inner surface of the casing top cover 131a at a position corresponding to the developing-section counter plate 131a1. The counter wiring substrate 135 is attached to the inner surface of the developing casing 131 such that the counter wiring substrate 135 is fitted into the recess.

That is, the counter wiring substrate 135 is supported by the inner wall surface of the developing-section counter plate 131a1 to face the toner main transport surface 133a with a predetermined gap therebetween.

In the present embodiment, the counter wiring substrate 135 is provided to correspond to substantially the entire surface of the casing bottom plate 131b. That is, the counter wiring substrate 135 is provided such that it extends between the highest position of the casing bottom plate 131b (the position at which the lower end of the semi-cylindrical portion of the developing-section counter plate 131a1 and the casing bottom plate 131b are joined) and the lowest position of the casing bottom plate 131b (an end portion of the casing bottom plate 131b located on the front side in FIG. 17).

As described above, the counter wiring substrate 135 is supported by the inner wall surface of the developing casing 131 in a state in which the counter wiring substrate 135 is curved into a generally U-like shape or a generally V-like shape.

A toner sub-transport surface 135a, which is the inner surface (facing the toner containing space 131e) of the counter wiring substrate 135, is a smooth surface formed into a generally J-like shape or a generally U-like shape as viewed in a side sectional view.

A portion of the toner sub-transport surface 135a which corresponds to the casing bottom plate 131b forms a smooth slope which forms a constant angle (e.g., 30 degrees or less) in relation to a horizontal plane. Further, the toner sub-transport surface 135a is formed parallel to the main scanning direction (the z-direction in FIG. 17).

That is, the portion of the toner sub-transport surface 135a which corresponds to the casing bottom plate 131b forms a slope which ascends from a lower end portion of the casing front closing plate 131d toward a rear end portion of the toner electric-field transport body 132 (an upstream end portion of the toner main transport surface 133a with respect to the toner transport direction TTD).

The counter wiring substrate 135 has a structure similar to that of the above-described transport wiring substrate 133. That is, referring to FIG. 18, the counter wiring substrate 135 includes counter electrodes 135b, a counter-electrode support film 135c, and a counter-electrode coating layer 135d.

The counter electrodes 135b are formed of a copper foil having a thickness of about several tens of micrometers. The counter electrodes 135b are formed on the surface of the counter-electrode support film 135c as a strip-like wiring pattern such that their longitudinal direction becomes parallel with the main scanning direction (orthogonal to the sub-scanning direction).

The plurality of counter electrodes 135b are disposed in parallel with one another. These counter electrodes 135b are arrayed along the sub-scanning direction. Like the above-described transport electrodes 133b, the counter electrodes 135b are connected to power supply circuits such that every fourth counter electrodes 135b is connected to the same power supply circuit.

The plurality of counter electrodes 135b are arranged along the above-described toner sub-transport surface 135a. That is, the counter electrodes 135b are provided along the inner wall surfaces of the developing-section counter plate 131a and the casing bottom plate 131b of the developing casing 131.

The counter-electrode support substrate 135c is a flexible film of an electrically insulative synthetic resin, such as polyimide resin.

The counter electrodes 135b and the surface of the counter-electrode support film 135c on which the counter electrodes 135b are formed are covered with the counter-electrode coating layer 135d.

As a result of the counter-electrode coating layer 135d covering the counter-electrode support substrate 135c and the counter electrodes 135b, the above-described toner sub-transport surface 135a forms a smooth slope which has a constant angle in relation to a horizontal plane.

Like the above-described transport wiring substrate 133, the counter wiring substrate 135 is configured to be able to transport the toner T as follows. Traveling-wave voltages (see FIG. 4) as described above are applied to the plurality of counter electrodes 135b, whereby traveling-wave electric fields are generated on the toner sub transport surface 135a, whereby the positively charged toner T can be transported in the toner transport direction TTD.

<<<Developer Vibrating Section>>>

Referring to FIGS. 16 and 17, the developing apparatus 130 of the present embodiment includes a vibration body 136 and a vibration-body vibrating section 137.

The vibration body 136 and the vibration-body vibrating section 137, which constitute the developer vibrating section of the present invention, are provided near the casing bottom plate 131b.

The vibration body 136 is disposed in the toner containing space 131e within the developing casing 131. This vibration body 136 is provided such that it corresponds to substantially the entirety of the toner containing space 131e with respect to the paper width direction.

In the present embodiment, the vibration body 136 is supported by the paired casing side plates 131c such that the vibration body 136 can oscillate at least in the paper width direction. At least one end portion of the vibration body 136 with respect to the paper width direction projects outward from the developing casing 131 via the casing through hole 131c1 such that the end portion faces the vibration-body vibrating section 137.

The vibration-body vibrating section 137 is provided on the body frame 111. Further, the vibration-body vibrating section 137 is disposed at such a position that, when the development apparatus 130 is attached to the body portion 110 (the body frame 111), the vibration-body vibrating section 137 is located at a position outside the developing casing 131 and corresponding to the vibration body 136 (the vibration-body vibrating section 137 faces the vibration body 136 via the developing casing 131). This vibration-body vibrating section 137 is configured such that it can vibrate the vibration body 136 from the outside of the developing casing 131.

As described above, the vibration body 136 and the vibration-body vibrating section 137, which constitute the developer vibrating section of the present invention, are configured and disposed such that the vibration-body vibrating section 137 can vibrate the toner pool TP (the toner T stored at the bottom portion of the toner containing space 131e within the developing casing 131) substantially from the outside of the developing casing 131, by vibrating the vibration body 136 from the outside of the developing casing 131.

### EXAMPLE 1

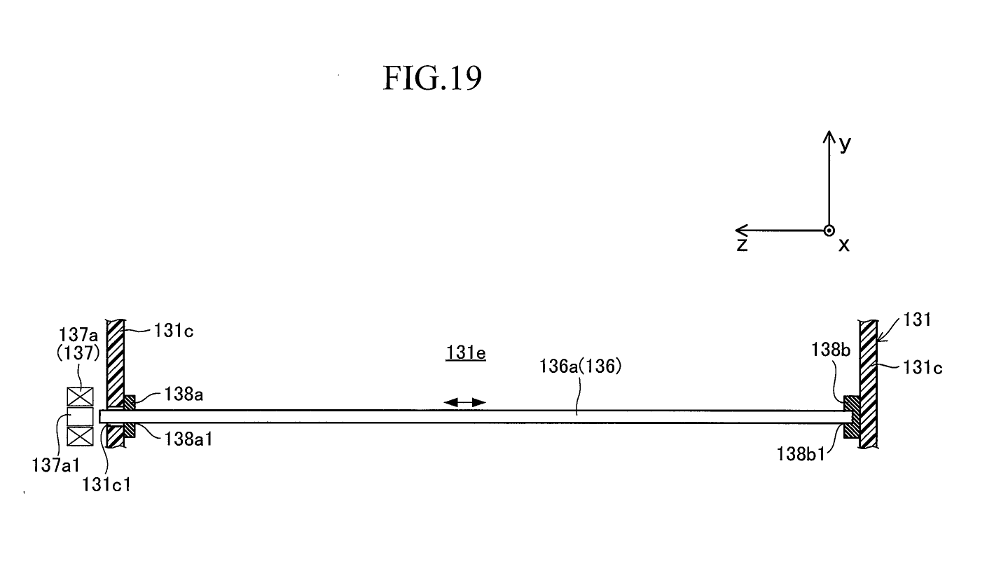

FIG. 19 is a sectional view, as viewed from the front side, showing the configuration of one example of the vibration body 136 and the vibration-body vibrating section 137 shown in FIG. 17.

Referring to FIGS. 17 and 19, a vibration rod 136a, which serves as the vibration body 136 of the present example, is a rod-like member formed of a magnetic material, and is disposed to extend along the paper width direction (the z-axis direction in these drawings). The vibration rod 136a is disposed such that it is separated from the toner sub-transport surface 135a and faces the toner sub-transport surface 135a.

In the present example, the casing through hole 131c1 is formed only one casing side plate 131c. The vibration rod 136a has a diameter slightly smaller than the diameter of the casing through hole 131c1. One end portion of the vibration rod 136a with respect to the paper width direction is exposed to the outside of the developing casing 131 via the casing through hole 131c1.

A coil 137a, which serves as the vibration-body vibrating section 137, is disposed such that an iron core 137a1 at the center thereof is in close proximity to (faces) the one end portion of the vibration rod 136a with a predetermined gap formed therebetween. This coil 137a is configured such that it vibrates the vibration rod 136a when electricity is supplied to the coil 137a from an AC power supply.

That is, the coil 137a is magnetically coupled with the vibration rod 136a at the end portion of the vibration rod 136a with respect to the paper width direction (the main scanning direction).

An elastic seal 138a, which serves as the elastic member of the present invention, is bonded to the inner surface of the above-described one casing side plate 131c (the surface facing the toner containing space 131e). The elastic seal 138a is provided at a position corresponding to the casing through hole 131c1.

The elastic seal 138a is a disk-shaped member formed of a synthetic rubber. A seal through hole 138a1 is provided at an approximately central portion of the elastic seal 138a.

The elastic seal 138a is disposed such that the center axis of the casing through hole 131c1 extending in the paper width direction (the z-axis direction in FIG. 19) and the center axis of the seal through hole 138a1 extending in the paper width direction generally coincide with each other.

The one end portion of the vibration rod 136a is inserted into the seal through hole 138a1. The seal through hole 138a1 is slightly smaller in diameter than the vibration rod 136a. That is, the wall surface of the seal through hole 138a1 is in close contact with the outer circumferential surface of the one end portion of the vibration rod 136a.

As described above, the elastic seal 138a is configured such that it can suppress leakage of the toner T through the seal through hole 138a1, while supporting the one end portion of the vibration rod 136a in an oscillatable manner.

An elastic damper 138b, which serves as the elastic member of the present invention, is bonded to the inner surface of the other casing side plate 131c (in which the casing through hole 131c1 is not provided).

The elastic damper 138b is a disk-shaped member formed of a synthetic rubber. A depression 138b1 is provided at an approximately central portion of the elastic damper 138b.

The depression 138b1 is slightly smaller in diameter than the other end portion of the vibration rod 136a, opposite the one end portion thereof. The other end portion of the vibration rod 136a is inserted into to the depression 138b1. Thus, the other end portion is supported by the elastic damper 138b in an oscillatable manner.

As described above, the vibration rod 136a is oscillatably supported by the paired casing side plates 131c via the elastic seal 138a and the elastic damper 138b.

<<Transfer Section>>

Referring again to FIG. 16, a transfer section 140 is provided in such a manner as to face the image carrying surface 121b1 at a position located downstream, with respect to the direction of rotation of the photoconductor drum 121, of the position where the photoconductor drum 121 and the developing apparatus 130 face each other.

The transfer section 140 includes a rotary center shaft 141, which is a roller-like member and is made of a metal, and a semiconductive rubber layer 142, which is circumferentially provided on the rotary center shaft 141. The rotary center shaft 141 is disposed in parallel with the main scanning direction (the z-axis direction in FIG. 16). A high-voltage power supply is connected to the rotary center shaft 141. The semiconductive rubber layer 142 is formed of a synthetic rubber containing carbon black or the like kneadingly mixed thereinto such that the rubber layer exhibits semiconductivity.

The transfer section 140 is configured to be able to transfer the toner T from the image carrying surface 121b1 to the paper P by means of being rotatably driven counterclockwise while a predetermined transfer voltage is applied between the transfer section 140 and the drum body 121a of the photoconductor drum 121.

<<Paper Feed Cassette>>

A paper feed cassette 150 is disposed under the developing apparatus 130. A paper feed cassette case 151 is a box-like member used to form the casing of the paper feed cassette 150 and opens upward. The paper feed cassette case 151 is configured to be able to contain a large number of sheets of the paper P of up to size A4 (210 mm width×297 mm length) in a stacked state.

A paper-pressing plate 153 is disposed within the paper feed cassette case 151. The paper-pressing plate 153 is supported by the paper feed cassette case 151 in such a manner as to pivotally move on a pivot at its front end portion, so that its rear end can move vertically in FIG. 1. An unillustrated spring urges the rear end portion of the paper-pressing plate 153 upward.

<<Paper Transport Section>>.

A paper transport section 160 is housed within the body casing 112.

The paper transport section 160 is configured to be able to feed the paper P to a transfer position TRP where the transfer section 140 and the image carrying surface 121b1 face each other with a smallest gap therebetween. The paper transport section 160 includes a paper feed roller 161, a paper guide 163, and paper transport guide rollers 165.

The paper feed roller 161 includes a rotary center shaft parallel to the main scanning direction and a rubber layer, which is circumferentially provided on the rotary center shaft. The paper feed roller 161 is disposed in such a manner as to face a leading end portion, with respect to the paper transport direction, of the paper P stacked on the paper-pressing plate 153 housed within the paper feed cassette case 151. The paper guide 163 and the paper transport guide rollers 165 are configured to be able to guide to the transfer position TRP the paper P which has been delivered by the paper feed roller 161.

<<Fixing Section>>

A fixing section 170 is housed within the body casing 112. The fixing section 170 is disposed downstream of the transfer position TRP with respect to the paper transport direction.

The fixing section 170 is configured to apply pressure and heat to the paper P which has passed the transfer position TRP and bears an image in the toner T, thereby fixing the image in the toner T on the paper P. The fixing section 170 includes a heating roller 172 and a pressure roller 173.

The heating roller 172 includes a cylinder which is made of a metal and whose surface is exfoliation-treated, and a halogen lamp which is housed within the cylinder. The pressure roller 173 includes a rotary center shaft which is made of a metal, and a silicone rubber layer which is circumferentially provided on the rotary center shaft. The heating roller 172 and the pressure roller 173 are disposed in such a manner as to press against each other under a predetermined pressure.

The heating roller 172 and the pressure roller 173 are configured and disposed so as to be able to deliver the paper P toward the paper ejection port 112a while applying pressure and heat to the paper P.

<<Control Section>>

A control section 180 is accommodated within the body casing 112. The control section 180 includes a ROM, a CPU, a RAM, a re-writable ROM, and an interface.

The ROM stores various routines executed by the CPU for operation of the laser printer 100, tables, etc. The CPU is configured such that it can read out a routine or the like from the ROM, and execute the routine while storing data in the RAM and the re-writable ROM when necessary.

The CPU is connected via the interface to various sensors and switches provided in the laser printer 100. Further, the CPU is configured to control the operations of various sections, such as the electrostatic-latent-image forming section 120, developing apparatus 130, and the transfer section 140, via the interface.

<Outline of Image Forming Operation of the Laser Printer of the Present Embodiment>

The outline of an image forming operation of the laser printer 100 of the present embodiment (example) having such a configuration will next be described with reference to the drawings. Notably, various operations as described below are performed under the control by the CPU of the control section 180.

<<Paper Feed Operation>>

Referring to FIG. 16, the paper-pressing plate 153 urges the paper P stacked thereon upward toward the paper feed roller 161. This causes the top paper P of a stack of the paper P on the paper-pressing plate 153 to come into contact with the circumferential surface of the paper feed roller 161.

When the paper feed roller 161 is rotatably driven clockwise in FIG. 1, a leading end portion with respect to the paper transport direction of the top paper P is moved toward the paper guide 163. Then, the paper guide 163 and the paper transport guide rollers 165 transport the paper P to the transfer position TRP.

<<Formation of Toner Image on Image Carrying Surface>>

While the paper P is being transported to the transfer position TRP as described above, an image in the toner T is formed as described below on the image carrying surface 121b1, which is the circumferential surface of the photoconductor drum 121.

<<<Formation of Electrostatic Latent Image>>>

First, the charger 123 uniformly charges a portion of the image carrying surface 121b1 of the photoconductor drum 121 to positive polarity.

Referring to FIG. 18, as a result of the clockwise rotation of the photoconductor drum 121, the portion of the image carrying surface 121b1 which has been charged by the charger 123 moves along the sub-scanning direction to the scanning position SP, where the portion of the image carrying surface 121b1 faces (faces straight toward) the scanner unit 122.

At the scanning position SP, the charged portion of the image carrying surface 121b1 is irradiated with the laser beam LB modulated on the basis of image information, while the laser beam LB sweeps along the main scanning direction. Certain positive charges are lost from the charged portion of the image carrying surface 121b1, according to a state of modulation of the laser beam LB. By this procedure, an electrostatic latent image LI in the form of an imagewise distribution of positive charges is formed on the image carrying surface 121b1.

As a result of the clockwise rotation of the photoconductor drum 121 in FIG. 16, the electrostatic latent image LI formed on the image carrying surface 121b1 moves toward the development facing position DP.

<<<Fluidization of Toner>>>

Referring to FIG. 17, the vibration body 136 is vibrated by the vibration-body vibrating section 137.

That is, referring to FIG. 19, in the prevent embodiment, electricity is supplied from the unillustrated AC power supply to the coil 137a. As a result, an alternating magnetic field is generated at the iron core 137a1. By means of the alternating magnetic field, the vibration rod 136a is vibrated.

Referring to FIG. 17, by mean of such vibration of the vibration body 136, the toner pool TP (the toner T stored at the bottom portion of the toner containing space 131e of the developing casing 131) is vibrated. This vibrated toner pool TP is fluidized such that the toner pool TP behaves like a liquid.

<<<Transport of Charged Toner>>

Referring to FIG. 17, predetermined voltages (similar to those shown in FIG. 4) are applied to the counter wiring substrate 135. Thus, predetermined traveling-wave electric fields are formed on the counter wiring substrate 135 (the toner sub-transfer surface 135a).

As a result, the above-described traveling-wave electric fields generated along the toner sub-transfer surface 135a acts on the toner T in a region (a toner transport start area TTA) located at a rear end portion of the sufficiently fluidized toner pool TP and near the toner sub-transfer surface 135a.

Thus, the toner T is transported in the toner transport direction TTD from the toner transport start area TTA such that the toner T moves up along a cylindrical inner surface portion of the toner sub-transfer surface 135a.

Notably, the toner transport start area TTA moves frontward and downward along the toner sub-transfer surface 135a as the highest position of the toner pool TP (a toner pool top surface TPS) lowers as a result of consumption of the toner.

The toner T having moved up along the cylindrical inner surface portion of the toner sub-transfer surface 135a is guided to a position where the counter wiring substrate 135 faces the furthest upstream portion (a left-side lower end portion in FIG. 17) of the transport wiring substrate 133 with respect to the toner transport direction TTD.

The toner T having being guided to a position between the transport wiring substrate 133 and the counter wiring substrate 135 is transported to the development facing position DP by means of the traveling-wave electric fields generated along the toner main transport surface 133a of transport wiring substrate 133 and the toner sub-transport surface 135a of the counter wiring substrate 135.

The toner T having passed through the development facing position DP falls down from a frontmost end portion of the toner main transport surface 133a, so that the toner T returns to the above-described toner pool TP.

<<<Development of Electrostatic Latent Image>>>

Referring to FIG. 18, the positively charged toner T is transported to the development facing position DP as described above.

In the vicinity of the development facing position DP, the toner T adheres to portions of the electrostatic latent image LI on the image carrying surface 121b1 at which positive charges are lost. That is, the electrostatic latent image LI on the image carrying surface 121b1 of the photoconductor drum 121 is developed with the toner T.

Thus, an image in the toner T is carried on the image carrying surface 121b1.

<<Transfer of Toner Image from Image Carrying Surface to Paper>>

Referring to FIG. 16, as a result of clockwise rotation of the image carrying surface 121b1, an image in the toner T which has been carried on the image carrying surface 121b1 of the photoconductor drum 121 as described above is transported toward the transfer position TRP.

At the transfer position TRP, the image in the toner T is transferred from the image carrying surface 121b1 onto the paper P.

<<Fixing and Ejection of Paper>>

The paper P onto which an image in the toner T has been transferred at the transfer position TRP is sent to the fixing section 170 along the paper path PP.

The paper P is nipped between the heating roller 172 and the pressure roller 173, thereby being subjected to pressure and heat. By this procedure, the image in the toner T is fixed on the paper P.

Subsequently, the paper P is sent to the paper ejection port 112a and is then ejected onto the catch tray 114 through the paper ejection port 112a.

<Actions and Effects Achieved by the Configuration of the Embodiment and Example>

According to the configuration of the present embodiment, there are provided the vibration body 136 and the vibration-body vibrating section 137, which serve as the developer vibrating section for vibrating the toner T contained (stored) within the developing casing 131.

By virtue of such a configuration, the toner T stored in the developing casing 131 (the toner pool TP) is fluidized satisfactorily. Stresses, such as aggregation force and shearing force, acting on the toner T at that time are very small.

Therefore, by virtue of such a configuration, the state of supply of the toner T to the toner sub-transport surface 135a and the toner main transport surface 133a can be made uniform satisfactorily. Accordingly, the state of transport of the toner T on the toner sub-transport surface 135a and the toner main transport surface 133a can be made uniform satisfactorily

As described above, the configuration of the present embodiment enables more uniform performance of the transport of the toner T and the supply of the toner T to the development facing position DP by means of the traveling-wave electric fields. Accordingly, generation of density non-uniformity can be suppressed effectively, whereby satisfactory image formation becomes possible.

In the configuration of the present embodiment, the vibration body 136 is disposed within the developing casing 131 of the developing apparatus 130 which can be attached to and detached from the body portion 110. When the developing apparatus 130 is attached to the body portion 110, the vibration body 136 is located at a position corresponding to the vibration-body vibrating section 137. The vibration-body vibrating section 137 vibrates the vibration body 136 from the outside of the developing casing 131.

By virtue of such a configuration, fluidization of the toner T within the developing casing 131 can be performed satisfactorily when the developing apparatus 130, which can be attached to and detached from the body portion 110, is attached to the body portion 110.

In the configuration of the present embodiment, the vibration body 136 is disposed at a bottom portion of the toner containing space 131e, which is the internal space of the developing casing 131.

By virtue of such a configuration, the vibration body 136 is vibrated at the bottom portion of the toner containing space 131e. By means of vibration of the vibration body 136, the toner T at the bottom portion of the toner containing space 131e is vibrated.

As a result, a satisfactory fluidity can be imparted to the toner T stored within the developing casing 131. Thus, fluidization of the toner T stored within the developing casing 131 by the vibration body 136 can be performed more reliably.

In the configuration of the present embodiment, the vibration body 136 is separated from the inner wall surface of the developing casing 131. Further, the vibration body 136 is supported by the developing casing 131 for free oscillating movement. This configuration can suppress direct transmission of vibration from the vibration body 136 to the developing casing 131 and the toner electric-field transport body 132 supported by the developing casing 131.

Therefore, such a configuration can suppress generation of noise to the greatest possible extent, which noise would otherwise be generated as a result of vibration of the developing casing 131 or the toner electric-field transport body 132.

Further, such a configuration can suppress, to the greatest possible extent, change in a predetermined positional relation at the development facing position DP between the image carrying surface 121b1 and the toner main transport surface 133a of the toner electric-field transport body 132 supported by the developing casing 131, which change would otherwise occur due to vibration of the vibration body 136. Therefore, generation of a distortion of a formed image, which distortion would otherwise occur due to a change in the positional relation, can be suppressed to the greatest possible extent.

In the configuration of the present embodiment, the vibration rod 136a is disposed within the toner containing space 131e of the developing casing 131. Further, the the vibration rod 136a is magnetically coupled with the coil 137a disposed outside the developing casing 131 at an end portion of the vibration rod 136a with respect to the sheet width direction (the main scanning direction).

By virtue of such a configuration, through use of a simple apparatus structure, there can be realized a structure for vibrating the vibration rod 136a provided within the toner containing space 131e, which is the inner space of the developing casing 131, from the outside of the developing casing 131 of the developing apparatus 130, which can be attached to and detached from the body portion 110.

In the configuration of the present embodiment, the casing bottom plate 131b is formed in the shape of a flat plate which intersects with a horizontal plane at a constant angle. Further, the toner sub-transport surface 135a is formed as a flat surface which intersects with the horizontal plane at a constant angle.

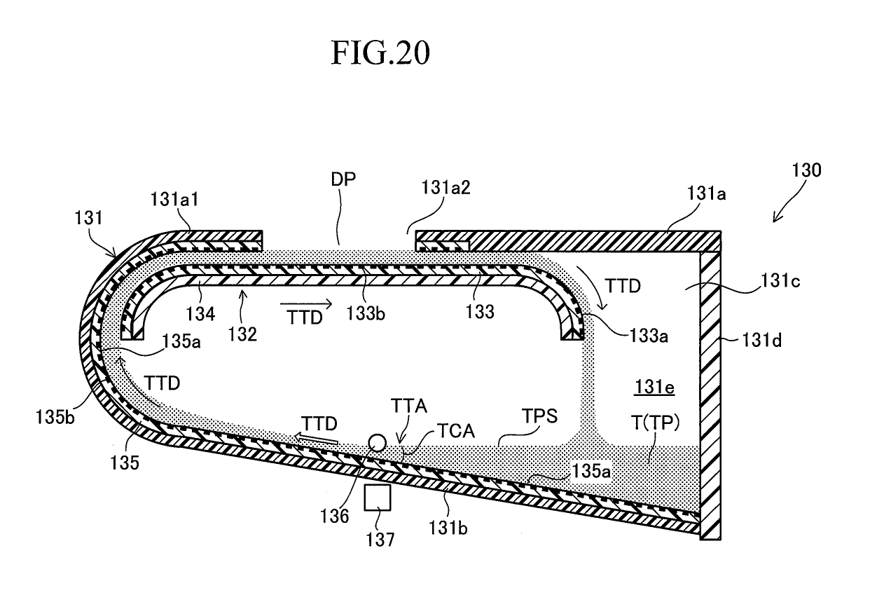

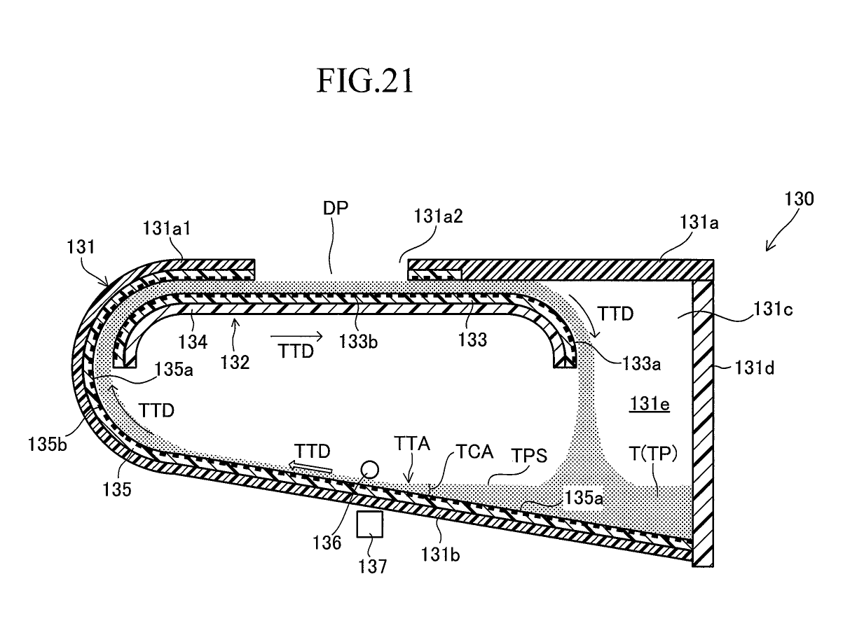

FIG. 20 is a side sectional view of the development apparatus 130 shown in FIG. 17 showing a state in which the storage amount of the toner T within the developing casing 131 (the amount of toner pool TP) has decreased. FIG. 21 is a side sectional view of the development apparatus 130 shown in FIG. 17 showing a state in which the toner storage amount has decreased further, as compared with the state shown in FIG. 20.

As shown in FIGS. 20 and 21, the above-described toner pool top surface TPS gradually lowers as the storage amount of the toner T within the developing casing 131 decreases.

In such a case, according to the configuration of the present embodiment, the angle (toner contact angle TCA) between the toner pool top surface TPS and the toner sub-transport surface 135a in the toner transport start area TTA becomes substantially constant.

Referring to FIGS. 20 and 21, in the present embodiment, even when the storage amount of the toner T decreases (in particular, even when the storage amount of the toner T within the developing casing 131 decreases), the toner contact angle TCA becomes substantially constant.

Thus, in the present embodiment, the state of transport of the toner T from the toner transport start area TTA toward the downstream side with respect to the toner transport direction TTD becomes substantially constant. That is, the transport state of the toner T is stabilized.

Therefore, the configuration of the present embodiment can effectively suppress generation of a transport failure of the toner T (e.g., an extreme decrease in the transport amount), which failure would otherwise occur when the storage amount of the toner T within the developing casing 131 (the storage amount of the toner T at the bottom portion of the toner containing space 131e) decreases.

In the configuration of the present embodiment, the casing bottom plate 131b is formed in the shape of a flat plate which intersects with a horizontal plane at a small angle (30 degrees or less). Further, the toner sub-transport surface 135a is formed as a flat surface which intersects with the horizontal plane at a small angle (30 degrees or less).

By virtue of such a configuration, the greater part portion of the toner T in the toner transport start area TTA receives the action of the traveling-wave electric fields on the toner sub-transport surface 135a (in particular, when the storage amount of the toner T within the developing casing 131 decreases).

Therefore, (even in a case as described above), the supply of the toner T from the toner transport start area TTA to a portion of the toner sub-transport surface 135a located at the downstream side with respect to the toner transport direction TTD can be performed satisfactorily.

Further, the size of the developing casing 131 in the height direction decreases. Thus, the thickness of the developing apparatus 130 can be reduced. Therefore, a further reduction in the size of the laser printer 100 becomes possible.

<Modifications>

(1) No particular limitation is imposed on the configurations of the toner electric-field transport body 132, the transport wiring substrate 133, and the counter wiring substrate 135 in the above-described embodiment.

For example, the transport electrodes 133b can be embedded in the transport-electrode support substrate 133c so as not to project from the surface of the transport-electrode support substrate 133c. The transport-electrode coating layer 133d can be omitted.

Alternatively, the transport electrodes 133b can be formed directly on the transport-substrate support member 134. In this case, the transport electrodes 133b can be embedded in the transport-electrode support member 134 so as not to project from the upper surface of the transport-electrode support member 134. Further, in this case, the toner main transport surface 133a is formed by the upper surface of the transport-electrode support member 134.

The counter electrodes 135b can also be, for example, embedded in the counter-electrode support substrate 135c so as not to project from the surface of the counter-electrode support substrate 135c. The counter-electrode coating layer 135d can be omitted.

Alternatively, the counter electrodes 135b can be formed directly on the inner wall surface of the casing bottom plate 131b. In this case, the counter electrodes 135b can be embedded in the casing bottom plate 131b so as not to project from the inner wall surface of the casing bottom plate 131b. Further, in this case, the toner sub-transport surface 135a is formed by the inner wall surface of the casing bottom plate 131b.

The longitudinal direction of the transport electrodes 133b and that of the counter electrodes 135b may be in parallel with the main scanning direction as in the case of the above-described embodiment or may intersect with the main scanning direction.

The direction of arraying the transport electrodes 133b and that of arraying the counter electrodes 135b may be in parallel with the sub-scanning direction as viewed in plane as in the case of the above-described embodiment or may intersect with the sub-scanning direction as viewed in plane.

No particular limitation is imposed on the transport electrodes 133b and the counter electrodes 135b with respect to shape and the configuration of electrical connections. For example, in place of the form of a straight line as in the case of the above-described embodiment, the transport electrodes 133b and the counter electrodes 135b can assume various other forms, such as V-shaped, arc, waves, and serrated.

The pattern of connecting the electrodes is not limited to that of connecting every fourth electrode as in the case of the above-described embodiment. For example, every other electrode or every third electrode may be connected. In this case, the corresponding power circuits are not of four kinds, but can be modified as appropriate such that the phase shift of voltage waveforms is 180°, 120°, etc. Furthermore, the voltage waveform can be rectangular waves, sine waves, and waves of various other shapes.

(2) The arrangement and configuration of the vibration-body vibrating section 137, which constitutes the developer vibrating section of the present invention, are not limited to those of the above-described embodiment and examples.

The vibration-body vibrating section 137 may have any configuration so long as the vibration-body vibrating section 137 can vibrate the vibration body 136 in at least one direction selected from the paper width direction, the height direction, and the front-rear direction.

For example, the vibration-body vibrating section 137 may be configured to vibrate the vibration body 136 in at least two directions selected from the paper width direction, the height direction, and the front-rear direction (or in all three directions) simultaneously.

Further, in the above-described example, the vibration-body vibrating section 137 assumes the form of the coil 137a. However, the vibration-body vibrating section 137 may configured as follows.

### EXAMPLE 2

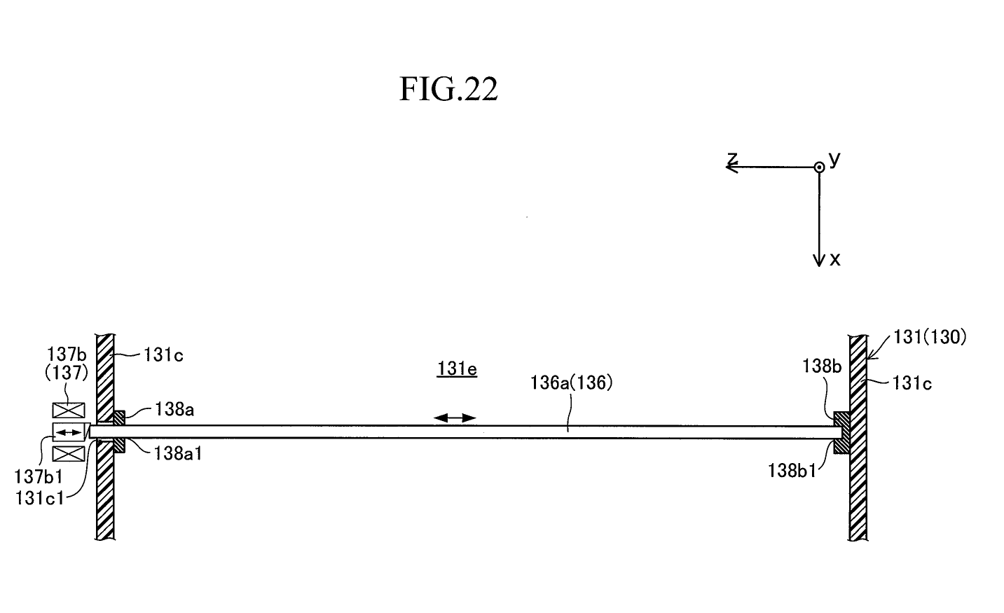

FIG. 22 is a sectional view, as viewed from the upper side, showing one modification of the vibration-body vibrating section 137 shown in FIG. 19.

Referring to FIG. 22, a solenoid 137b, which serves as the vibration-body vibrating section 137, includes an actuator 137b1. This actuator 137b1 vibrates in the paper width direction when electricity is supplied to the solenoid 137b from an AC power supply.

Further, an inclined surface is formed on an end portion of the actuator 137b1 on the inner side with respect to the paper width direction (an end portion which faces the above-described one end portion of the vibration rod 136a) such that the inclined surface projects inward toward the rearward direction (the direction opposite the x-direction in FIG. 22), which is the insertion direction of the developing apparatus 130.

In the present modification, when the developing apparatus 130 is inserted into the body portion 110 (see FIG. 16) and is placed at a predetermined position, the above-described one end portion of the vibration rod 136a comes into engagement with (abuts against) the inclined surface at the above-described end portion of the actuator 137b1.

According to the above-described configuration, when the developing apparatus 130 is placed at the predetermined position within the body portion 110 (see FIG. 16). the above-described one end portion of the vibration rod 136a comes into engagement with (abuts against) the inclined surface at the above-described end portion of the actuator 137b1.

When electricity is supplied to the solenoid 137b in this state, the actuator 137b1 vibrates. The vibration of the actuator 137b1 is transmitted directly to the vibration rod 136a, so that the vibration rod 136a is vibrated. At that time, the vibration rod 136a is elastically supported by the elastic seal 138a and the elastic damper 138b. Therefore, direct transmission of vibration of the vibration rod 136a to the developing casing 131 can be suppressed to the greatest possible extent.

### EXAMPLE 3

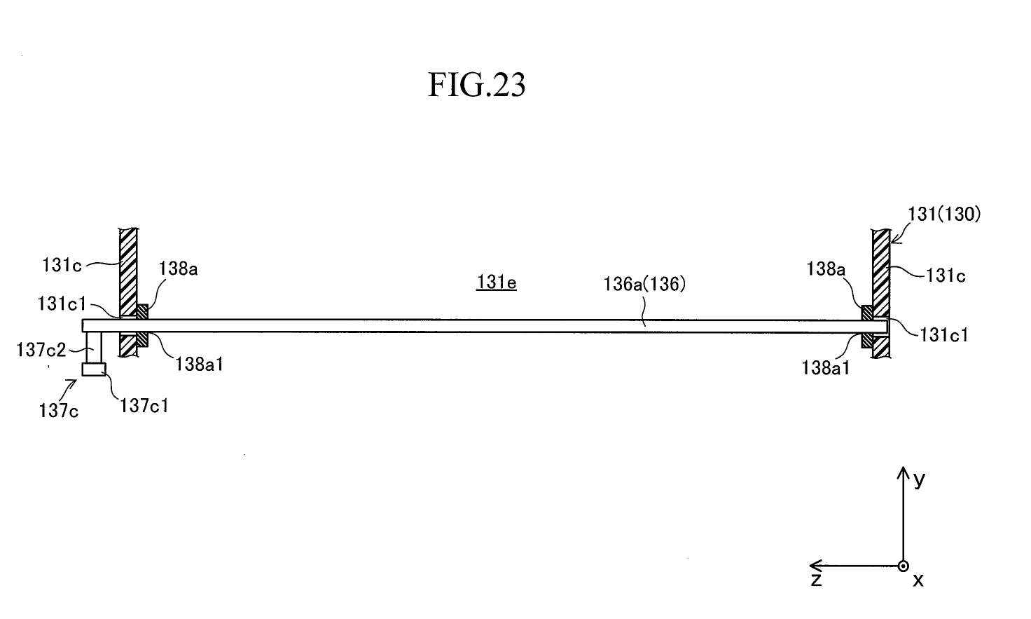

FIG. 23 is a sectional view, as viewed from the front side, showing another modification of the vibration-body vibrating section 137 shown in FIG. 19.

Referring to FIG. 23, in the present modification, casing through holes 131c1 are provided for both the paired casing side plates 131c. Paired elastic seals 138a are provided for these casing through holes 131c1. The elastic seals 138a have the same configuration as in the above-described example.

Such a configuration can also suppress leakage of the toner T (see FIG. 17) through the casing through holes 131c1 to the greatest possible extent, and elastically support the vibration rod 136a in an oscillatable manner.

### EXAMPLE 4

Referring to FIG. 23, as in the case of the above-described Example 3, the vibration rod 136a is elastically supported at opposite ends thereof by the paired elastic seals 138a such that the vibration rod 136a can oscillate.

In the present modification, the vibration rod 136a is a rod-like member formed of a metal. Further, a rod vibrating section 137c, which serves as the vibration-body vibrating section 137 of the present modification, includes a piezoelectric element 137c1 and a vibration transmission section 137c2.

The piezoelectric element 137c1 is configured such that it generates vibration when electricity is supplied thereto. The vibration transmission section 137c2 is a rod-like member formed of a metal, and is disposed such that it comes into contact with the vibration body 136 and the piezoelectric element 137c1.

This vibration transmission section 137c2 is configured so as to transmit the vibration generated by the piezoelectric element 137c1 to one end portion of the vibration body 136. That is, in the present modification, when the developing apparatus 130 is inserted into the body portion 110 (see FIG. 16) and is placed at a predetermined position, the above-described one end portion of the vibration rod 136a comes into engagement with (abuts against) an upper end portion of the vibration transmission section 137c2.

In such a configuration, a predetermined (AC) voltage is supplied from an unillustrated power supply unit to the piezoelectric element 137c1. As a result, the piezoelectric element 137c1 vibrates. The vibration of the piezoelectric element 137c1 is transmitted to the vibration rod 136a via the vibration transmission section 137c2. Thus, the vibration rod 136a vibrates within the developing casing 131 while being supported by the paired elastic seals 138a.

According to such a modification, through use of a simple apparatus structure, there can be realized the structure for vibrating the vibration rod 136a provided within the toner containing space 131e, which is the inner space of the developing casing 131, from the outside of the developing casing 131 of the developing apparatus 130, which can be attached to and detached from the body portion 110 (see FIG. 16).

(3) The arrangement and configuration of the vibration body 136, which constitutes the developer vibrating section of the present invention, are not limited to these of the above-described embodiment and examples.

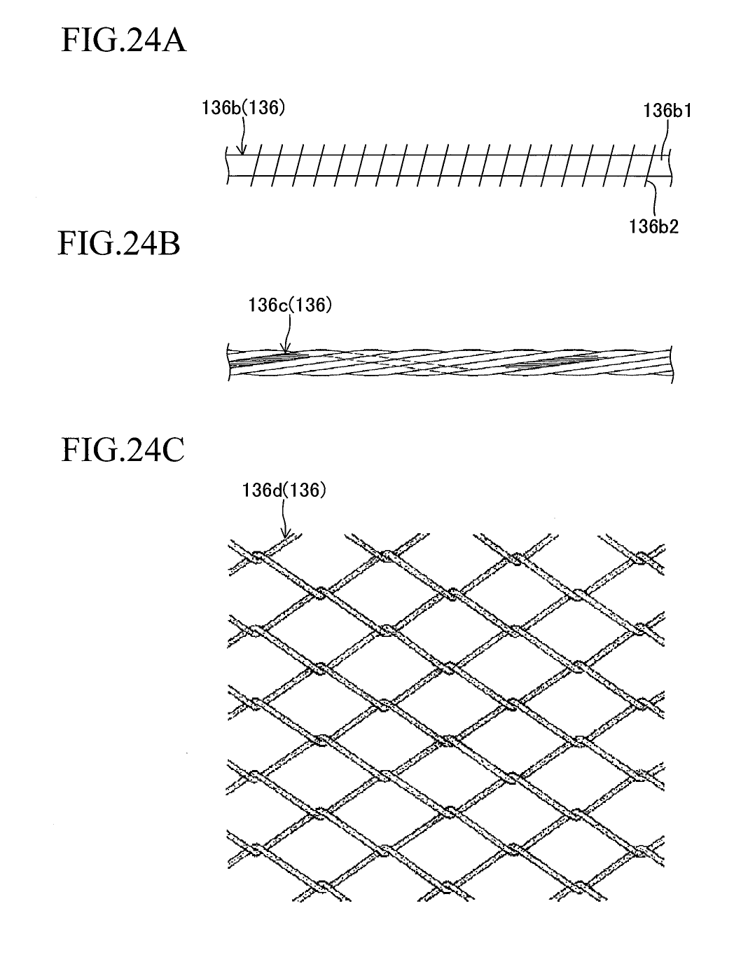

FIGS. 24A to 24C are enlarged fragmental plan views showing the configurations of modifications of the vibration body 136 of the example shown in FIG. 19.

For example, as shown in FIG. 24A, a vibration rod 136b, which serves as the vibration body 136 of the modification, includes a bar-shaped rod body 136b1 and a (plurality of) projecting blades 136b2 provided on the rod body 136b1.

By virtue of the vibration rod 136b having such a configuration, the toner T (see FIG. 17) at the bottom portion of the toner containing space 131e (see FIG. 17) can be more effectively fluidized by means of vibration of the vibration rod 136b along the longitudinal direction (the paper width direction).

Further, as shown in FIG. 24B, a vibration wire 136c, which serves as the vibration body 136 of the modification, is formed by twining a plurality of (e.g., six) thin wires.

Fine projections and depressions are formed on the surface of the vibration wire 136c. The toner T (see FIG. 17) at the bottom portion of the toner containing space 131e (see FIG. 17) can be more effectively fluidized by means of the fine projections and depressions.

Further, as shown in FIG. 24C, a vibration mesh 136d, which serves as the vibration body 136 of the modification, is formed by a plurality of thin wires.

By virtue of the vibration mesh 136d having such a configuration, the toner T (see FIG. 17) at the bottom portion of the toner containing space 131e (see FIG. 17) can be more effectively fluidized by means of vibration of the vibration mesh 136d.

(4) A plurality of sets each including the vibration body 136 and the vibration-body vibrating section 137, which constitute the developer vibrating section of the present invention, may be provided.

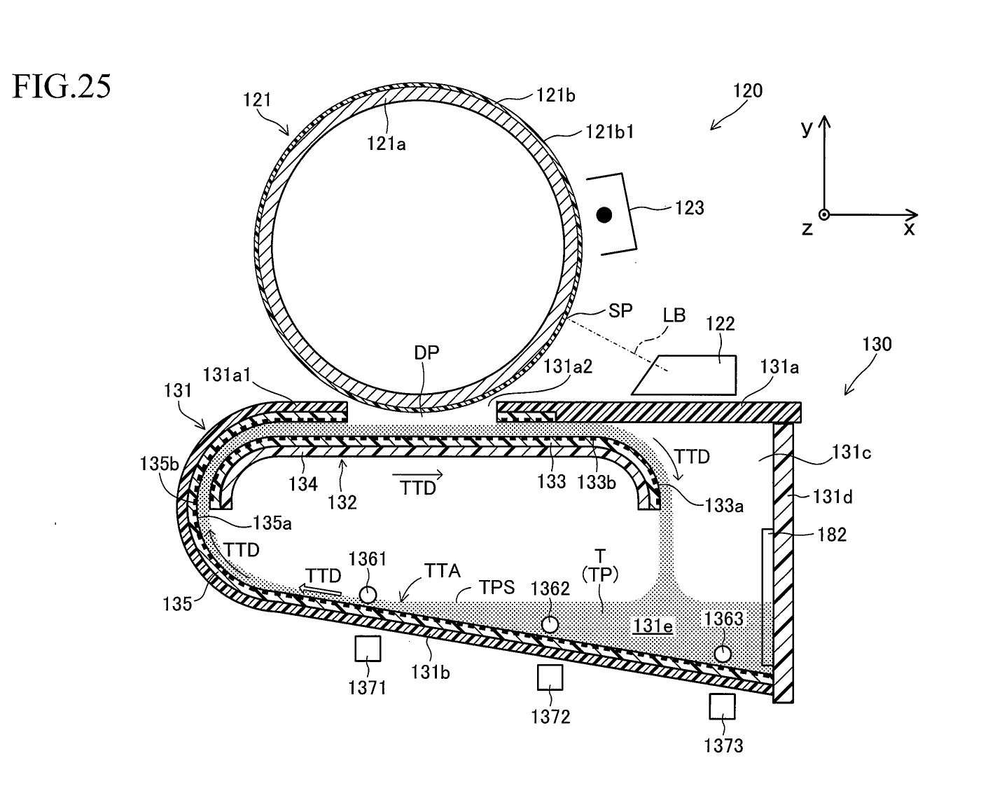

FIG. 25 is a side sectional view showing the configuration of one modification of the laser printer 100 shown in FIG. 16.

As shown in FIG. 25, a downstream vibration body 1361, an intermediate vibration body 1362, and an upstream vibration body 1363 are provided within the developing casing 131 (the toner containing space 131e).

The downstream vibration body 1361 is provided downstream of the center of the toner sub-transport surface 135a with respect to the toner transport direction TTD. The upstream vibration body 1363 is provided upstream of the center of the toner sub-transport surface 135a with respect to the toner transport direction TTD. The intermediate vibration body 1362 is provided between the downstream vibration body 1361 and the upstream vibration body 1363.

Outside the developing casing 131 (the toner containing space 131e), a downstream-vibration-body vibration section 1371 is provided such that the downstream-vibration-body vibration section 1371 corresponds to the downstream vibration body 1361. Further, an intermediate-vibration-body vibration section 1372 is provided such that the intermediate-vibration-body vibration section 1372 corresponds to the intermediate vibration body 1362. Moreover, an upstream-vibration-body vibration section 1373 is provided such that the upstream-vibration-body vibration section 1373 corresponds to the upstream vibration body 1363.

Notably, the intermediate vibration body 1362 may be omitted. Alternatively, the intermediate body 1362 may be provided at a plurality of locations. Moreover, the downstream-vibration-body vibration section 1371 to the upstream-vibration-body vibration section 1373 may be integrated.

(5) The developer vibrating section of the present invention may be configured such that it can vibrate the entire toner pool TP even when the storage amount of the toner T within the developing casing 131 (the amount of the toner pool TP) decreases. Alternatively, the developer vibrating section of the present invention is preferably configured such that it can vibrate at least the toner within the toner transport start area TTA.

For example, referring to FIG. 25, a toner amount sensor 182 may be provided within the developing casing 131 (the toner containing space 131e).

The toner amount sensor 182 is configured to output a signal corresponding to the position of the toner pool top surface TPS; i.e., the amount of the toner T within the toner containing space 131e. This toner amount sensor 182 is electrically connected to the control section 180.

In such a configuration, the states of vibrations of the plurality of vibration bodies (the downstream vibration body 1361, etc.) are controlled by the control section 180 in accordance with the position of the toner pool top surface TPS.

For example, when the position of the toner pool top surface TPS is high, all the downstream vibration body 1361 to the upstream vibration body 1363 are vibrated. When the position of the toner pool top surface TPS becomes lower than the downstream vibration body 1361, the intermediate vibration body 1362 and the upstream vibration body 1363 are vibrated. When the position of the toner pool top surface TPS becomes lower than the intermediate vibration body 1362, the upstream vibration body 1363 is vibrated.

Alternatively, for example, when the position of the toner pool top surface TPS is high, only the downstream vibration body 1361 is vibrated. When the position of the toner pool top surface TPS becomes lower than the downstream vibration body 1361, only the intermediate vibration body 1362 vibrated. When the position of the toner pool top surface TPS becomes lower than the intermediate vibration body 1362, only the upstream vibration body 1363 is vibrated.

(6) In place of the above-described configuration including the vibration body 136, there may be used a configuration in which a wall-like or plate-like member surrounding the toner containing space 131e (facing the toner containing space 131e) is vibrated.

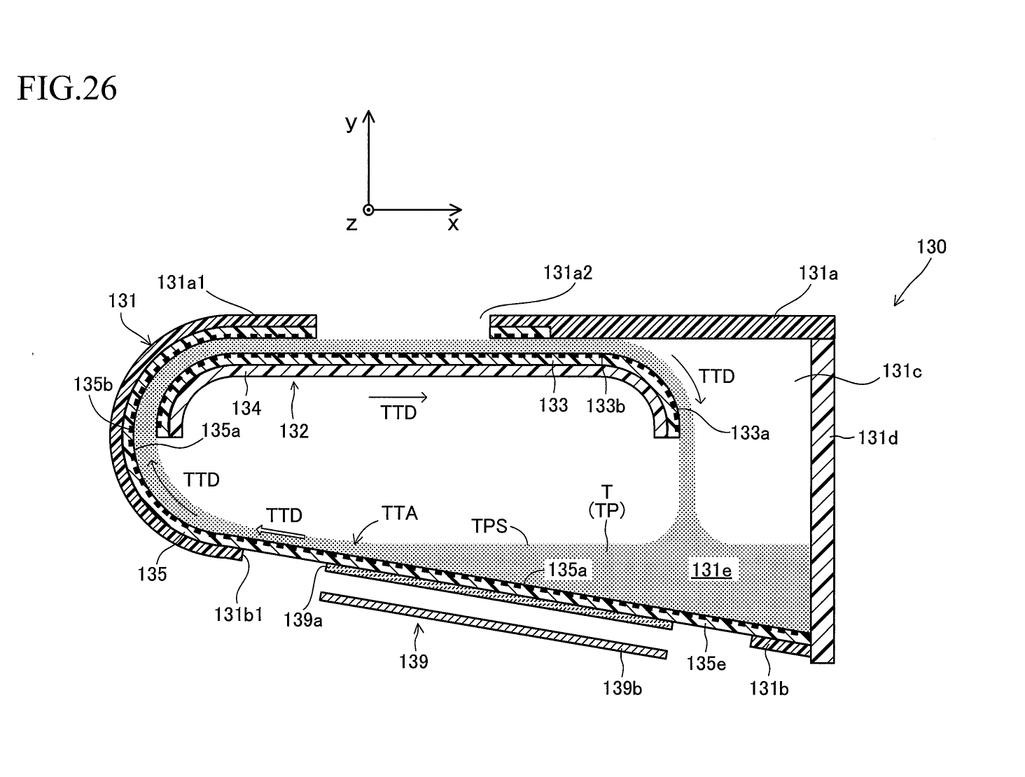

FIG. 26 is a side sectional view showing the configuration of one modification of the developing apparatus 130 shown in FIG. 17.

Referring to FIG. 26, a bottom plate opening portion 131b1 is provided at the center of the casing bottom plate 131b. The bottom plate opening portion 131b1 is formed as a through hole that penetrates the casing bottom plate 131b. The bottom plate opening portion 131b1 may be formed to assume a generally rectangular shape or an (elliptical) circular shape.

A portion of the counter wiring substrate 135 corresponding to the bottom plate opening portion 131b1 forms a diaphragm section 135e, which constitutes the developer vibrating section of the present invention. The edge portion of the diaphragm section 135e is supported by the casing bottom plate 131b. The diaphragm section 135e is configured to vibrate in the thickness direction of the counter wiring substrate 135 with the above-described edge portion serving as a fixed end.

A diaphragm vibrating section 139, which constitutes the developer vibrating section of the present invention, is provided to face the outer surface of the diaphragm section 135e (the surface opposite the surface facing the toner containing space 131e).

The diaphragm vibrating section 139 shown in FIG. 26 includes a polarized film 139a and a polarized-film drive electrode plate 139b.

The polarized film 139a is a ferroelectric film polarized in the thickness direction and formed into the form of a flat plate. This polarized film 139a is fixed to the outer surface of the diaphragm section 135e.

The polarized-film drive electrode plate 139b is a thin plate formed of a metal. This polarized-film drive electrode plate 139b is provided to face the polarized film 139a with a predetermined narrow gap therebetween. Further, the polarized-film drive electrode plate 139b is disposed parallel to the polarized film 139a. Moreover, the polarized-film drive electrode plate 139b is electrically connected to output terminals of an unillustrated AC power supply.

In such a configuration, the potential of the polarized-film drive electrode plate 139b and the electric field in the vicinity of the polarized-film drive electrode plate 139b change in accordance with the output from the AC power supply. Due to this change in the electric field, the polarized film 139a is vibrated in the thickness direction thereof.

As a result, the diaphragm section 135e is vibrated in the thickness direction thereof. By means of the vibration of the diaphragm section 135e, the toner T within the toner containing space 131e is fluidized satisfactorily.

As shown in FIG. 26, preferably, the diaphragm section 135e is formed over substantially the entirety of the casing bottom plate 131b. By virtue of this configuration, the entire toner pool TP can be vibrated satisfactorily. As a result, the toner T in the toner transport start area TTA is fluidized satisfactorily.

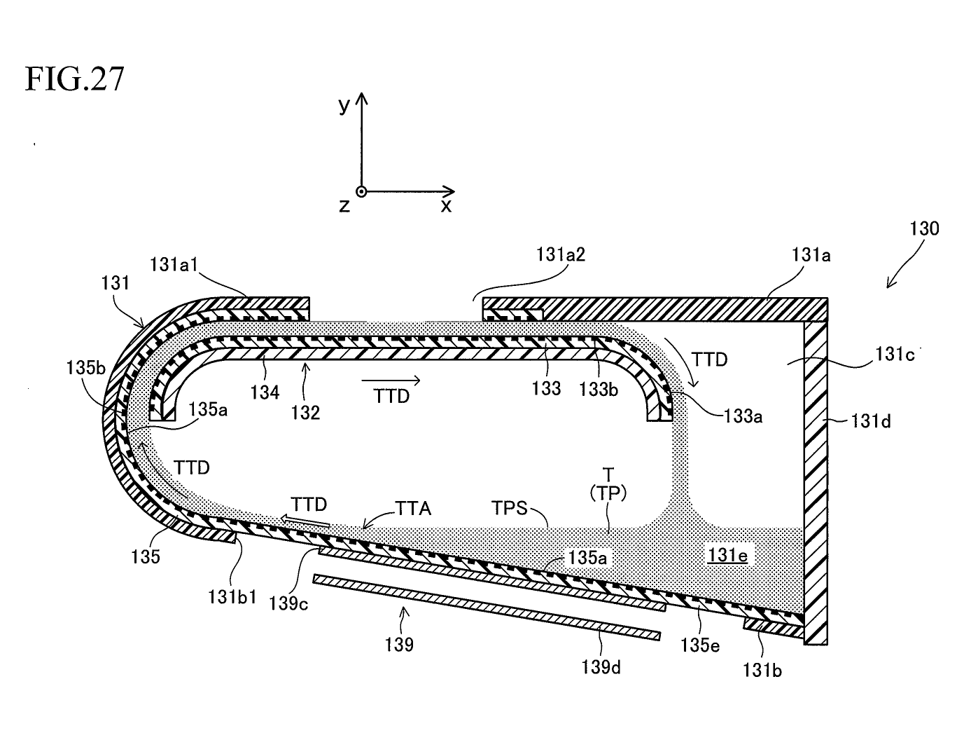

FIG. 27 is a side sectional view showing the configuration of another modification of the developing apparatus 130 shown in FIG. 17 (a modification of the developing apparatus 130 shown in FIG. 26).

Referring to FIG. 27, the diaphragm vibrating section 139 of the present modification includes a diaphragm-side electrode plate 139c and a diaphragm counter electrode plate 139d.

The diaphragm-side electrode plate 139c is formed from a flat-plate like member made of a metal. This diaphragm-side electrode plate 139c is fixed to the outer surface of the diaphragm section 135e.

The diaphragm counter electrode plate 139d is formed from a flat-plate like member made of a metal. This diaphragm counter electrode plate 139d is provided to face the diaphragm-side electrode plate 139c with a predetermined narrow gap therebetween. Further, the polarized-film drive electrode plate 139b is disposed parallel to the diaphragm-side electrode plate 139c.

The diaphragm-side electrode plate 139c and the diaphragm counter electrode plate 139d are respectively connected to output terminals of an unillustrated AC power supply. That is, an AC voltage can be applied between the diaphragm-side electrode plate 139c and the diaphragm counter electrode plate 139d.

In such a configuration, the force (attraction forth or repulsive force) generated between the diaphragm-side electrode plate 139c and the diaphragm counter electrode plate 139d changes in accordance with the output from the AC power supply. As a result, the diaphragm section 135e is vibrated in the thickness direction thereof. By means of the vibration of the diaphragm section 135e, the toner T within the toner pool TP (the toner transport start area TTA) can be fluidized satisfactorily.

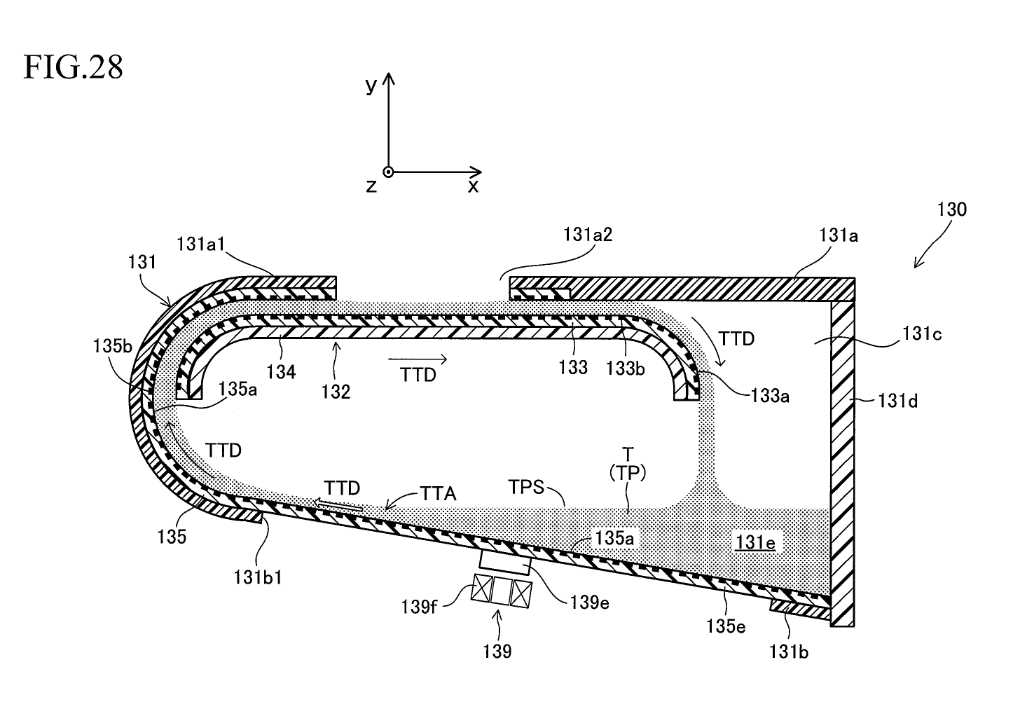

FIG. 28 is a side sectional view showing the configuration of another modification of the developing apparatus 130 shown in FIG. 17.

Referring to FIG. 28, the diaphragm vibrating section 139 of the present modification includes a diaphragm-side actuator 139e and a coil 139f.

The diaphragm-side actuator 139e is formed of a block-shaped or a plate-shaped magnetic body. This diaphragm-side actuator 139e is fixed to the outer surface of the diaphragm section 135e.

The coil 139f is provided to face the diaphragm-side actuator 139e with a predetermined narrow gap therebetween. This coil 139f is configured such that it can vibrate the diaphragm-side actuator 139e in the thickness direction of the diaphragm section 135e when electricity is supplied thereto by an AC power supply. That is, the coil 139f is magnetically coupled with the diaphragm-side actuator 139e.

In such a configuration, electricity is supplied to the coil 139f by the unillustrated AC power supply. As a result, the coil 139f generates an alternating magnetic field. Due to this alternating magnetic field, the diaphragm-side actuator 139e vibrates.

The vibration of the diaphragm-side actuator 139e causes the diaphragm section 135e to vibrate in the thickness direction thereof. By means of the vibration of the diaphragm section 135e, the toner T within the toner pool TP (the toner transport start area TTA) can be fluidized satisfactorily.

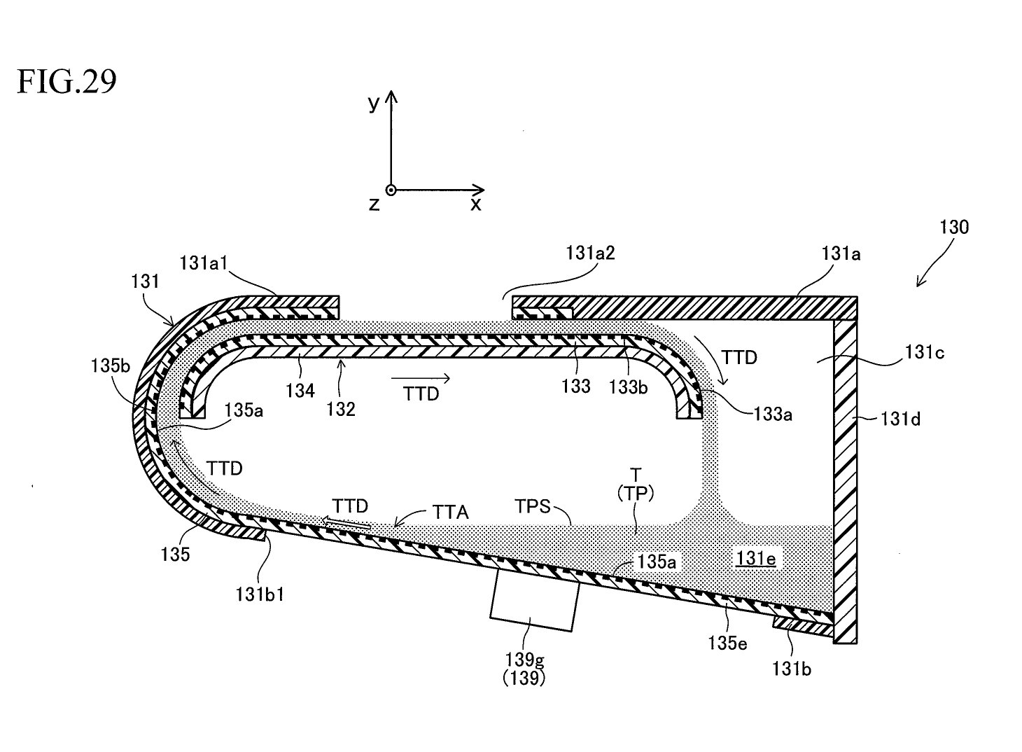

FIG. 29 is a side sectional view showing the configuration of another modification of the developing apparatus 130 shown in FIG. 17.

Referring to FIG. 29, the diaphragm vibrating section 139 of the present modification includes a diaphragm direct vibrator 139g. This diaphragm direct vibrator 139g is provided at an approximately central portion of the outer surface of the diaphragm section 135e.

The diaphragm direct vibrator 139g is configured such that it can directly vibrate the diaphragm section 135e. A vibrator or acoustic wave generator may be used as the diaphragm direct vibrator 139g.

In such a configuration, the approximately central portion (a portion where the maximum amplitude is attained) of the diaphragm section 135e is directly vibrated by means of vibration generated by the diaphragm direct vibrator 139g. As a result, the diaphragm section 135e vibrates in the thickness direction thereof. By means of the vibration of the diaphragm section 135e, the toner T within the toner pool TP (the toner transport start area TTA) can be fluidized satisfactorily.

(7) The casing bottom plate 131b and the toner sub-transport surface 135a may be provided to form an angle of 60 degrees or greater in relation to a horizontal plane.

Such a configuration reduces the size of the developing casing 131 (the developing apparatus 130) as measured in the front-rear direction. Thus, the size of an apparatus in which a plurality of developing apparatus 130 are arranged in the front-rear direction can be reduced. That is, the size of an image forming apparatus which can form a multicolor image can be reduced.

Further, by virtue of such a configuration, when the storage amount of the toner T within the developing casing 131 (the amount of the toner pool TP) decreases, the toner pool top surface TPS can become horizontal due to the weight of the toner T itself, even if the toner pool TP is not vibrated.

That is, since the toner sub-transport surface 135a is a steep slant surface which forms an angle of 60 degrees or greater in relation to a horizontal plane, the toner contact angle TCA is stably maintained at a substantially constant angle due to the weight of the toner T itself, even if the toner pool TP is not vibrated.

(8) Further, a vibration generation source such as a piezoelectric element may be directly provided on the vibration body 136 in FIG. 17 (the downstream vibration body 1361, etc. in FIG. 25). In such a case, the vibration-body vibrating section 137 (the downstream-vibration-body vibrating section 1371, etc. in FIG. 25) can be omitted.

(9) The counter wiring substrate 135 may be partially or entirely omitted.

(10) The developing apparatus 130 may be configured in such a manner that the toner pool top surface TPS is always lower than the rear end portion of the casing bottom plate 131b as in the above-described embodiment and modifications.

By virtue of this configuration, the toner contact angle TCA in the toner transport start area TTA can always be maintained in a predetermined state. For example, the toner contact angle TCA can be maintained at a substantially constant angle. Alternatively, the toner contact angle TCA can always be maintained at a small angle of 30 degrees or less.

By virtue of such a configuration, supply of the toner T from the toner pool TP to the toner sub-transport surface 135a and the toner main transport surface 133a can be performed stably (and satisfactorily) irrespective of the progress of consumption of the toner T.

<Overall Configuration of Fourth Laser Printer>

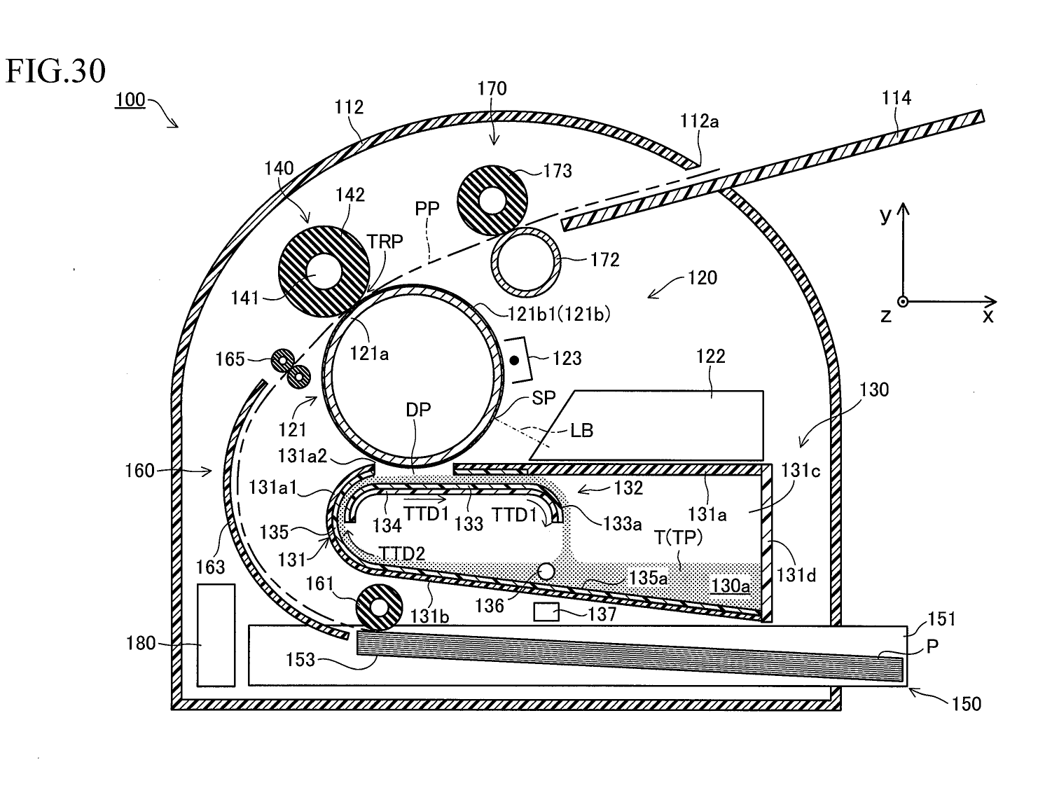

FIG. 30 is a side sectional view showing the schematic configuration of a laser printer 100 to which the fourth embodiment of the present invention is applied.

<<Body Section>>

Referring to FIG. 30, the laser printer 100, which corresponds to the image forming apparatus of the present invention, includes a body casing 112. The body casing 112 is a member which constitutes an outer cover of the laser printer 100. The body casing 112 is integrally formed from a synthetic resin plate.

The body casing 112 has a paper ejection port 112a in the form of a slit-like through-hole located at an upper front portion thereof.

A catch tray 114 is attached to an upper front portion of the body casing 112 at a position corresponding to the paper ejection port 112a. The catch tray 114 is configured to receive the paper P which is ejected through the paper ejection port 112a and on which an image has been formed.

<<Electrostatic-Latent-Image Forming Section>>

The body casing 112 houses an electrostatic-latent-image forming section 120. The electrostatic-latent-image forming section 120 includes a photoconductor drum 121, which corresponds to the electrostatic-latent-image carrying body and the developer carrying body of the present invention.

The photoconductor drum 121 is a generally cylindrical member. The center axis of rotation of the photoconductor drum 121 is in parallel with the paper width direction. The photoconductor drum 121 is configured to be able to be rotatably driven clockwise in FIG. 30.

Specifically, the photoconductor drum 121 includes a drum body 121a and a photoconductor layer 121b.

The drum body 121a is a metal tube of an aluminum alloy or the like. The photoconductor layer 121b is formed on the outer circumference of the drum body 121a.

The photoconductor layer 121b is formed by a positively chargeable photoconductive layer. That is, the photoconductor layer 121b is formed of a substance which exhibits electrical conductivity, with holes serving as a carrier, when it is irradiated with light within a predetermined wavelength band.

The photoconductor drum 121 has an image carrying surface 121b1, which serves as the latent-image forming surface and the developer carrying surface of the present invention.

The circumferential surface of the photoconductor layer 121b serves as the image carrying surface 121b1. The image carrying surface 121b1 is formed in parallel with the paper width direction and a main scanning direction, which will be described later. The image carrying surface 121b1 is configured such that an electrostatic latent image can be formed by electric-potential distribution.

The photoconductor drum 121 is configured such that the image carrying surface 121b1 can move along a sub-scanning direction to be described later (a direction orthogonal to a main scanning direction to be described later).

The electrostatic-latent-image forming section 120 includes a scanner unit 122 and a charger 123.

The scanner unit 122 is configured to generate a laser beam LB. This laser beam LB has a wavelength which is contained in the above-described predetermined wavelength band in which the photoconductor layer 121b exhibits electrical conductivity, and is modulated in accordance with image information.

The scanner unit 122 is configured such that it can sweep the laser beam LB along the main scanning direction. The main scanning direction is a direction (the z-axis direction in FIG. 30) parallel to the paper width direction.

That is, the scanner unit 122 is configured and disposed such that it can irradiate the image carrying surface 121b1 can be irradiated with the laser beam LB at a predetermined scanning position SP, while sweeping the laser beam LB along the main scanning direction.

The charger 123 is disposed upstream of the scanning direction SP with respect to the direction of movement of the image carrying surface 121b1 (direction of rotation of the photoconductor drum 121). The charger 123 is configured and disposed so as to be able to uniformly, positively charge the image carrying surface 121b1 at a position located upstream of the scanning position SP with respect to the above-mentioned direction.

The electrostatic-latent-image forming section 120 is configured such that the scanner unit 122 irradiates, with the laser beam LB, the image carrying surface 121b1 which is uniformly, positively charged by the charger 123, whereby an electrostatic latent image by electric-potential distribution (charge distribution) can be formed on the image carrying surface 121b1.

The electrostatic-latent-image forming section 120 is configured to be able to move the image carrying surface 121b1 on which an electrostatic latent image is formed, along the sub-scanning direction, which will be described later.

The “sub-scanning direction” is an arbitrary direction orthogonal to the main scanning direction. Usually, the sub-scanning direction is a direction which intersects with a vertical line. Typically, the sub-scanning direction may be a direction along the front-rear direction of the laser printer 100 (the x-axis direction in FIG. 30).

<<Developing Apparatus>>

The body casing 112 houses a developing apparatus 130, which corresponds to the developer supply apparatus of the present invention. The developing apparatus 130 is disposed such that the developing apparatus 130 faces the photoconductor drum 121 at a developing position DP (developer carrying position).

A toner containing area 130a is formed within the developing apparatus 130. This toner containing area 130a is a space for containing (storing) a toner T, which is a dry developer in the form of fine particles (powder developer).

When the laser printer 100 is not operated, the toner T is stored at a bottom portion of the toner containing area 130a. The ensemble of the toner T stored at the bottom portion of the toner containing area 130a will be referred to as a “toner pool TP.”

The developing apparatus 130 is configured to transport the toner T along a toner main transport direction TTD1 and a toner sub-transport direction TTD2 as indicated by arrows in FIG. 30.

The toner main transport direction TTD1, which corresponds to the developer main transport direction of the present invention, is a transport direction of the toner T on a toner main transport surface 133a to be described later.

The toner main transport direction TTD1 is set such that, when viewed from above (when viewed in a direction parallel with the y-axis direction in FIG. 30), the toner main transport direction TTD1 becomes generally parallel with the sub-scanning direction (the x-axis direction in FIG. 30) (Notably, the toner main transport direction TTD1 may partially extend parallel to the height direction (the y-axis direction in FIG. 30)).

Further, the toner sub-transport direction TTD2, which corresponds to the developer sub-transport direction of the present invention, is a transport direction of the toner T on a toner sub-transport surface 135a to be described later.

The toner sub-transport direction TTD2 is also set such that, when viewed from above, the toner sub-transport direction TTD2 becomes generally parallel with the sub-scanning direction (the x-axis direction in FIG. 30) (Notably, the toner sub-transport direction TTD2 also may partially extend parallel to the height direction (the y-axis direction in FIG. 30)).

The developing apparatus 130 is configured to transport the toner T, while circulating it along a circulating transport path formed to have a generally oval (elliptical) shape as viewed in a side sectional view. That is, each of the toner main transport direction TTD1 and the toner sub-transport direction TTD2 is a direction tangent to the circulating transport path at an arbitrary point in the side sectional view.

The developing apparatus 130 is configured and disposed as described below such that it can supply the toner T in a charged state to the image carrying surface 121b1, on which an electrostatic latent image is formed, in the vicinity of the developing position DP.

Notably, the toner T used in the present embodiment is a non-magnetic 1-component developer for use in electrophotography.

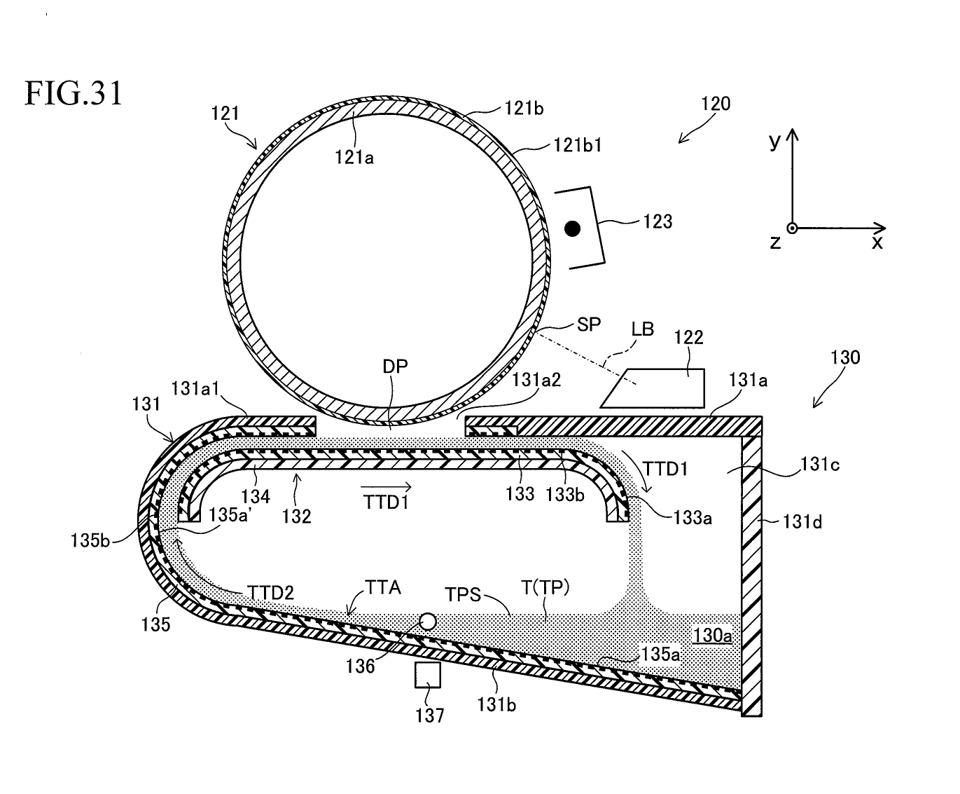

FIG. 31 is an enlarged side sectional view showing the electrostatic-latent-image forming section 120 and the developing apparatus 130 shown in FIG. 30.

Referring to FIGS. 30 and 31, the developing apparatus 130 is disposed below the photoconductor drum 121 in such a manner as to face the image carrying surface 121b1 at a position located downstream of the scanning position SP with respect to the direction of movement of the image carrying surface 121b1.

<<<Developing Casing>>>

Referring to FIGS. 30 and 31, a developing casing 131, which corresponds to the developer containing casing of the present invention, is a box-like member formed of a synthetic resin, and is configured such that it can store the toner T therein. That is, the above-described toner pool TP is stored at the bottom portion of the toner containing area 130a formed within the developing casing 131.

A casing top cover 131a, which corresponds to the top plate of the developer containing casing of the present invention, is formed to assume a generally J-like shape as viewed in a side sectional view. A developing-section counter plate 131a1, which is a rear portion of the casing top cover 131a, is smaller in thickness than the remaining portion.

The developing-section counter plate 131a1 is composed of a flat plate portion which is located below the photoconductor drum 121, and a semi-cylindrical portion connected to a rear end of the flat plate portion.

A developing opening portion 131a2, which corresponds to the opening portion of the present invention, is formed in the flat plate portion of the developing-section counter plate 131a1. The developing opening portion 131a2 is provided in the developing-section counter plate 131a1 at a position facing the image carrying surface 121b1 such that the developing opening portion 131a2 surrounds the developing position DP.

A casing bottom plate 131b, which corresponds to the bottom plate of the developer containing casing of the present invention, is provided to face the casing top cover 131a. This casing bottom plate 131b is formed from a flat-plate-shaped member having the same thickness as the developing-section counter plate 131a1.

The casing bottom plate 131b is provided in an inclined state such that the casing bottom plate 131b forms a constant angle of 30 degrees or less in relation to a horizontal plane. That is, the casing bottom plate 131b is disposed in such a manner that the surface of the casing bottom plate 131b located on the upper side in FIG. 30 forms a gentle slope which ascends from the front side toward the rear side.

A rear end portion of the casing bottom plate 131b is connected to a lower end of the semi-cylindrical portion of the casing top cover 131a. That is, the casing bottom plate 131b and the casing top cover 131a are integrally formed such that they are smoothly connected at the rear end of the developing casing 131.

Further, the developing casing 131 includes a pair of casing side plates 131c. The pair of casing side plates 131c are closingly attached to the opposite ends, with respect to the paper width direction, of the casing top cover 131a and to those of the casing bottom plate 131b.

A casing front closing plate 131d is closingly attached to the front end of the casing top cover 131a, to that of the casing bottom plate 131b, and to those of the paired casing side plates 131c.

That is, a space surrounded by the casing top cover 131a, the casing bottom plate 131b, the paired casing side plates 131c, and the casing front closing plate 131d constitutes the toner containing area 130a.

<<<Toner Electric-Field Transport Body>>>

Referring to FIG. 31, the developing casing 131 houses a toner electric-field transport body 132, which corresponds to the developer transport body of the present invention. That is, the toner electric-field transport body 132 is covered with the developing casing 131.

The toner electric-field transport body 132 is disposed in the inner space of the developing casing 131 at a rearward position, in such a manner as to face the image carrying surface 121b1 with the developing opening portion 131a2 therebetween. That is, the toner electric-field transport body 132 is provided such that the photoconductor drum 121 and the toner electric-field transport body 132 (the above-described toner main transport surface 133a) face each other with the developing opening portion 131a2 therebetween.

The opposite ends of the toner electric-field transport body 132 are supported by the paired casing side plates 131c in such a manner that the toner electric-field transport body 132 is supported at a position located above the casing bottom plate 131b while facing the developing-section counter plate 131a1 with a predetermined gap therebetween.

<<<<Transport Wiring Substrate>>>>

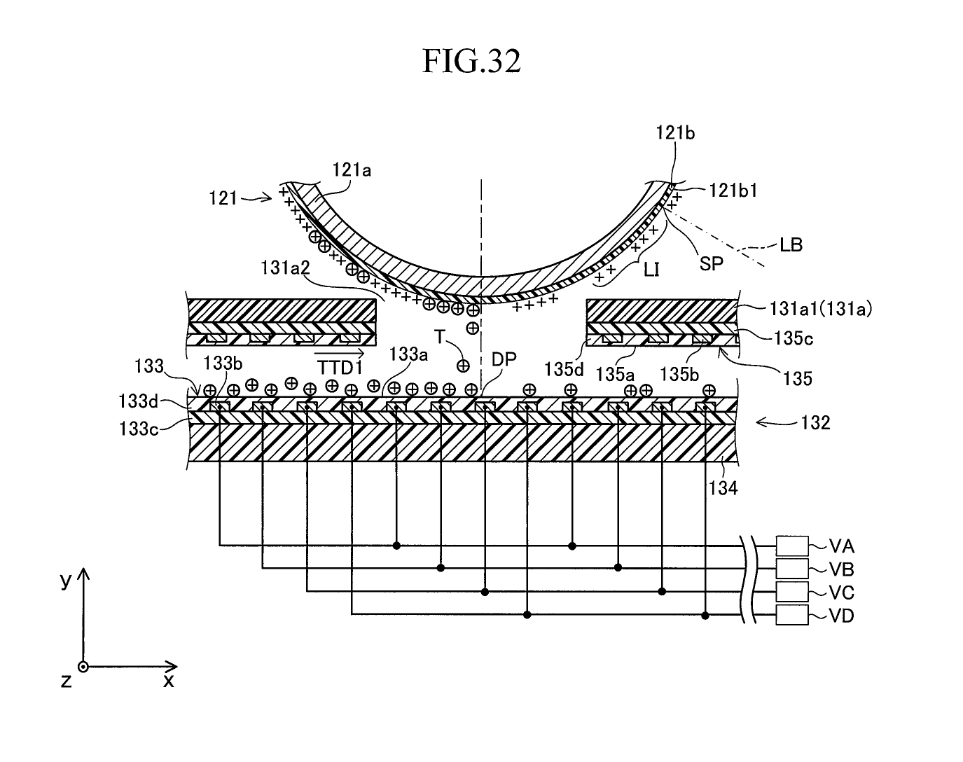

FIG. 32 is an enlarged side sectional view showing a portion of the developer electric-field transport body 132 shown in FIG. 31 in the vicinity of the developing opening portion 131a2.

Referring to FIGS. 31 and 32, the toner electric-field transport body 132 includes the transport wiring substrate 133. The transport wiring substrate 133 is disposed in such a manner as to face the image carrying surface 121b1 with the developing opening portion 131a2 therebetween.

The above-descried toner main transport surface 133a, which is the surface of the transport wiring substrate 133 located on the upper side in FIG. 31 is formed in a shape resembling the inverted letter U as viewed from the lateral direction. That is, a rear end portion of the toner main transport surface 133a is curved downward along the casing top cover 131a of the developing casing 131.

Also, a front end portion of the toner main transport surface 133a is curved downward in a manner similar to that of the rear end portion. A portion of the toner main transport surface 133a between the above-mentioned front and rear portions assumes the form of a generally flat plate.

The toner main transport surface 133a, which corresponds to the developer main transport surface of the present invention, is formed in parallel with the main scanning direction (the z-direction in FIG. 31). Further, the toner main transport surface 133a is disposed to face the image carrying surface 121b1 of the photoconductor drum 121. The toner main transport surface 133a and the image carrying surface 121b1 are in the closest proximity to each other at the developing position DP.

Referring to FIG. 32, the transport wiring substrate 133 has a structure similar to that of a flexible printed wiring board. That is, the transport wiring substrate 133 includes a plurality of transport electrodes 133b, which correspond to the first transport electrodes of the present invention.

These transport electrodes 133b are disposed along the toner main transport surface 133a. That is, the transport electrodes 133b are disposed near the toner main transport surface 133a.

The transport electrodes 133b are formed of a copper foil having a thickness of about several tens of micrometers. The transport electrodes 133b are formed in a strip-like wiring pattern such that their longitudinal direction becomes parallel with the main scanning direction (orthogonal to the sub-scanning direction).

The plurality of transport electrodes 133b are disposed in parallel with one another. These transport electrodes 133b are arrayed along the toner main transport direction TTD1 (along the sub-scanning direction).

The large number of transport electrodes 133b arrayed along the sub-scanning direction are connected to power supply circuits such that every fourth transport electrodes 133b is connected to the same power supply circuit.

That is, the transport electrode 133b connected to a power supply circuit VA, the transport electrode 133b connected to a power supply circuit VB, the transport electrode 133b connected to a power supply circuit VC, the transport electrode 133b connected to a power supply circuit VD, the transport electrode 133b connected to the power supply circuit VA, the transport electrode 133b connected to the power supply circuit VB, . . . , are sequentially arrayed along the sub-scanning direction.

The transport wiring substrate 133 further includes a transport-electrode support substrate 133c and a transport-electrode coating layer 133d.

The transport-electrode support substrate 133c is a flexible film formed of an insulative synthetic resin, such as polyimide resin. The transport electrodes 133b are provided on the upper surface of the transport-electrode support substrate 133c.

The transport-electrode coating layer 133d is provided on the upper surface of the transport-electrode support substrate 133c on which the transport electrodes 133b are formed. The transport-electrode coating layer 133d is provided to cover the transport electrodes 133b.

The transport-electrode coating layer 133d covers the transport-electrode support substrate 133c and the transport electrodes 133b, thereby making the toner main transport surface 133a smooth.

Referring to FIGS. 31 and 32, the toner electric-field transport body 132 includes a transport-substrate support member 134. The transport-substrate support member 134 is provided so as to support the transport wiring substrate 133 from underneath.

Referring to FIG. 31, a rear end portion of the transport-substrate support member 134 is curved downward along the casing top cover 131a of the developing casing 131. Also, a front end portion of the transport-substrate support member 134 is curved downward in a manner similar to that of the rear end portion. A portion of the transport-substrate support member 134 between the above-mentioned front and rear portions assumes the form of a generally flat plate.

That is, the transport-substrate support member 134 is formed in a shape resembling the inverted letter U as viewed from the lateral direction. The transport wiring substrate 133 is supported by the transport-substrate support member 134 in a state in which the transport wiring substrate 133 is bent in a shape resembling the inverted letter U as viewed from the lateral direction.

Referring to FIGS. 31 and 32, the toner electric-field transport body 132 is configured to be able to transport the toner T as follows. Traveling-wave voltages (see FIG. 4) as described above are applied to the transport electrodes 133b of the transport wiring substrate 133, so that traveling-wave electric fields along are generated along the toner main transport direction TTD1, whereby the positively charged toner T can be transported in the toner main transport direction TTD1.

<<<Counter Wiring Substrate>>>

Referring to FIGS. 30 and 31, as described above, a recess is formed on the inner surface of the casing top cover 131a at a position corresponding to the developing-section counter plate 131a1. The counter wiring substrate 135 is attached to the inner surface of the developing casing 131 such that the counter wiring substrate 135 is fitted into the recess.

That is, the counter wiring substrate 135 is supported by the inner wall surface of the developing-section counter plate 131a1 such that the counter wiring substrate 135 faces the toner main transport surface 133a with a predetermined gap formed therebetween.

In the present embodiment, the counter wiring substrate 135 is provided to correspond to substantially the entire surface of the casing bottom plate 131b. That is, the counter wiring substrate 135 is provided such that it extends between the highest position of the casing bottom plate 131b (the position at which the lower end of the semi-cylindrical portion of the developing-section counter plate 131a1 and the casing bottom plate 131b are joined) and the lowest position of the casing bottom plate 131b (an end portion of the casing bottom plate 131b located on the front side in FIG. 30).

As described above, the counter wiring substrate 135 is supported by the inner wall surface of the developing casing 131 in a state in which the counter wiring substrate 135 is curved into a generally U-like shape or a generally V-like shape.

The toner sub-transport surface 135a, which corresponds to the developer sub-transport surface of the present invention, is formed by a portion of the surface of the counter wiring substrate 135 corresponding to the casing bottom plate 131b. That is, the toner sub-transport surface 135a is a flat surface extending along the inner wall surface of the casing bottom plate 131b of the developing casing 131. Specifically, the toner sub-transport surface 135a is a flat surface parallel to the inner wall surface.

Further, the toner sub-transport surface 135a forms a smooth slope which always forms an angle of 30 degrees or less in relation to a horizontal plane. Further, the toner sub-transport surface 135a is formed parallel to the main scanning direction (the z-direction in FIG. 30).

The toner sub-transport surface 135a forms a slope which ascends from a lower end portion of the casing front closing plate 131d toward a rear end portion of the toner electric-field transport body 132 (an upstream end portion of the toner main transport surface 133a with respect to the toner main transport direction TTD1).

In this case, the toner sub-transfer direction TTD2 is a direction in which the toner moves up along the toner sub-transport surface 135a toward an upstream end portion of the toner main transport surface 133a with respect to the toner main transport direction TTD1.

A toner auxiliary transport surface 135a′, which corresponds to the developer auxiliary transport surface of the present invention, is formed by a portion of the surface of the counter wiring substrate 135 corresponding to the developing-section counter plate 131a1.

That is, the toner auxiliary transport surface 135a′ is formed by a surface extending along the inner wall surface of a portion (the above-described semi-cylindrical portion) of the developing-section counter plate 131a1 located on the upstream side of the developing opening portion 131a2 with respect to the toner main transport direction TTD1 and a surface extending along the inner wall surface of a portion (the above-described flat-plate portion) of the developing-section counter plate 131a1 located on the downstream side of the developing opening portion 131a2.

An upstream end portion of the toner auxiliary transport surface 135a′ with respect to the toner sub-transport direction TTD2 (an end portion of the toner auxiliary transport surface 135a′ corresponding to an end portion (a lower end portion in FIG. 31) of the above-described semi-cylindrical portion of the developing-section counter plate 131a1 located away from the developing opening portion 131a2) is smoothly connected to a downstream end portion of the toner sub-transport surface 135a with respect to the toner sub-transport direction TTD2 without formation of a step therebetween.

This toner auxiliary transport surface 135a′ is also formed in parallel with the main scanning direction (the z-direction in FIG. 31).

The counter wiring substrate 135 has a structure similar to that of the above-described transport wiring substrate 133.

That is, referring to FIG. 32, the counter electrodes 135b, which correspond to the second transport electrodes of the present invention, are formed of a copper foil having a thickness of about several tens of micrometers. The counter electrodes 135b are formed in a strip-like wiring pattern such that their longitudinal direction becomes parallel with the main scanning direction (orthogonal to the sub-scanning direction).

The plurality of counter electrodes 135b are disposed in parallel with one another. These counter electrodes 135b are arrayed along the predetermined toner sub-transport direction TTD2 (the sub-scanning direction). The counter electrodes 135b are connected to power supply circuits such that every fourth counter electrodes 135b is connected to the same power supply circuit.

The plurality of counter electrodes 135b are provided along the toner sub-transport surface 135a. That is, the counter electrodes 135b are provided along the inner wall surface of the casing bottom plate 131b of the developing casing 131. Further, the plurality of counter electrodes 135b are provided along the toner auxiliary transport surface 135a′.

In addition to the above-described counter electrodes 135b, the counter wiring substrate 135 includes a counter-electrode support substrate 135c and a counter-electrode coating layer 135d.

The counter-electrode support substrate 135c is a flexible film of an electrically insulative synthetic resin, such as polyimide resin. The counter electrodes 135b are provided on the surface of the counter-electrode support substrate 135c located on the lower side in the drawing.

The counter-electrode coating layer 135d is provided on the lower surface of the counter-electrode support substrate 135c on which the counter electrodes 135b are formed. The counter-electrode coating layer 135d is provided to cover the counter electrodes 135b.

As a result of the counter-electrode coating layer 135d covering the counter-electrode support substrate 135c and the counter electrodes 135b, the above-described toner sub-transport surface 135a forms a smooth slope which always forms an angle of 30 degrees or less in relation to the horizontal plane. The toner sub-transport surface 135a forms a gentle slope which ascends from the front side toward the rear side.

The counter wiring substrate 135 is configured to be able to transport the toner T as follows. As in the case of the above-described transport wiring substrate 133, predetermined voltages are applied to the plurality of counter electrodes 135b, so that traveling-wave electric fields are generated along the toner sub-transport direction TTD2, whereby the positively charged toner T can be transported in the toner sub-transport direction TTD2.

<<<Developer Vibrating Section>>>

Referring to FIG. 31, the developing apparatus 130 of the present embodiment includes a vibration element 136 and a vibration-element drive section 137.

The vibration element 136 and the vibration-element drive section 137, which constitute the developer vibrating section of the present invention, are provided near the casing bottom plate 131b. That is, the vibration element 136 and the vibration-element drive section 137 are configured as follows so as to vibrate the toner pool TP (the toner T stored at the bottom portion of the toner containing area 130a within the developing casing 131).

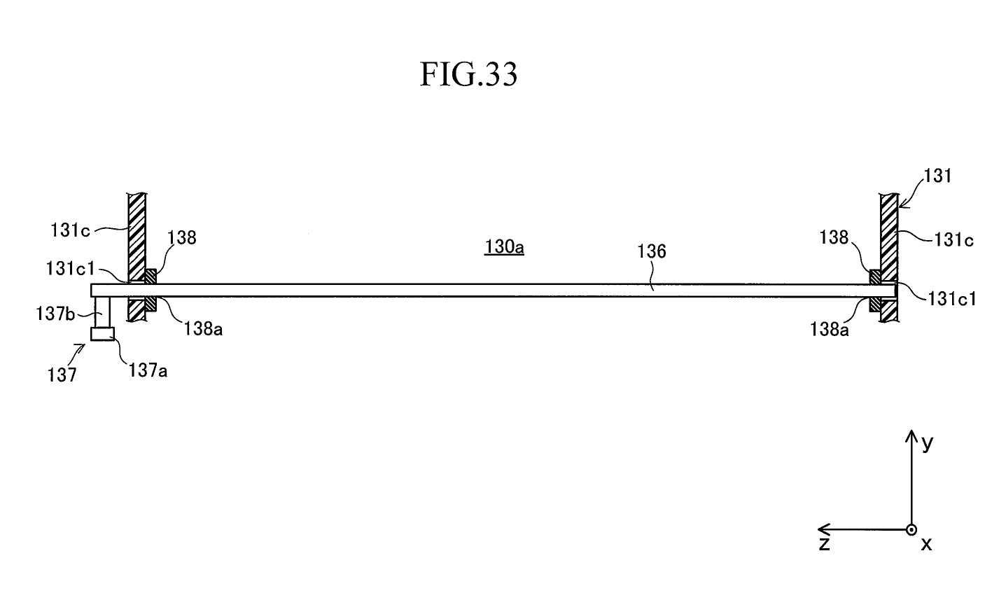

FIG. 33 is an enlarged sectional view, as viewed from a front side, of a portion of the developing casing 131 shown in FIG. 31 in the vicinity of the vibration element 136.

Referring to FIG. 31, the vibration element 136 is a rod-like member, and is disposed to extend along the paper width direction (the z-axis direction in these drawings). This vibration element 136 is disposed within the developing casing 131 (the toner containing area 130a) such that it is separated from the toner sub-transport surface 135a and faces the toner sub-transport surface 135a.

That is, referring to FIGS. 31 and 33, a casing through hole 131c1 is formed in each of the paired casing side plates 131c. The casing through hole 131c1 is formed to have a diameter slightly larger than the diameter of the vibration element 136. The vibration element 136 is disposed such that it penetrates the paired casing through holes 131c1.

The vibration-element drive section 137 is disposed outside the developing casing 131 (the toner containing area 130a). The vibration-element drive section 137 is configured as follows in order to vibrate the vibration element 136 from the outside of the developing casing 131.

Specifically, referring to FIG. 33, the vibration-element drive section 137 includes a vibration generation section 137a and a vibration transmission section 137b.

The vibration generation section 137a is constituted by a piezoelectric element, a vibrator, or the like which can generate vibration upon supply of electricity thereto.

The vibration transmission section 137b is a rod-like member formed of a metal, and is disposed such that it comes into contact with the vibration element 136 and the vibration generation section 137a. This vibration transmission section 137b is configured so as to transmit the vibration generated by the vibration generation section 137a to one end portion of the vibration element 136.

Paired elastic seals 138 are bonded to the inner surfaces of the casing side plates 131c (the surfaces facing the toner containing area 130a) at positions corresponding to the casing through holes 131c1. The elastic seals 138 are configured in such a manner that they suppress the leakage of the toner T (see FIG. 31) to the outside of the developing casing 131 through the casing through holes 131c1, and support the vibration element 136.

Specifically, each of the elastic seals 138 is a disk-shaped member formed of a synthetic rubber. A seal through hole 138a is provided at an approximately central portion of the elastic seal 138. The seal through holes 138a are formed to have a diameter slightly smaller than the diameter of the vibration element 136.

The elastic seals 138 are disposed such that the center axes of the casing through holes 131c1 extending in the paper width direction (the z-axis direction in FIG. 33) and the center axes of the seal through holes 138a extending in the paper width direction generally coincide with each other. That is, the vibration element 136 is supported by the casing side plates 131c via the elastic seals 138 in an oscillatable manner.

<<Transfer Section>>

Referring again to FIG. 30, a transfer section 140 is provided in such a manner as to face the image carrying surface 121b1 at a position located downstream, with respect to the direction of rotation of the photoconductor drum 121, of the position where the photoconductor drum 121 and the developing apparatus 130 face each other.

The transfer section 140 includes a rotary center shaft 141, which is a roller-like member and is made of a metal, and a semiconductive rubber layer 142, which is circumferentially provided on the rotary center shaft 141. The rotary center shaft 141 is disposed in parallel with the main scanning direction (the z-axis direction in FIG. 16). A high-voltage power supply is connected to the rotary center shaft 141. The semiconductive rubber layer 142 is formed of a synthetic rubber containing carbon black or the like kneadingly mixed thereinto such that the rubber layer exhibits semiconductivity.

The transfer section 140 is configured to be able to transfer the toner T from the image carrying surface 121b1 to the paper P by means of being rotatably driven counterclockwise while a predetermined transfer voltage is applied between the transfer section 140 and the drum body 121a of the photoconductor drum 121.

<<Paper Feed Cassette>>

A paper feed cassette 150 is disposed under the developing apparatus 130. A paper feed cassette case 151 is a box-like member used to form the casing of the paper feed cassette 150 and opens upward. The paper feed cassette case 151 is configured to be able to contain a large number of sheets of the paper P of up to size A4 (210 mm width×297 mm length) in a stacked state.

A paper-pressing plate 153 is disposed within the paper feed cassette case 151. The paper-pressing plate 153 is supported by the paper feed cassette case 151 in such a manner as to pivotally move on a pivot at its front end portion, so that its rear end can move vertically in FIG. 30. An unillustrated spring urges the rear end portion of the paper-pressing plate 153 upward.

<<Paper Transport Section>>

A paper transport section 160 is housed within the body casing 112.

The paper transport section 160 is configured to be able to feed the paper P to a transfer position TRP where the transfer section 140 and the image carrying surface 121b1 face each other with a smallest gap therebetween. The paper transport section 160 includes a paper feed roller 161, a paper guide 163, and paper transport guide rollers 165.

The paper feed roller 161 includes a rotary center shaft parallel to the main scanning direction and a rubber layer, which is circumferentially provided on the rotary center shaft. The paper feed roller 161 is disposed in such a manner as to face a leading end portion, with respect to the paper transport direction, of the paper P stacked on the paper-pressing plate 153 housed within the paper feed cassette case 151. The paper guide 163 and the paper transport guide rollers 165 are configured to be able to guide to the transfer position TRP the paper P which has been delivered by the paper feed roller 161.

<<Fixing Section>>

A fixing section 170 is housed within the body casing 112. The fixing section 170 is disposed downstream of the transfer position TRP with respect to the paper transport direction.

The fixing section 170 is configured to apply pressure and heat to the paper P which has passed the transfer position TRP and bears an image in the toner T, thereby fixing the image in the toner T on the paper P. The fixing section 170 includes a heating roller 172 and a pressure roller 173.

The heating roller 172 includes a cylinder which is made of a metal and whose surface is exfoliation-treated, and a halogen lamp which is housed within the cylinder. The pressure roller 173 includes a rotary center shaft which is made of a metal, and a silicone rubber layer which is circumferentially provided on the rotary center shaft. The heating roller 172 and the pressure roller 173 are disposed in such a manner as to press against each other under a predetermined pressure.

The heating roller 172 and the pressure roller 173 are configured and disposed so as to be able to deliver the paper P toward the paper ejection port 112a while applying pressure and heat to the paper P.

<<Control Section>>

A control section 180 is accommodated within the body casing 112. The control section 180 includes a ROM, a CPU, a RAM, a re-writable ROM, and an interface.

The ROM stores various routines executed by the CPU for operation of the laser printer 100, tables, etc. The CPU is configured such that it can read out a routine or the like from the ROM, and execute the routine while storing data in the RAM and the re-writable ROM when necessary.

The CPU is connected via the interface to various sensors and switches provided in the laser printer 100. Further, the CPU is configured to control the operations of various sections, such as the electrostatic-latent-image forming section 120, developing apparatus 130, and the transfer section 140, via the interface.

<Outline of Image Forming Operation of the Laser Printer>

The outline of an image forming operation of the laser printer 100 having such a configuration will next be described with reference to the drawings. Notably, various operations as described below are performed under the control by the CPU of the control section 180.

<<Paper Feed Operation>>

Referring to FIG. 30, the paper-pressing plate 153 urges the paper P stacked thereon upward toward the paper feed roller 161. This causes the top paper P of a stack of the paper P on the paper-pressing plate 153 to come into contact with the circumferential surface of the paper feed roller 161.

When the paper feed roller 161 is rotatably driven clockwise in FIG. 30, a leading end portion with respect to the paper transport direction of the top paper P is moved toward the paper guide 163. Then, the paper guide 163 and the paper transport guide rollers 165 transport the paper P to the transfer position TRP.

<<Formation of Toner Image on Image Carrying Surface>>

While the paper P is being transported to the transfer position TRP as described above, an image in the toner T is formed as described below on the image carrying surface 121b1, which is the circumferential surface of the photoconductor drum 121.

<<<Formation of Electrostatic Latent Image>>>

First, the charger 123 uniformly charges a portion of the image carrying surface 121b1 of the photoconductor drum 121 to positive polarity.

Referring to FIG. 31, as a result of the clockwise rotation of the photoconductor drum 121 in the drawing, the portion of the image carrying surface 121b1 which has been charged by the charger 123 moves along the sub-scanning direction to the scanning position SP, where the portion of the image carrying surface 121b1 faces (faces straight toward) the scanner unit 122.

At the scanning position SP, the charged portion of the image carrying surface 121b1 is irradiated with the laser beam LB modulated on the basis of image information, while the laser beam LB sweeps along the main scanning direction. Certain positive charges are lost from the charged portion of the image carrying surface 121b1, according to a state of modulation of the laser beam LB. By this procedure, an electrostatic latent image LI in the form of an imagewise distribution of positive charges is formed on the image carrying surface 121b1.

As a result of the clockwise rotation of the photoconductor drum 121 in the drawing, the electrostatic latent image LI formed on the image carrying surface 121b1 moves toward the developing position DP.

<<<Fluidization of Toner>>>

Referring to FIG. 33, a predetermined AC voltage is output from an unillustrated power supply unit to the vibration generation section 137a.

As a result, the vibration generation section 137a vibrates. The vibration of the vibration generation section 137a is transmitted to the vibration element 136 via the vibration transmission section 137b. Thus, the vibration element 136 vibrates within the developing casing 131 while being supported by the elastic seals 138.

Referring to FIG. 31, by mean of such vibration of the vibration element 136, the toner pool TP (the toner T stored at the bottom portion of the toner containing area 130a of the developing casing 131) is vibrated. This vibrated toner pool TP is fluidized such that the toner pool TP behaves like a liquid.

<<<Transport of Charged Toner>>>

Referring to FIG. 31, predetermined voltages (similar to those shown in FIG. 4) are applied to the counter wiring substrate 135. Thus, predetermined traveling-wave electric fields are formed on the counter wiring substrate 135 (the toner sub-transfer surface 135a and the toner auxiliary transfer surface 135a′).

As a result, the above-described traveling-wave electric fields generated along the toner sub-transfer surface 135a acts on the toner T in a region (a toner transport start area TTA) located at a rear end portion of the sufficiently fluidized toner pool TP and near the toner sub-transfer surface 135a.

Thus, the toner T is transported in the toner sub-transport direction TTD2 from the toner transport start area TTA such that the toner T moves up along the sloped toner sub-transfer surface 135a having a constant inclination angle, and the cylindrical inner surface portion of the toner auxiliary transfer surface 135a′.

Notably, the toner transport start area TTA moves frontward and downward along the toner sub-transfer surface 135a and the toner auxiliary transfer surface 135a′ as the highest position of the toner pool TP (a toner pool top surface TPS) lowers as a result of consumption of the toner.

The toner T having moved up along the toner auxiliary transfer surface 135a′ is guided to a position where the counter wiring substrate 135 faces the furthest upstream portion (a left-side lower end portion in FIG. 31) of the transport wiring substrate 133 with respect to the toner main transport direction TTD1.

The toner T having being guided to a position between the transport wiring substrate 133 and the counter wiring substrate 135 is transported to the developing position DP by means of the traveling-wave electric fields generated along the toner main transport surface 133a of transport wiring substrate 133 and the toner auxiliary transport surface 135a′ and the toner sub-transport surface 135a of the counter wiring substrate 135.

The toner T having passed through the developing position DP falls down from a frontmost end portion of the toner main transport surface 133a, so that the toner T returns to the above-described toner pool TP.

<<<Development of Electrostatic Latent Image>>>

Referring to FIG. 32, the positively charged toner T is transported to the developing position DP as described above.

In the vicinity of the developing position DP, the toner T adheres to portions of the electrostatic latent image LI on the image carrying surface 121b1 at which positive charges are lost. That is, the electrostatic latent image LI on the image carrying surface 121b1 of the photoconductor drum 121 is developed with the toner T.

Thus, an image in the toner T is carried on the image carrying surface 121b1.

<<Transfer of Toner Image from Image Carrying Surface to Paper>>

Referring to FIG. 30, as a result of clockwise rotation of the image carrying surface 121b1 in FIG. 30, an image in the toner T which has been carried on the image carrying surface 121b of the photoconductor drum 121 as described above is transported toward the transfer position TRP.

At the transfer position TRP, the image in the toner T is transferred from the image carrying surface 121b1 onto the paper P.

<<Fixing and Ejection of Paper>>

The paper P onto which an image in the toner T has been transferred at the transfer position TRP is sent to the fixing section 170 along the paper path PP.

The paper P is nipped between the heating roller 172 and the pressure roller 173, thereby being subjected to pressure and heat. By this procedure, the image in the toner T is fixed on the paper P.

Subsequently, the paper P is sent to the paper ejection port 112a and is then ejected onto the catch tray 114 through the paper ejection port 112a.

<Actions and Effects Achieved by the Configuration of the Embodiment>

In the configuration of the present embodiment, the casing bottom plate 131b is formed in the shape of a flat plate which intersects with a horizontal plane at a constant angle. Further, the toner sub-transport surface 135a is formed as a flat surface which intersects with the horizontal plane at a constant angle.

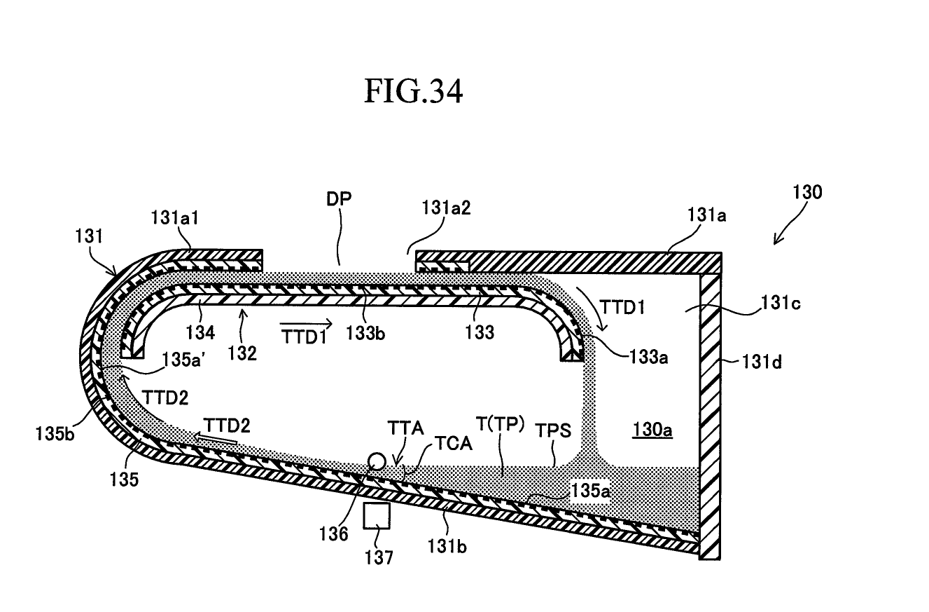

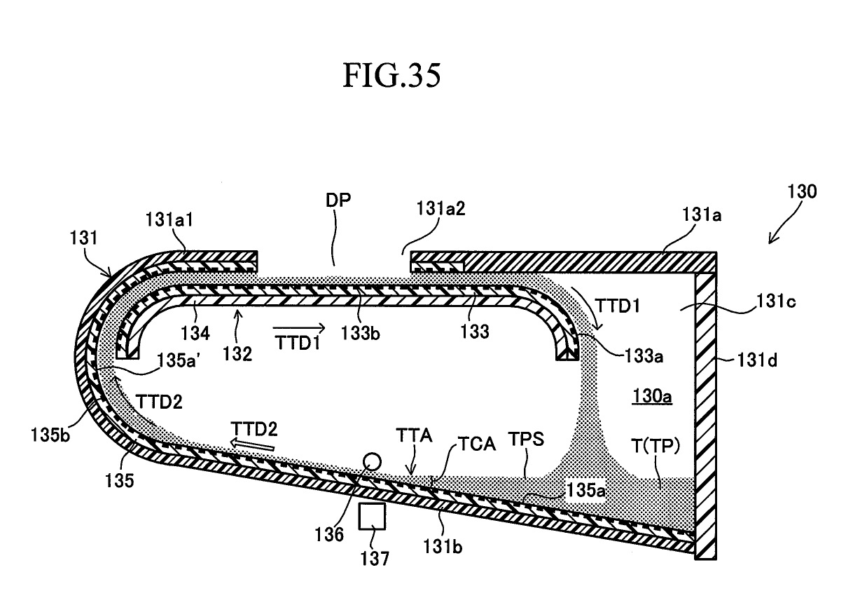

FIG. 34 is a side sectional view of the development apparatus 130 shown in FIG. 31 showing a state in which the storage amount of the toner T within the developing casing 131 (the amount of toner pool TP) has decreased. FIG. 35 is a side sectional view of the development apparatus 130 shown in FIG. 31 showing a state in which the toner storage amount has decreased further, as compared with the state shown in FIG. 34.

As shown in FIGS. 34 and 35, the above-described toner pool top surface TPS gradually lowers as the storage amount of the toner T within the developing casing 131 decreases.

In such a case, according to the configuration of the present embodiment, the angle (toner contact angle TCA) between the toner pool top surface TPS and the toner sub-transport surface 135a in the toner transport start area TTA becomes substantially constant.

Referring to FIGS. 34 and 35, in the present embodiment, even when the storage amount of the toner T decreases, the toner contact angle TCA becomes substantially constant.

Thus, in the present embodiment, the state of transport of the toner T from the toner transport start area TTA toward the downstream side with respect to the toner sub-transport direction TTD2 becomes substantially constant. That is, the transport state of the toner T becomes stable.

Therefore, the configuration of the present embodiment can effectively suppress generation of a transport failure of the toner T (e.g., an extreme decrease in the transport amount), which failure would otherwise occur when the storage amount of the toner T within the developing casing 131 (the storage amount of the toner T at the bottom portion of the toner containing area 130a) decreases.

In the configuration of the present embodiment, the casing bottom plate 131b is formed in the shape of a flat plate which intersects with a horizontal plane at a small angle (30 degrees or less). Further, the toner sub-transport surface 135a is formed as a flat surface which intersects with the horizontal plane at a small angle (30 degrees or less). The angle between the toner sub-transport surface 135a and the flat plane becomes generally equal to the toner contact angle TCA.

By virtue of such a configuration, the toner contact angle TCA, which is the angle between the toner pool top surface TPS and the toner sub-transport surface 135a, becomes a small angle (30 degrees or less). Therefore, the greater part portion of the toner T in the toner transport start area TTA receives the action of the traveling-wave electric fields on the toner sub-transport surface 135a.

Therefore, the supply of the toner T from the toner transport start area TTA to a portion of the toner sub-transport surface 135a located at the downstream side with respect to the toner sub-transport direction TTD2 can be performed satisfactorily.

Further, the size of the developing casing 131 in the height direction decreases. Thus, the thickness of the developing apparatus 130 can be reduced. Therefore, a further reduction in the size of the laser printer 100 becomes possible.

In the configuration of the present embodiment, there are provided the vibration element 136 and the vibration-element drive section 137, which serve as the developer vibrating section for vibrating the toner T contained (stored) in the developing casing 131.

By virtue of such a configuration, the toner T stored in the developing casing 131 (the toner pool TP) is fluidized satisfactorily. Stresses, such as aggregation force and shearing force, acting on the toner T at that time are very small.

Therefore, by virtue of such a configuration, the state of supply of the toner T to the toner sub-transport surface 135a, the toner auxiliary transport surface 135a′, and the toner main transport surface 133a can be made uniform satisfactorily. Accordingly, the state of transport of the toner T on the toner sub-transport surface 135a, the toner auxiliary transport surface 135a′, and the toner main transport surface 133a can be made uniform satisfactorily

As described above, the configuration of the present embodiment enables more uniform performance of the transport of the toner T and the supply of the toner T to the development facing position DP by means of the traveling-wave electric fields. Accordingly, generation of density non-uniformity can be suppressed effectively, whereby satisfactory image formation becomes possible.

In the configuration of the present embodiment, the vibration element 136 is disposed within the developing casing 131 such that the vibration element 136 is separated from the toner sub-transport surface 135a. This vibration element 136 is supported by the casing side plates 131c via the elastic seals 138 such that the vibration element 136 can oscillate.

Further, in the configuration of the present invention, the vibration-element drive section 137 is disposed outside the developing casing 131. The vibration-element drive section 137 can vibrate the vibration element 136 from the outside of the developing casing 131.

Such a configuration can suppress, to the greatest possible extent, generation of a distortion of a formed image, which distortion would otherwise occur when the predetermined positional relation at the developing position DP between the toner main transport surface 133a and the image carrying surface 121b1 changes due to vibration of the vibration element 136.

Further, it is possible to suppress, to the greatest possible extent, generation of noise which would otherwise be generated due to direct transmission of all the vibration of the vibration element 136 to the developing casing 131.

<Modifications>

(1) No particular limitation is imposed on the configurations of the toner electric-field transport body 132, the transport wiring substrate 133, and the counter wiring substrate 135 in the above-described embodiment.

For example, the transport electrodes 133b can be embedded in the transport-electrode support substrate 133c so as not to project from the surface of the transport-electrode support substrate 133c. The transport-electrode coating layer 133d can be omitted.

Alternatively, the transport electrodes 133b can be formed directly on the transport-substrate support member 134. In this case, the transport electrodes 133b can be embedded in the transport-electrode support member 134 so as not to project from the upper surface of the transport-electrode support member 134. Further, in this case, the toner main transport surface 133a is formed by the upper surface of the transport-electrode support member 134.

The counter electrodes 135b can also be, for example, embedded in the counter-electrode support substrate 135c so as not to project from the surface of the counter-electrode support substrate 135c. The counter-electrode coating layer 135d can be omitted.

Alternatively, the counter electrodes 135b can be formed directly on the inner wall surface of the casing bottom plate 131b. In this case, the counter electrodes 135b can be embedded in the casing bottom plate 131b so as not to project from the inner wall surface of the casing bottom plate 131b. Further, in this case, the toner sub-transport surface 135a is formed by the inner wall surface of the casing bottom plate 131b.

The longitudinal direction of the transport electrodes 133b and that of the counter electrodes 135b may be in parallel with the main scanning direction as in the case of the above-described embodiment or may intersect with the main scanning direction.

The direction of arraying the transport electrodes 133b and that of arraying the counter electrodes 135b may be in parallel with the sub-scanning direction as viewed in plane as in the case of the above-described embodiment or may intersect with the sub-scanning direction as viewed in plane.

No particular limitation is imposed on the transport electrodes 133b and the counter electrodes 135b with respect to shape and the configuration of electrical connections. For example, in place of the form of a straight line as in the case of the above-described embodiment, the transport electrodes 133b and the counter electrodes 135b can assume various other forms, such as V-shaped, arc, waves, and serrated.

The pattern of connecting the electrodes is not limited to that of connecting every fourth electrode as in the case of the above-described embodiment. For example, every other electrode or every third electrode may be connected. In this case, the corresponding power circuits are not of four kinds, but can be modified as appropriate such that the phase shift of voltage waveforms is 180°, 120°, etc. Furthermore, the voltage waveform can be rectangular waves, sine waves, and waves of various other shapes.

(2) The arrangement and configuration of the developer vibrating section of the present invention are not limited to those disclosed in the above-described embodiment and corresponding drawings.

For example, the vibration element 136 may be provided in the vicinity of the lowest position of the toner containing area 130a (a lower right end portion in FIG. 30).

Further, a plurality of vibration elements 136 may be provided within the developing casing 131 (toner containing area 130a).

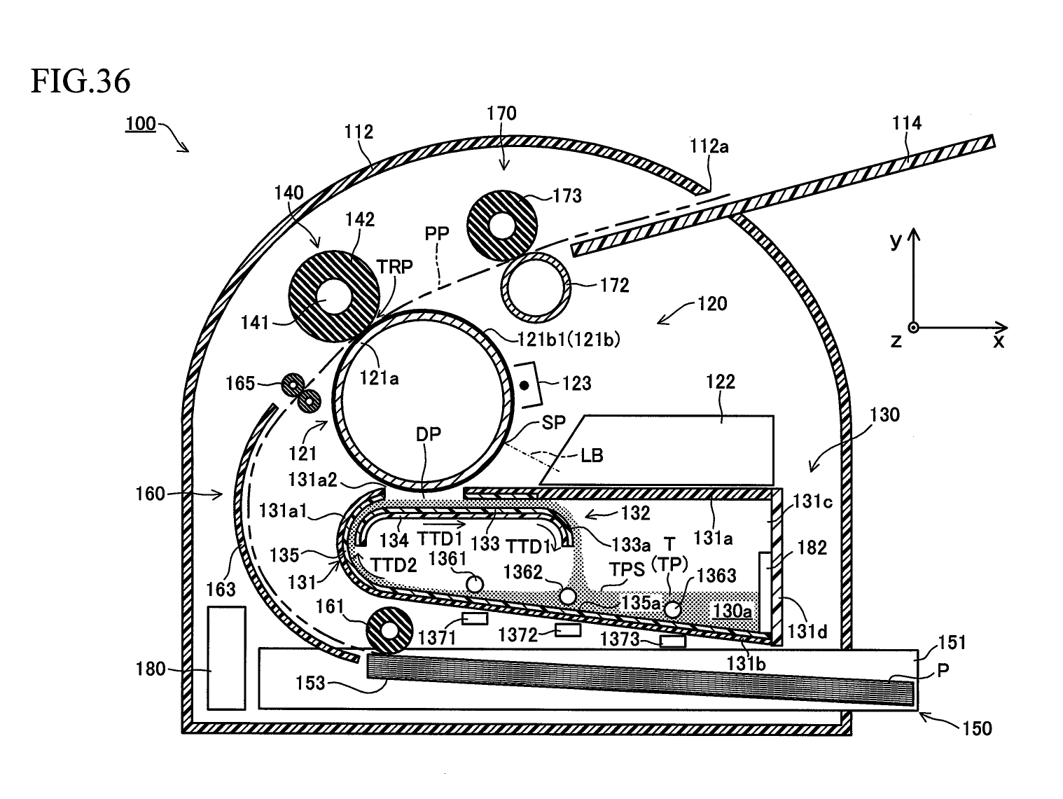

FIG. 36 is a side sectional view showing the configuration of one modification of the laser printer 100 shown in FIG. 30.

As shown in FIG. 36, a downstream vibration element 1361, an intermediate vibration element 1362, and an upstream vibration element 1363 are provided within the developing casing 131 (the toner containing area 130a).

The downstream vibration element 1361 is provided downstream of the center of the toner sub-transport surface 135a with respect to the toner sub-transport direction TTD2. The upstream vibration element 1363 is provided upstream of the center of the toner sub-transport surface 135a with respect to the toner sub-transport direction TTD2. The intermediate vibration element 1362 is provided between the downstream vibration element 1361 and the upstream vibration element 1363.

Outside the developing casing 131 (the toner containing area 130a), a downstream-vibration-element vibration section 1371 is provided such that the downstream-vibration-element vibration section 1371 corresponds to the downstream vibration element 1361. Further, an intermediate-vibration-element vibration section 1372 is provided such that the intermediate-vibration-element vibration section 1372 corresponds to the intermediate vibration element 1362. Moreover, an upstream-vibration-element vibration section 1373 is provided such that the upstream-vibration-element vibration section 1373 corresponds to the upstream vibration element 1363.

Notably, the intermediate vibration element 1362 may be omitted. Alternatively, the intermediate vibration element 1362 may be provided at a plurality of locations. Moreover, the downstream-vibration-element drive section 1371 to the upstream-vibration-element drive section 1373 may be integrated.

Further, a vibration generation source such as a piezoelectric element may be directly provided on the vibration element 136 in FIG. 31 (the downstream vibration element 1361, etc. in FIG. 36). In such a case, the vibration-element drive section 137 (the downstream-vibration-element drive section 1371, etc. in FIG. 36) can be omitted.

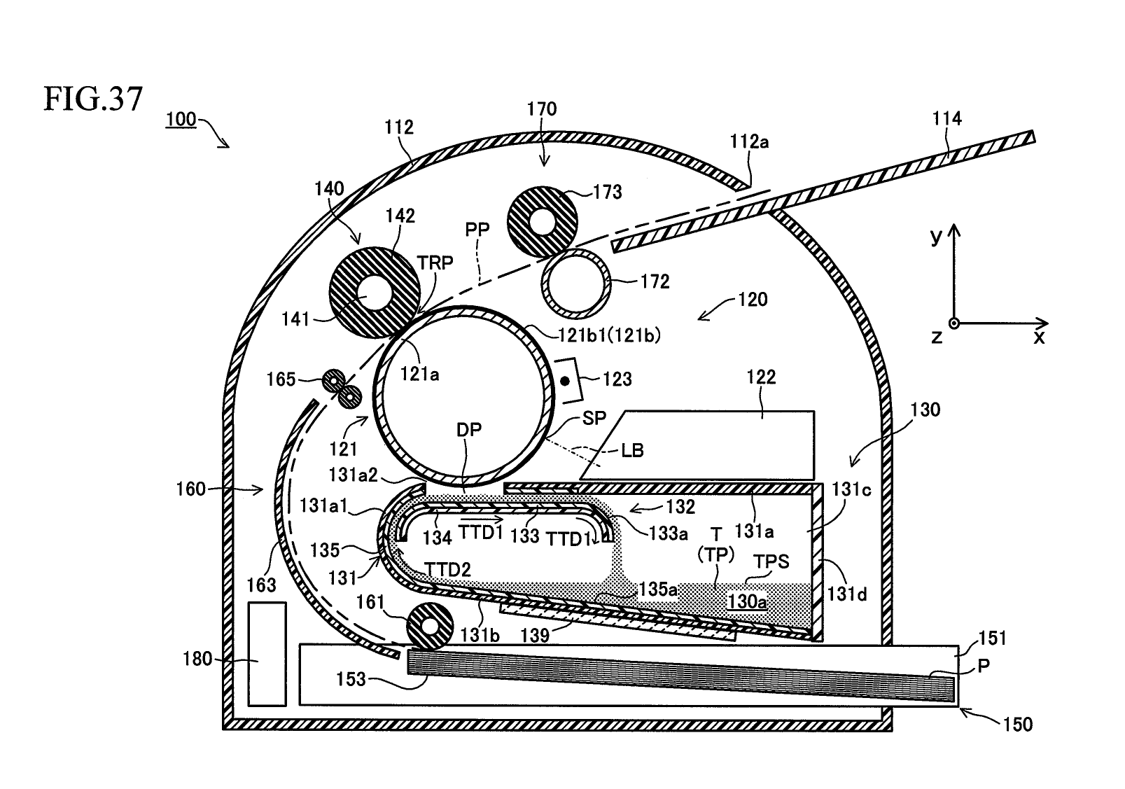

Further, in place of the vibration element 136 and the vibration-element drive section 137 shown in FIG. 31, a vibration plate 139 may be used as shown in FIG. 37. This vibration plate 139 is formed of a piezoelectric element, a vibrator, or the like which can generate vibration upon supply of electricity thereto, as in the case of the vibration generation section 137a of the vibration-element drive section 137 (see FIG. 33).

As shown in FIG. 37, the vibration plate 139 may be provided on the casing bottom plate 131b. For example, the vibration plate 139 may be provided on the outer surface of the casing bottom plate 131b (the surface opposite the inner surface which faces the counter wiring substrate 135).

Alternatively, the vibration plate 139 may be provided within the developing casing 131 (the toner containing area 130a) such that the vibration plate 139 faces the toner sub-transport surface 135a with a predetermined gap therebetween.

By virtue of such a configuration, the toner pool TP within the toner containing area 130a can be fluidized satisfactorily by use of a very simple apparatus structure.

(3) The developer vibrating section of the present invention may be configured such that it can vibrate the entire toner pool TP even when the storage amount of the toner T within the developing casing 131 (the amount of the toner pool TP). Alternatively, the developer vibrating section of the present invention may be configured such that it can vibrate at least the toner within the toner transport start area TTA.

For example, referring to FIG. 36, a toner amount sensor 182 may be provided within the developing casing 131 (the toner containing area 130a).

The toner amount sensor 182 is configured to output a signal corresponding to the position of the toner pool top surface TPS; i.e., the amount of the toner T within the toner containing area 130a. This toner amount sensor 182 is electrically connected to the control section 180.

In such a configuration, the states of vibrations of the plurality of vibration elements (the downstream vibration element 1361, etc.) are controlled by the control section 180 in accordance with the position of the toner pool top surface TPS.

For example, when the position of the toner pool top surface TPS is high, all the downstream vibration element 1361 to the upstream vibration element 1363 are vibrated. When the position of the toner pool top surface TPS becomes lower than the downstream vibration element 1361, the intermediate vibration element 1362 and the upstream vibration element 1363 are vibrated. When the position of the toner pool top surface TPS becomes lower than the intermediate vibration element 1362, the upstream vibration element 1363 is vibrated.

Alternatively, for example, when the position of the toner pool top surface TPS is high, only the downstream vibration element 1361 is vibrated. When the position of the toner pool top surface TPS becomes lower than the downstream vibration element 1361, only the intermediate vibration element 1362. When the position of the toner pool top surface TPS becomes lower than the intermediate vibration element 1362, only the upstream vibration element 1363 is vibrated.

Alternatively, as shown in FIG. 37, in the case where the vibration plate 139 is provided such that it corresponds to the casing bottom plate 131b, the casing bottom plate 131b is vibrated by the vibration plate 139.

By virtue of this configuration, the toner T in the toner transport start area TTA (see FIG. 35) can be vibrated reliably even when the position of the toner pool top surface TPS changes with consumption of the toner T.

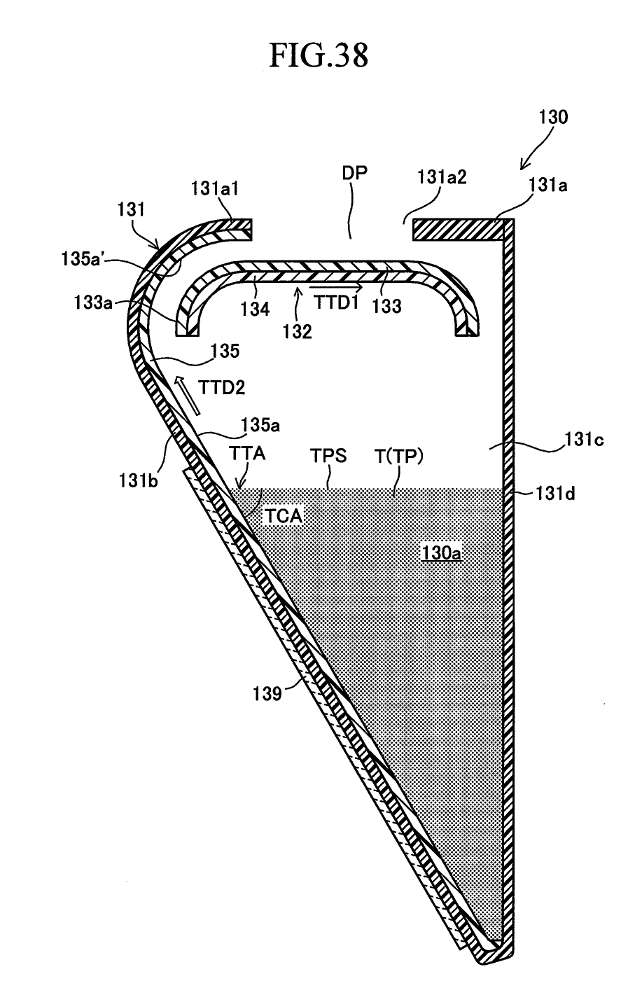

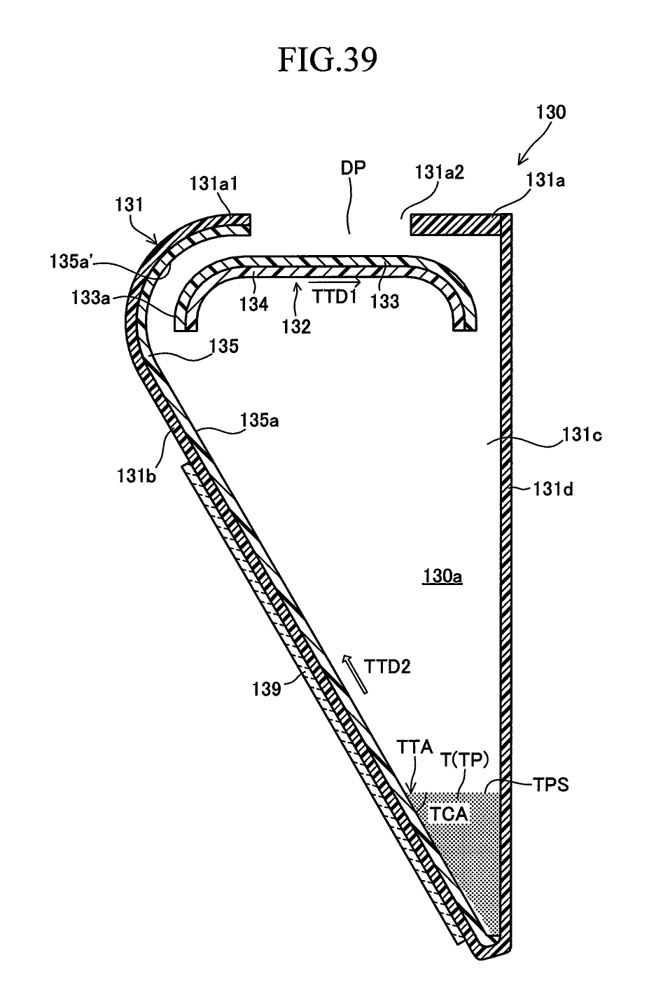

(4) FIG. 38 is a side sectional view showing the configuration of another modification of the developing apparatus 130 shown in FIG. 30. FIG. 39 is a side sectional view of the development apparatus 130 shown in FIG. 38 showing a state in which the storage amount of the toner T within the developing casing 131 (the amount of the toner pool TP) has decreased.

As shown in FIG. 38, the casing bottom plate 131b and the toner sub-transport surface 135a may be provided to form an angle of 60 degrees or greater in relation to a horizontal plane.

Such a configuration reduces the size of the developing casing 131 (the developing apparatus 130) as measured in the front-rear direction. Thus, the size of an apparatus in which a plurality of developing apparatus 130 are arranged in the front-rear direction can be reduced. That is, the size of an image forming apparatus which can form a multicolor image can be reduced.

Further, by virtue of such a configuration, when the storage amount of the toner T within the developing casing 131 (the amount of the toner pool TP) decreases as shown in FIG. 39, the toner pool top surface TPS can become horizontal due to the weight of the toner T itself, even if the toner pool TP is not vibrated by use of the vibration plate 139 or the like.

That is, since the toner sub-transport surface 135a is a steep slant surface which forms an angle of 60 degrees or greater in relation to a horizontal plane, the toner contact angle TCA is stably maintained at a substantially constant angle due to the weight of the toner T itself, even if the toner pool TP is not vibrated by use of the vibration plate 139 or the like.

Accordingly, even when the storage amount of the toner T within the developing casing 131 (the amount of the toner pool TP) decreases, the state of supply (start of transport) of the toner T from the toner transport start area TTA can be stabilized satisfactorily by employment of a very simple apparatus structure.

(5) The counter wiring substrate 135 may be partially or entirely omitted.

1. An image forming apparatus comprising:
an electrostatic-latent-image carrying body having a latent-image forming surface formed in parallel with a predetermined main scanning direction and configured to be able to form an electrostatic latent image thereon by means of electric-potential distribution, and configured such that the latent-image forming surface can move along a sub-scanning direction orthogonal to the main scanning direction; and
a developer supply apparatus disposed in such a manner as to face the electrostatic-latent-image carrying body and configured to be able to supply a developer in a charged state to the latent-image forming surface, wherein the developer supply apparatus includes:
a developer containing casing which is a box-like member having an opening portion at a position facing the electrostatic-latent-image carrying body, and is configured to be able to contain the developer therein;
a developer transport body which has a developer transport surface parallel with the main scanning direction, and is disposed within the developer containing casing such that the developer transport surface faces the electrostatic-latent-image carrying body via the opening portion;
a plurality of transport electrodes which are provided along the developer transport surface such that they face the latent-image forming surface, are configured in such a manner as to be able to transport the developer in a predetermined developer transport direction on the developer transport surface upon application of traveling-wave voltages, and are arrayed along the sub-scanning direction; and
a developer vibrating section configured to be able to vibrate the developer which is to be transported on the developer transport surface.

2. An image forming apparatus according to claim 1, wherein the developer vibrating section is contained in the developer containing casing, and is disposed to be able to vibrate the developer which is to be transported on the developer transport surface, at a position near a furthest upstream portion of the developer transport surface with respect to the developer transport direction.

3. An image forming apparatus according to claim 1, wherein the developer vibrating section is provided in a bottom plate of the developer containing casing.

4. An image forming apparatus according to claim 1, wherein the developer vibrating section is disposed within the developer containing casing such that the developer vibrating section is separated from an inner wall surface of a bottom portion of the developer containing casing and the developer transport body.

5. An image forming apparatus according to claim 1, wherein the developer vibrating section is provided at least at a position corresponding to a lowest portion of the developer containing casing.

6. An image forming apparatus according to claim 1, wherein
the developer containing casing includes a gas-permeable bottom plate which prevents passage of the developer therethrough and permits passage of a gas therethrough; and
the developer vibrating section includes a gas supply section configured to be able to blow the gas into the developer containing casing via the gas-permeable bottom plate, to thereby fluidize the developer within the developer containing casing.

7. An image forming apparatus according to claim 6, wherein the gas-permeable bottom plate is provided at a position near a furthest upstream portion of the developer transport surface with respect to the developer transport direction.

8. An image forming apparatus according to claim 6, further comprising an exhaust section configured to be able to exhaust the gas from the developer containing casing,
wherein an exhaust port which communicates with the exhaust section is provided in the developer containing casing at a position different from that of the opening portion.

9. An image forming apparatus according to claim 8, wherein the exhaust port is diagonally positioned in relation to the gas-permeable bottom plate.

10. An image forming apparatus according to claim 8, further comprising a gas circulation passage configured to connect the exhaust port and the gas-permeable bottom plate outside the developer containing casing,
wherein the gas supply section and the exhaust section are formed by a pump interposed in the gas circulation passage.

11. An image forming apparatus according to claim 6, wherein the gas-permeable bottom plate is provided at least at a position corresponding to a lowest portion of the developer containing casing.

12. An image forming apparatus according to claim 1, wherein
the transport electrodes include:
a plurality of first transport electrodes which are provided along the developer transport surface such that they face the latent-image forming surface, are configured in such a manner as to be able to transport the developer in the developer transport direction on the developer transport surface upon application of traveling-wave voltages, and are arrayed along the sub-scanning direction; and
a plurality of second transport electrodes which are provided along the bottom plate of the developer containing casing and along a sloped developer sub-transport surface formed in the form of a flat surface which intersects with a horizontal plane such that a constant angle is formed in relation to the horizontal plane, the second transport electrodes being configured in such a manner as to be able to transport the developer in a predetermined developer sub-transport direction on the developer sub-transport surface upon application of traveling-wave voltages, and being arrayed along the sub-scanning direction.

13. An image forming apparatus according to claim 12, wherein the developer sub-transport surface is formed so that the angle formed between the developer sub-transport surface and the horizontal plane always becomes 30 degree or less.

14. An image forming apparatus comprising:
an electrostatic-latent-image carrying body having a latent-image forming surface formed in parallel with a predetermined main scanning direction and configured to be able to form an electrostatic latent image thereon by means of electric-potential distribution, and configured such that the latent-image forming surface can move along a sub-scanning direction orthogonal to the main scanning direction; and
a developer supply apparatus disposed in such a manner as to face the electrostatic-latent-image carrying body and configured to be able to supply a developer in a charged state to the latent-image forming surface, wherein the developer supply apparatus includes:
a developer containing casing which is a box-like member having an opening portion at a position facing the electrostatic-latent-image carrying body, and is configured to be able to contain the developer therein;
a developer transport body which has a developer transport surface parallel with the main scanning direction, and is disposed within the developer containing casing such that the developer transport surface faces the electrostatic-latent-image carrying body via the opening portion;
a plurality of transport electrodes which are provided along the developer transport surface such that they face the latent-image forming surface, are configured in such a manner as to be able to transport the developer in a predetermined developer transport direction on the developer transport surface upon application of traveling-wave voltages, and are arrayed along the sub-scanning direction; and
a vibration body disposed in a space inside the developer containing casing, wherein
the developer supply apparatus is configured such that the developer supply apparatus can be attached to and detached from a main body of the image forming apparatus; and
the main body includes a vibration-body vibrating section which is provided at such a position that, when the developer supply apparatus is attached, the vibration-body vibrating section is located at a position outside the developer containing casing and corresponding to the vibration body and which is configured to vibrate the vibration body.

15. An image forming apparatus according to claim 14, wherein the vibration body is disposed at a bottom portion of the space inside the developer containing casing.

16. An image forming apparatus according to claim 14, wherein the vibration body is disposed within the space of the developer containing casing such that the vibration body is separated from an inner wall surface of the developer containing casing, and is supported by the developer containing casing such that the vibration body can oscillate.

17. An image forming apparatus according to claim 16, wherein the vibration body is formed of a wire-shaped or rod-shaped member.

18. An image forming apparatus according to claim 17, wherein
the vibration body is formed of a vibration rod, which is a rod-shaped member extending along the main scanning direction; and
opposite end portions of the vibration rod with respect to the main scanning direction are supported on the developer containing casing via an elastic member.

19. An image forming apparatus according to claim 18, wherein the vibration-body vibrating section is magnetically coupled with the vibration rod at one end of the vibration rod with respect to the main scanning direction.
